(19) United States
(12) Patent Application Publication
(10) Pub. No.: US 2013/0204592 A1
(43) Pub. Date: Aug. 8, 2013

(54) Structural Health Monitoring Systems And Methods

(71) Applicants: Akash Dixit, Atlanta, GA (US); Sathya Hanagud, Atlanta, GA (US); Dewey Hodges, Dunwoody, GA (US)

(72) Inventors: Akash Dixit, Atlanta, GA (US); Sathya Hanagud, Atlanta, GA (US); Dewey Hodges, Dunwoody, GA (US)

(73) Assignee: GEORGIA TECH RESEARCH CORPORATION, Atlanta, GA (US)

(21) Appl. No.: 13/639,796

(22) PCT Filed: Apr. 5, 2011
(86) PCT No.: PCT/US11/31279

§ 371 Date: Jan. 10, 2013

Related U.S. Application Data
(60) Provisional application No. 61/320,916, filed on Apr. 5, 2010.
(60) Provisional application No. 61/326,779, filed on Apr. 22, 2010.

(51) Int. Cl. G06F 17/50

(52) U.S. Cl. CPC G06F 17/5018
USPC 703/2

(57) ABSTRACT

Systems and methods of discovering damages in structures, systems and methods of modeling how a structure will behave once damage has been discovered, and a structure that does not change it natural frequency if there is loss or addition of mass or stiffness in the structure.

### CROSS-REFERENCE TO RELATED APPLICATIONS

This application claims the benefit of U.S. Provisional Application No. 61/326,779 filed 22 Apr. 2010, and U.S. Provisional Application No. 61/320,916 filed 5 Apr. 2010, the entire contents and substance of both applications hereby incorporated by reference.

### BACKGROUND OF THE INVENTION

1. Field of the Invention

The present invention evolves from research in the area of Structural Health Monitoring (SHM), and has application to the field of structural dynamics of discontinuous structures. More specifically, the invention relates to systems and methods of discovering damages in structures, systems and methods of modeling how a structure will behave once damage has been discovered, and design of structures that have higher sensitivity to damage

2. Description of Related Art

SHM, which relates to discovering damages in structures (damage diagnosis) and predicting remaining life of structures (prognosis), is a rapidly expanding field both in academia and industry. Damage diagnosis is based on damage models. The damage models that are used are either-based on expected physical behavior of damage, which is conjectured-based on experimental observations, or on approximate methods.

The damage model-based on expected physical behavior use several physical equivalents to model the damage. They include, among others, modeling the rectangular edge defect as a spring (either a linear spring, a rotational spring, or both), modeling the damage as an elastic hinge, and modeling the damage as a concentrated couple at the location of the damage. Other models-based on expected physical behavior include modeling the damage as a zone with reduced Young's modulus, and modeling the damage as a spring with nonlinear stiffness. It is also known to use an extensional spring at the damage location, with its flexibility determined using the stress intensity factors K_{I}, K_{II} and K_{III}.

The approximate methods used to model damage are based on the approximate methods known in the field of structural dynamics. For example, crack functions can be represented as an additional term in the axial displacement of Euler-Bernoulli beams. The crack functions were determined using stress intensity factors K_{I}, K_{II} and K_{III}. Thereafter, known approximate methods like the Rayleigh-Ritz method, the Galerkin Method, and/or the finite element method can be used to predict the behavior of a beam with an edge crack. A crack can also be approximately modeled mathematically as a Dirac delta function. Alternatively model displacements are approximated as Heaviside's function, which meant that modal displacements were discontinuous at the crack location.

Primarily, the damage models fall into two main categories, those-based on wave propagation-based techniques and those-based on vibration-based techniques. It is sometimes alleged that wave propagation-based techniques are more sensitive to damage detection than vibration-based techniques. The advantages with regard to sensitivity of wave propagation-based techniques arise due to the selected damage detection parameters, such as the reflected wave due to the damage. The alleged short coming of a lack of sensitivity with vibration-based techniques has several reasons, the primary among them being that the order of changes in damage detection parameters for small defects are of the order of the noise in the detection ambience.

It is, however, accepted that other than sensitivity, vibration-based techniques have a wide array of advantages over wave propagation-based techniques. For example, they are easier to implement, and the data obtained from vibration-based techniques can be used to determine the vibration characteristic of the damaged structure. The modes determined by vibration-based techniques can be used to determine the subsequent response of the structure with the damage. It can therefore be used to determine the remaining life of the structure directly. Vibration-based techniques are also capable of examining relatively large areas of the structure, and also inaccessible areas of the structure. Further, the natural vibrations of the structure can be used as the excitation (rather than external excitation as required in wave propagation-based techniques). Thus, it is clear that wave propagation-based methods have many benefits over wave propagation-based techniques, in spite of the conventional belief that vibration-based methods inherently have a lack of sensitivity.

A limitation that exists in both the vibration-based methods and wave propagation-based methods is the requirement of a baseline metric, for example, knowing the undamaged structure's natural frequency in order to determine if the structure has damage. This limitation is difficult to overcome, when determining damage to the structure relates to the difference of the damaged structure's natural frequency and the undamaged structure's natural frequency. In such methods, these two data sets must be known to yield relevant damage information.

Yet, it is not always possible to have data representative of the undamaged structure. Thus, the conventional SHM damage diagnosis methods incorporate this disadvantage—requiring this data from the undamaged structure. This limitation is so pronounced, that indeed one of the proposed axioms in the field of SHM is “the assessment of damage requires a comparison between two system states.”

In spite of considerable progress in the field of damage identification using vibration-based methods, there is still a lack of a successful system and method to detect damage. For example, in 1995, in the review published by Dimarogonas (1996), it is concluded “a consistent cracked beam vibration theory is yet to be developed.” In 2005, in another review about vibration-based structural health monitoring, Carden and Fanning (2004) conclude, “there is no universal agreement as to the optimum method for using measured vibration data for damage detection, location or quantification.” Similarly, one of the conclusions in Montalvao et al. (2006) includes “there is no general algorithm that allows the resolution of all kinds of problems in all kinds of structures.” Similar trends regarding a lack of generality of proposed models is seen in a more recent review by Fan and Qiao (2010).

Damage occurs in a variety of shapes and sizes, and can occur in structures of different shapes. Most of the literature, however, concentrates on either sharp cracks or rectangular notches in uniform beams of rectangular cross-sections. Thus, investigation of the interaction of the effect of the shape of the damage on the shape of the structure will give rise to design considerations that will aid in detection and characterization of damage.

Typically after detection and characterization of damage, the next question is to determine the dynamic characteristics of the structure with the damage. Presently, this is done using Finite Element Analysis (FEA) software. Yet, this can be a costly step both as to time and money, because suddenly the number of elements required to model the structure increases by orders of magnitude as the element size needs to be of the order of the damage detected.

In view of this background of the primary shortcomings of the conventional damage diagnosis, new SHM methods and systems need to be developed. Such new SHM methods and systems should overcome the variety of conventional disadvantages, including (i) the lack of a general method to detect damages in all kinds of structures, that can combines the advantages of vibration-based methods and wave propagation-based methods, and also eliminates the requirement of baseline data from the undamaged structures; (ii) the lack of a general method to determine the response of a damaged structure; and (iii) the lack of a general understanding of the design considerations that will help in damage diagnosis. Such new SHM methods and systems should also require much less time as compared to presently available FEA methods, yet provide results that are comparable in accuracy to those obtained by FEA methods. It is to such methods and systems that that present invention is primarily directed.

### BRIEF SUMMARY OF THE INVENTION

Briefly described, in preferred form, the present invention comprises a unified framework that yields modes and natural frequencies for damaged structures, systems and methods for discovering damage in structures, systems and methods of modeling how a structure will behave once damage has been discovered, and determining design considerations that will aid in detection of damage.

Regarding a first objective of the present invention, that of providing systems and methods for damage diagnosis applicable to generic structures, as discussed, there are two main methods used to find damages in structures: vibration-based, and wave propagation-based. The present invention combines the advantages of both the wave propagation-based and vibration-based methods, and eliminates the conventional need of knowledge of a baseline metric, for example, knowing the undamaged structure's natural frequency in order to determine if the structure has damage. Thus, the present invention is more sensitive than existing vibration-based methods, and also does not require a baseline state for damage localization.

The first objective of the present invention is to provide a unified framework that yields expressions for nth-order perturbation equations governing vibration characteristics, for example, mode shapes and natural frequencies, for damaged elastic. The framework is applicable to damaged systems for arbitrary boundary conditions, and applies to structures with any damage profile and having more than one area of damage. The present framework considers the geometric discontinuity at the damage location, but it makes no ad hoc assumptions regarding the physical behavior at the damage location such as added springs or changes in Young's modulus. The geometric discontinuity manifests itself in terms of discontinuities in cross-sectional properties, such as depth, area or area moment of inertia. When the modes and natural frequencies are perturbed, a set of differential equations is obtained, one for each order, albeit again with constant cross-sectional properties. Solutions of these perturbation equations are obtained. The framework incorporates the change in mass due to damage, where applicable.

The present invention considers the response of the damaged structure as a sum of that due to the undamaged structure and that of the damage alone. Then, the response due to damage alone is isolated to find where the damage is located. As such, a sensitivity problem plaguing conventional vibration-based methods is not an issue. The present invention isolates the response due to that of the damage alone, and thus there is no loss of sensitivity since the dominant response of the undamaged structure does not clutter the observation. Further, the present invention eliminates the need for a baseline metric, for example, knowing the undamaged structure's natural frequency in order to determine if the structure has damage.

The present invention comprises finding the structural response of the damaged structure (DSR), then recognizes that DSR equals the response due to the undamaged part of the damaged structure (UPR) plus the response due to the damaged part of the damaged structure (DPR). The DPR is then isolated. Since DPR is solely due to the damage, it localizes the damage efficiently. The present method is illustrated for the structural responses determined near the natural frequencies.

The present invention overcomes the disadvantages of the conventional method that determines DSR, then determines the undamaged structural response (USR), then defines a quantity Q that equals USR minus DSR, and lastly finds the damage using Q.

In the conventional method, one needs USR (which is not always available), and that the quantity Q is a mix of a part of UPR (which is a relatively large value) and DPR (which is a relatively minute value). Thus, it is abundantly clear that finding DPR using Q is difficult due to low sensitivity.

Regarding a second objective of the present invention, that of providing systems and methods for discovering damage in structures, a partial mode contribution system and method of damage diagnosis is presented. A novel physical parameter is applied to damage detection to address the two main challenges in the field of vibration-based SHM, the sensitivity of detection and the requirement of data from baseline state. The parameter is not affected by noise in the detection ambience. Assuming linear superposition, the response of a damaged structure is expressed as the summation of the responses of the corresponding undamaged structure, and the response (negative response) of the damage alone. If the second part of the response is isolated, it forms a damage signature. This damage signature gives a clear indication of the damage.

The present invention comprises the formulation of the partial mode contribution of the damage signature, wherein the damaged structure is excited at one of its natural frequencies. The existence of the damage signature as a partial mode contribution is ascertained using analytical derivation of the unified framework, and thereupon ascertained using finite element models and experiments. The limits of damage size that can be determined using the present method are also disclosed.

Regarding a third objective of the present invention, that of providing systems and methods of modeling how a structure will behave once damage has been discovered, the present invention utilizes the unified framework and uses two methods, an equivalent stiffness method, and an equivalent force method. The present methods are faster than the conventional method of FEA, and therefore are cheaper to implement.

The vibration characteristics of three-dimensional structures having notched rods are investigated. The equivalent force method and the equivalent stiffness method both enable systematic calculation of displacements. In the former, the damage is modeled as an equivalent force, and in the later, it is modeled as change in stiffness of. Both methods work on the principle of drawing an analogy between the perturbation displacements and additional fictitious degrees of freedom.

Regarding a fourth objective of the present invention, that of providing systems and methods of determining design considerations that will aid in detection of damage, the present invention provides for the derivation of a structure that will not change its natural frequency if there is loss or addition of mass or stiffness in the structure. Further, a corollary from this derivation is another useful aspect in SHM design considerations. If structures can be designed that are very sensitive to changes in natural frequencies, then, natural frequency-based detection methods (which form a large segment of presently used research methods), will be more adept to detect the damages. In a preferred embodiment, a structure that will not change its natural frequency if there is loss or addition of mass or stiffness in the structure is a T-beam.

The objective is to ascertain the effect of the same type of damage placed on beams of different cross-sections, such as a T-beam and a rectangular beam. Although a direct precedence for modeling different types of damage using vibration-based techniques was previously not known, work has been done in the area by using Lamb waves for such a characterization. Two main types of damage are considered in the conventional techniques, a rectangular notch or a sharp crack, and modeled in a variety of ways. Experimental results for a composite T-beam are known, but no theoretical model for damage is given.

The present invention considers that the shape of the beam plays an important role in the sensitivity of damage identification. First, it is shown herein that the natural frequencies of a T-beam having the same cross-sectional area (or mass per unit length) as a rectangular beam is less sensitive to damage than a rectangular beam, holding the magnitude of the damage constant. It is further shown that the effect of moment of inertia on the natural frequency decreases for higher frequencies, a fact not represented by Euler-Bernoulli beam theory. It is also ascertained that Timoshenko beam theory is a better choice to predict the natural frequencies of a damaged beam for natural frequencies higher than the first two.

In a preferred embodiment, the present invention comprises a process, a system and computer-readable medium comprising computer-executable instructions for modeling an element with a discontinuity to obtain one or more vibrational characteristics of the element with the discontinuity. In such an embodiment, the one or more vibrational characteristics of the element without the discontinuity are known, as well as the characteristics of the discontinuity.

This unified framework provides the vibration characteristics of the element with a discontinuity (a structure with damage), and that information can be used in a number of other applications. This is a general, vibrational-based framework applicable with any shape of structure, having any number and characteristics of damage.

The process, system and computer-readable medium comprising computer-executable instructions begin with knowledge of the physical characteristics of the element, and the one or more vibrational characteristics of the element without the discontinuity. For example, the physical characteristics of the element can include the geometric properties of the element, the geometric properties of the discontinuity, the material properties of the element, and the material properties of the discontinuity. This data can include dimensions like length, width, height, and cross-sectional area, and include material properties like Young's modulus, Poisson's ratio, and density.

In this preferred embodiment, with the known physical characteristics of the element, and the one or more vibrational characteristics of the element without the discontinuity, the process, system and computer-readable medium comprising computer-executable instructions comprises perturbing one or more vibrational characteristics of the element without the discontinuity based on characteristics of the discontinuity, calculating nth-order, perturbed differential equations governing one or more vibrational characteristics of the element with the discontinuity, wherein n is 1 or greater, and solving the perturbed differential equations to obtain one or more vibrational characteristics of the element with the discontinuity.

Solving the perturbed differential equations to obtain one or more vibrational characteristics of the element with the discontinuity can include using a convolution integral in space domain over the domain of the discontinuity.

In another preferred embodiment, the present invention comprises a process, a system and computer-readable medium comprising computer-executable instructions for modeling a multi-element structure with finite element analysis, wherein at least one of the multi-elements has a discontinuity, the process to obtain one or more vibrational characteristics of the multi-element structure, the process comprising, for each of the elements of the multi-elements having a discontinuity, providing the physical characteristics of the element, providing a finite element method code, perturbing one or more vibrational characteristics of the element without the discontinuity based on the physical characteristics of the discontinuity, calculating nth-order, perturbed differential equations governing one or more vibrational characteristics of the element with the discontinuity, wherein n is 1 or greater, and forming a finite element where the discontinuity is modeled as an equivalent (negative) force, wherein the finite element is used with the finite method element code to obtain one or more vibrational characteristics of the entire multi-element structure.

In another preferred embodiment, the present invention comprises a process, a system and computer-readable medium comprising computer-executable instructions for modeling a multi-element structure with finite element analysis, wherein at least one of the multi-elements has a discontinuity, the process to obtain one or more vibrational characteristics of the multi-element structure, the process comprising, for each of the elements of the multi-elements having a discontinuity, providing the physical characteristics of the element, providing a finite element method code, perturbing one or more vibrational characteristics of the element without the discontinuity based on the physical characteristics of the discontinuity, calculating nth-order, perturbed differential equations governing one or more vibrational characteristics of the element with the discontinuity, wherein n is 1 or greater, and forming a finite element where the discontinuity is modeled as an equivalent (negative) stiffness, wherein the finite element is used with the finite method element code to obtain one or more vibrational characteristics of the entire multi-element structure.

In another preferred embodiment, the present invention comprises a process, a system and computer-readable medium comprising computer-executable instructions for designing a desired element without a discontinuity with one or more desired vibrational characteristics when related to the element modeled as having a discontinuity, the process comprising, modeling an element with a discontinuity to obtain one or more vibrational characteristics of the element with the discontinuity, the modeling process comprising, providing the physical characteristics of the element, providing one or more vibrational characteristics of the element without the discontinuity, perturbing one or more vibrational characteristics of the element without the discontinuity based on characteristics of the discontinuity, calculating nth-order, perturbed differential equations governing one or more vibrational characteristics of the element with the discontinuity, wherein n is 1 or greater, and solving the perturbed differential equations to obtain one or more vibrational characteristics of the element with the discontinuity, altering one or more vibrational characteristics of the element with the discontinuity with reference to the physical characteristics of the element, and obtaining the desired element with one or more desired vibrational characteristics when related to the element having a discontinuity.

In another preferred embodiment, the present invention comprises a process, a system and computer-readable medium comprising computer-executable instructions for detecting a discontinuity in an element, wherein the element has one or more continuous parts, each with no discontinuity, and if the element has a discontinuity, the element also has one or more discontinuous parts, each with a discontinuity, the process comprising providing one or more vibrational characteristics of the element modeled having no discontinuity, determining one or more vibrational characteristics of the element having a discontinuity, expressing one or more vibrational characteristics of the element as a sum of the one or more vibrational characteristics due to the element having no discontinuity to obtain the part of the one or more vibrational characteristics due to the continuous part of the element, and the part of the one or more vibrational characteristics due to the discontinuous part of the element, and isolating the part of the one or more vibrational characteristics due to the discontinuous part of the element.

The physical characteristics of the element can include one or more of spatial, geometric and material characteristics of the element, and in some circumstances, the physical characteristics of the element include the physical characteristics of any discontinuity in the element as well.

The vibrational characteristics can include one or more of mode shapes, natural frequencies, displacements, sectional rotations, shears, moments, stresses and strains. The vibrational characteristics can further include one or more of displacement mode shapes, sectional rotation mode shapes, derivatives of displacement mode shape, derivatives of sectional rotational mode shape, and combinations involving their sum or product.

The element can be a physical structure.

The discontinuity can be damage to the element.

The element comprises more than one discontinuity.

These and other objects, features and advantages of the present invention will become more apparent upon reading the following specification in conjunction with the accompanying drawing figures.

### BRIEF DESCRIPTION OF THE DRAWINGS

FIG. 1 depicts a notched beam representative of a structure with damage.

FIG. 2 depicts an experimental setup to find the natural frequencies and mode shapes of a damaged beam structure.

FIG. 3 is a graph of frequency response function, averaged velocity (m/s) against frequency (Hz) to determine the natural frequencies.

FIG. 4 is a graph of displacement mode shapes (normalized): experimental damaged mode (dots), experimental data curve fitted using undamaged modes (dashed), analytical undamaged mode (light), analytical damaged mode (dark).

FIG. 5 is a graph of curvature shapes (normalized): experimental undamaged curvature (lightest), experimental damaged curvature (light), analytical undamaged curvature (dark), analytical damaged curvature (darkest).

FIG. 6 is a graph of normalized difference between normalized damaged and undamaged, mode shapes and curvature shapes: experimental-analytical mode (darker), experimental-experimental mode (dark), analytical-analytical mode (dashed), experimental-analytical curvature (darkest), experimental-experimental curvature (light), analytical-analytical curvature (lightest).

FIG. 7 is a graph of damage signature (normalized partial mode contribution): experimental (dark), analytical (darker), displacement mode (solid line), curvature mode (dashed line).

FIG. 8 is a graph of damage signature of normalized modes and curvatures, mode 1 (dark), mode 2 (darker).

FIG. 9 is a graph of damaged (dashed lines) and undamaged (continuous lines) beam mode shapes ζ_{d}=0.35, ε=0.1, ΔL_{Z}=0.01.

FIG. 10 is a graph of damaged (dashed lines) and undamaged (continuous lines) beam curvature shapes ζ_{d}=0.35, ε=0.1, ΔL_{Z}=0.01.

FIG. 11 is a graph of the difference between damaged and undamaged beam, normalized, mode shape (continuous lines) and curvature shape (dashed lines) ζ_{d}=0.35, ε=0.1, ΔL_{Z}=0.01.

FIG. 12 is a graph of the partial mode contribution, mode shape (continuous lines) and curvature shape (dashed lines) ζ_{d}=0.35, ε=0.1, ΔL_{Z}=0.01, first twelve modes considered.

FIG. 13 is a graph of damaged (dashed lines) and undamaged (continuous lines) beam mode shapes ζ_{d}=0.5, ε=0.1, ΔL_{Z}=0.01.

FIG. 14 is a graph of damaged (dashed lines) and undamaged (continuous lines) beam curvature shapes ζ_{d}=0.5, ε=0.1, ΔL_{Z}=0.01.

FIG. 15 is a graph of the difference between damaged and undamaged beam, normalized, mode shape (continuous lines) and curvature shape (dashed lines) ζ_{d}=0.5, ε=0.1, ΔL_{Z}=0.01.

FIG. 16 is a graph of the partial mode contribution, mode shape (continuous lines) and curvature shape (dashed lines) ζ_{d}=0.5, ε=0.1, ΔL_{Z}=0.01, first twelve modes considered.

FIG. 17 is a graph of damaged (dashed lines) and undamaged (continuous lines) beam mode shapes ζ_{d}=0.7, ε=0.1, ΔL_{Z}=0.01.

FIG. 18 is a graph of damaged (dashed lines) and undamaged (continuous lines) beam curvature shapes ζ_{d}=0.7, ε=0.1, ΔL_{Z}=0.01.

FIG. 19 is a graph of the difference between damaged and undamaged beam, normalized, mode shape (continuous lines) and curvature shape (dashed lines) ζ_{d}=0.7, ε=0.1, ΔL_{Z}=0.01.

FIG. 20 is a graph of the partial mode contribution, mode shape (continuous lines) and curvature shape (dashed lines) ζ_{d}=0.7, ε=0.1, ΔL_{Z}=0.01, first twelve modes considered.

FIG. 21 is a graph of the difference between damaged and undamaged beam, normalized, mode Shape (continuous lines) and curvature shape (dashed lines) ζ_{d}=0.35, ε=0.01, ΔL_{Z}=0.01.

FIG. 22 is a graph of the partial mode contribution, mode shape (continuous lines) and curvature shape (dashed lines) ζ_{d}=0.35, ε=0.01, ΔL_{Z}=0.01, first twelve modes considered.

FIG. 23 is a graph of damaged (dashed lines) and undamaged (continuous lines) beam curvature shapes ζ_{d}=0.35, ε=0.4, ΔL_{Z}=0.01.

FIG. 24 is a graph of the difference between damaged and undamaged beam, normalized, mode shape (continuous lines) and curvature shape (dashed lines) ζ_{d}=0.35,ε=0.4, Δ_{L}=0.01.

FIG. 25 is a graph of the partial mode contribution, mode shape (continuous lines) and curvature shape (dashed lines) ζ_{d}=0.35, ε=0.4, ΔL_{Z}=0.01, first twelve modes considered.

FIG. 26 is a graph of the difference between damaged and undamaged beam, normalized, mode shape (continuous lines) and curvature shape (dashed lines) ζ_{d}=0.35, ε=0.1, ΔLz=0.001.

FIG. 27 is a graph of the partial mode contribution, mode shape (continuous lines) and curvature shape (dashed lines) ζ_{d}=0.35, ε=0.1, ΔL_{Z}=0.001, first twelve modes considered.

FIG. 28 is a graph of damaged (dashed lines) and undamaged (continuous lines) beam curvature shapes ζ_{d}=0.35, ε=0.1, ΔL_{Z}=0.1.

FIG. 29 is a graph of the difference between damaged and undamaged beam, normalized, mode shape (continuous lines) and curvature shape (dashed lines) ζ_{d}=0.35, ε=0.1, ΔL_{Z}=0.1.

FIG. 30 is a graph of the partial mode contribution, mode shape (continuous lines) and curvature shape (dashed lines) ζ_{d}=0.35, ε=0.1, ΔL_{Z}=0.1, first twelve modes considered.

FIG. 31 depicts a rod geometry.

FIG. 32 depicts a rod element.

FIG. 33 is a schematic for the spectral finite elements for the clamped-free rod.

FIG. 34 is a graph of the modulated sinusoidal pulse load in time and frequency domain.

FIG. 35 illustrates one way coupling between the zeroth and first order displacements for the rod element of FIG. 32.

FIG. 36 illustrates a preferred embodiment of the algorithm used for ESM and EQM.

FIG. 37 illustrates a preferred direct stiffness method of the present invention.

FIGS. 38-39 illustrate structures on which the ESM and EQM were tested.

FIG. 40 illustrates a graph of the frequency difference between a damaged and an undamaged beam, to illustrate how a beam may be designed to react to damage as designed.

### DETAILED DESCRIPTION OF THE INVENTION

To facilitate an understanding of the principles and features of the various embodiments of the invention, various illustrative embodiments are explained below. Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity. In particular, the invention is described in the context of being a wireless module for operation at ultra-high frequencies and ultra-high data communication speeds.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

A General Damage Theory: Solution of n^{th}-Order Equations Using Unified Framework

Nomenclature

E Young's modulus
P Mass density
μ Mode Shape (displacement, sectional rotation, bending strain or shear strain)
ud Undamaged (subscript)
d Damaged (subscript)
χ Numerical factor for main mode shape
ξ Numerical factor for secondary mode shapes
x Space representation (1-D for beams, 2-D for plates and shells)
L_{b} Length of beam
h Depth of beam
H Heaviside function
ε Ratio of depth of damage to total depth
Δl Width of damage
L Stiffness operator
M Mass operator

### φ Eigenfunction

I Area moment of inertia
A Area of cross-section

### λ Eigenvalues

ω Natural frequency
z Subscript for non-dimensionalized quantity
Eₘ Mass defect
Eₛ Stiffness defect
u(x,t) Axial Displacement
[K] Stiffness of undamaged rod
[T] Transformation matrix
[A] Stiffness change due to damage
f(x,t) Applied Load

### G Shear Modulus

̂ Any quantity with had denotes the quantity at element level
i Superscript denotes the i^{th} order perturbation

The general eigenvalue problem to determine the mode shapes and natural frequencies of elastic structures like rods, beams, plates and shells is given in Meirovitch (1997):

Lφ(x₁)−λMφ(x₁)=0 (1)

where L is the stiffness operator, M is the inertia matrix and λ is the eigenvalue. The order of L is an even integer, 2p. The Equation is valid for conservative distributed parameter structures, which represent a very large and important class of systems, namely self-adjoint systems. λ=ω² where ω is the natural frequency and φ is the eigenfunction or the mode shape. xᵢ the space dimension, i represents the direction), it denotes the one-dimensional space in case of beams, two-dimensional space in case of plates and shells and three-dimensional space in case of three-dimensional structures. The displacements and rotations corresponding to the spatial dimension xᵢ are uᵢ and θᵢ, respectively. In case of an Euler-Bernoulli beam, the variables of Equation (1) are given by:

$$L = \frac{{d}^{2} {H}_{33} ( {x}_{1} )}{d {x}_{1}^{2}} \frac{{d}^{2}}{d {x}_{1}^{2}} M = m ( {x}_{1} ) φ ( {x}_{1} ) = {u}_{1} ( {x}_{1} ) \\ {H}_{33} ( {x}_{1} ) = E ( {x}_{1} ) {I}_{3} ( {x}_{1} ) \qquad ( 2 )$$

and in the case of a Timoshenko beam their values are

$$L = [ \begin{matrix}\frac{d {K}_{22} ( {x}_{1} ) d}{d {x}_{1}^{2}} & \frac{d {K}_{22} ( {x}_{1} )}{d {x}_{1}} \\ - \frac{{K}_{22} ( {x}_{1} ) d}{d {x}_{1}} & {K}_{22} ( {x}_{1} ) - \frac{d {H}_{33} ( {x}_{1} ) d}{d {x}_{1}^{2}}\end{matrix} ] \\ M = [ \begin{matrix}m ( {x}_{1} ) & 0 \\ 0 & J ( {x}_{1} )\end{matrix} ] \\ φ ( x ) = \{ \begin{matrix}{u}_{1} ( {x}_{1} ) \\ {θ}_{3} ( {x}_{1} )\end{matrix} \} {K}_{22} ( {x}_{1} ) = κ G ( {x}_{1} ) A ( {x}_{1} ) \qquad ( 3 )$$

where E, G, I, m and J are the Young's modulus, shear modulus, area moment of inertia, mass per unit length and mass moment of inertia per unit length respectively, ρ is the density and A the area. All the quantities are functions of space dimension xₗ. κ is the shear factor.

In case of plates or shells L is a partial differential operator. For Kirchhoff's plate theory the variables of Equation (1) are given by:

$$L = {∇}^{2} D {∇}^{2} - ( 1 - v ) ( \frac{{\partial }^{2} D}{\partial {x}_{2}^{2}} \frac{{\partial }^{2}}{\partial {x}_{1}^{2}} - 2 \frac{{\partial }^{2} D}{\partial {x}_{1} \partial {x}_{2}} \frac{{\partial }^{2}}{\partial {x}_{1} \partial {x}_{2}} + \frac{{\partial }^{2} D}{\partial {x}_{1}^{2}} \frac{{\partial }^{2}}{\partial {x}_{2}^{2}} ) \\ φ = {u}_{3} ( {x}_{1} , {x}_{2} ) \\ D = \frac{E ( {x}_{1} , {x}_{2} ) {h ( {x}_{1} , {x}_{2} )}^{3}}{12 ( 1 - {v}^{2} )} M = ρ ( {x}_{1} , {x}_{2} ) h ( {x}_{1} , {x}_{2} ) \qquad ( 4 )$$

and for Mindlin plate theory their values are given by:

$$L = [ \begin{matrix}\frac{\partial D \partial }{\partial {x}_{1}^{2}} - \frac{\partial D / 2 ( 1 - v ) \partial }{\partial {x}_{2}^{2}} + F & - \frac{\partial Dv \partial }{\partial {x}_{1} \partial {x}_{2}} - \frac{\partial D / 2 ( 1 - v ) \partial }{\partial {x}_{2} \partial {x}_{1}} & - F \frac{\partial }{\partial {x}_{1}} \\ - \frac{\partial D / 2 ( 1 - v ) \partial }{\partial {x}_{1} \partial {x}_{2}} - \frac{\partial Dv \partial }{\partial {x}_{2} \partial {x}_{1}} & - \frac{\partial D / 2 ( 1 - v ) \partial }{\partial {x}_{1}^{2}} - \frac{\partial D \partial }{\partial {x}_{2}^{2}} + F & - F \frac{\partial }{\partial {x}_{2}} \\ \frac{\partial F}{\partial {x}_{1}} & \frac{\partial F}{\partial {x}_{2}} & - \frac{\partial D \partial }{\partial {x}_{1}^{2}} - \frac{\partial D \partial }{\partial {x}_{2}^{2}}\end{matrix} ] \\ M = ρ ( {x}_{1} , {x}_{2} ) h ( {x}_{1} , {x}_{2} ) [ \begin{matrix}\frac{{h ( {x}_{1} , {x}_{2} )}^{2}}{12} & 0 & 0 \\ 0 & \frac{{h ( {x}_{1} , {x}_{2} )}^{2}}{12} & 0 \\ 0 & 0 & 1\end{matrix} ] φ = \{ \begin{matrix}{θ}_{1} ( {x}_{1} , {x}_{2} ) \\ {θ}_{2} ( {x}_{1} , {x}_{2} ) \\ {u}_{3} ( {x}_{1} , {x}_{2} )\end{matrix} \} \\ F = κ G ( {x}_{1} , {x}_{2} ) h ( {x}_{1} , {x}_{2} ) \qquad ( 5 )$$

In the above Equations, h(x₁, x₂) is the depth of the plate, θ₁ (x₁, x₂), and θ₂ (x₁, x₂) are plate rotations about the x₁ and x₂ axis respectively. u₁(x₁, x₂) is the transverse displacement.

The boundary conditions for Equation (1) are given by:

Bᵢφ(xⱼ)=0 i=1,2 . . . ,p (6)

where Bᵢ is a differential operator of maximum order of 2p−1. Examples of clamped, pinned and free boundary conditions for Euler-Bernoulli are given by:

$${B}_{i} = \{ \begin{matrix}1 \\ \frac{d}{d {x}_{1}}\end{matrix} \} @ {x}_{1} = clamped \\ {B}_{i} = EI \{ \begin{matrix}1 \\ \frac{{d}^{2}}{d {x}_{1}^{2}}\end{matrix} \} @ {x}_{1} = pinned {B}_{i} = EI \{ \begin{matrix}\frac{{d}^{2}}{d {x}_{1}^{2}} \\ \frac{{d}^{3}}{d {x}_{1}^{3}}\end{matrix} \} @ {x}_{1} = free \qquad ( 7 )$$

and for Timoshenko beam theory by:

$${B}_{i} = [ \begin{matrix}1 & 0 \\ 0 & 1\end{matrix} ] @ {x}_{1} = clamped {B}_{i} = [ \begin{matrix}1 & 0 \\ 0 & \frac{d}{d {x}_{1}}\end{matrix} ] @ {x}_{1} = pinned {B}_{i} = [ \begin{matrix}\frac{d}{d {x}_{1}} & - 1 \\ 0 & \frac{d}{d {x}_{1}}\end{matrix} ] @ {x}_{1} = free \qquad ( 8 )$$

The boundary condition for an edge parallel to x₁, for clamped, pinned and free end of the plate, according to Kirchhoff's plate theory is given by:

$${B}_{i} = \{ \begin{matrix}1 \\ \frac{\partial }{\partial {x}_{1}}\end{matrix} \} @ {x}_{1} = clamped \\ {B}_{i} = EI \{ \begin{matrix}1 \\ \frac{{\partial }^{2}}{\partial {x}_{1}^{2}}\end{matrix} \} @ {x}_{1} = pinned \\ {B}_{i} = EI \{ \begin{matrix}\frac{{\partial }^{2}}{\partial {x}_{1}^{2}} + v \frac{{\partial }^{2}}{\partial {x}_{2}^{2}} \\ \frac{\partial Dv}{\partial {x}_{1}} \frac{{\partial }^{2}}{\partial {x}_{2}^{2}} + \frac{\partial D}{\partial {x}_{1}} \frac{{\partial }^{2}}{\partial {x}_{1}^{2}} + 2 \frac{\partial D ( 1 - v )}{\partial {x}_{2}} \frac{{\partial }^{2}}{\partial {x}_{1} \partial {x}_{2}}\end{matrix} \} @ {x}_{1} = free \qquad ( 9 )$$

and for Mindlin plate theory is given by:

$${B}_{i} = [ \begin{matrix}1 & 0 & 0 \\ 0 & 1 & 0 \\ 0 & 0 & 1\end{matrix} ] @ x = clamped {B}_{i} = [ \begin{matrix}\frac{\partial }{\partial {x}_{1}} & v \frac{\partial }{\partial {x}_{2}} & 0 \\ 0 & 1 & 0 \\ 0 & 0 & 1\end{matrix} ] @ x = pinned {B}_{i} = [ \begin{matrix}\frac{\partial }{\partial {x}_{1}} & v \frac{\partial }{\partial {x}_{2}} & 0 \\ \frac{\partial }{\partial {x}_{2}} & \frac{\partial }{\partial {x}_{1}} & 0 \\ 1 & 0 & \frac{\partial }{\partial {x}_{1}}\end{matrix} ] @ x = free \qquad ( 10 )$$

The damage model presented herein models the change in cross-sectional thickness at the damage location. If the damage depth is h_{d}(xᵢ) then at the damage location the depth becomes h−h_{d}(xᵢ), where h is the constant depth at the undamaged location. Further a quantity h_{d} is defined which gives the average depth of the damage given by:

$${\overline{h}}_{d} = {\int }_{Ω} {h}_{d} ( {x}_{i} ) d {x}_{i} \qquad ( 11 )$$

where Ω gives the domain of damage. Therefore, the depth of the structure is given by:

$$h ( {x}_{i} ) = h - {\overline{h}}_{d} γ ( {x}_{i} ) = h ( 1 - εγ ( {x}_{i} ) ) \\ ε = \frac{{\overline{h}}_{d}}{h} \qquad ( 12 )$$

where γ(xᵢ) is the damage profile function and ε gives ratio of the depth of damage to the depth at the undamaged location.

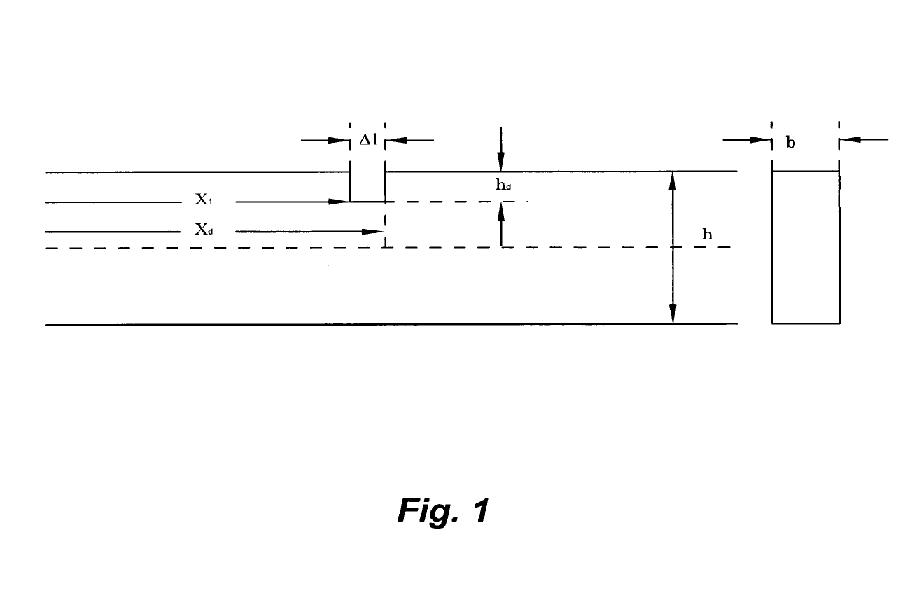

For example, consider a beam of uniform rectangular cross-section of width b and depth h as shown in FIG. 1. A rectangular through-thickness notch-shaped damage is located at x=x_{d} with a width of Δl and depth of h_{d}. Notice in this case h̅_{d}=h_{d}. The damage profile function is given by:

h(x₁)=h− h̅_{d}(H(x₁−x_{1d})−H(x₁−x_{1d}−l)))=h(1−εγ(x₁))

γ(x₁)=H(x₁−x_{1d})−H(x₁−x_{1d}−Δl) (13)

Here H(x−x₁) denotes the Heaviside function. Other representations of the crack profile functions of beams for different types of damages are given by:

For a V-shaped notch:

γ(x₁)=<x₁−x_{1d}<−2<x₁−x_{1d}−Δl/2>+<x₁−x_{1d}−Δl> (14)

where < >denotes ramp function. For a half V notch:

γ(x₁)=<x₁−x_{1d}>−H(x₁−x_{1d}−Δl)+<x₁−x_{1d}−Δl> (15)

For a saw-cut damage the definition of differentiation is used:

γ(x₁)=H(x₁−x_{1d})−H(x₁−x_{1d}−Δl)=Δlδ(x₁−x_{1d}) (16)

Damage does not always occur in shapes giving regular profiles. In the cases where damage cannot be represented as a regular profile as listed above, a convolution integral is used to obtain the expressions for mode shapes and natural frequencies using the crack profile function of saw cut damage as described hereinafter.

The concept of damage profile functions may be applied to multi-dimensional structures and multi-dimensional damages. For a plate, the damage profile function defined for a sharp crack is given by:

$$\begin{matrix}γ ( {x}_{1} , {y}_{1} ) = ( H ( {x}_{1} - {x}_{1 d} ) - H ( {x}_{1} - {x}_{1 d} - Δ {l}_{1} ) ) \\ ( H ( {y}_{1} - {y}_{1 d} ) - H ( {y}_{1} - {y}_{1 d} - Δ {l}_{2} ) ) \\ = Δ A δ ( {x}_{1} - {x}_{1 d} ) δ ( {y}_{1} - {y}_{1 d} )\end{matrix} \qquad ( 17 )$$

Δlᵢ gives the width of the damage in the i^{th} direction.

Multiple types of damage may be tackled using this methodology by summing the different crack profile functions for individual points of damage to represent a consolidated crack profile function.

$$γ ( {x}_{j} ) = {\sum }_{i = 1}^{i = N} {γ}_{i} ( {x}_{j} ) \qquad ( 18 )$$

The change in the depth also manifests itself as changes in cross-sectional properties. The change in moment of inertia and cross-sectional area can be written as:

I(x)=I₀+εIₐ+ε²I_{b}+ε³I_{c}+ε⁴I_{d}A(x)=A₀+εAₐ+ε²A_{b} (19)

For example for a rectangular beam the moment of inertia is given by:

$$I = \frac{{bh ( x )}^{3}}{12} = \frac{{bh}^{3}}{12} ( 1 - 3 εγ ( x ) + 3 {ε}^{2} {γ ( x )}^{2} - {ε}^{3} {γ ( x )}^{3} ) \qquad ( 20 )$$

Comparing with Equation (19):

Iₐ=−3I₀γ(x)I_{b}=3I₀ε²γ(x)²I_{c}=−ε³γ(x)³I₀I_{d}=0 (21)

Based on the above explanation, the stiffness and mass operator are written as

L=L₀+εL₁+ε²L₂+ε³L₃+ε⁴L₄

M=M₀+εM₁+ε²M₂+ε³M₃+ε⁴M₄ (22)

For example, the stiffness operator for Timoshenko beam theory can be written as:

$$L = [ \begin{matrix}- \frac{d κ G ( {A}_{0} + ε {A}_{1} + {ε}^{2} {A}_{2} ) d}{d {x}_{1}^{2}} & \frac{d κ G ( {A}_{0} + ε {A}_{1} + {ε}^{2} {A}_{2} ) d}{d {x}_{1}} \\ - \frac{κ G ( {A}_{0} + ε {A}_{1} + {ε}^{2} {A}_{2} ) d}{d {x}_{1}} & \begin{matrix}κ G ( {A}_{0} + ε {A}_{1} + {ε}^{2} {A}_{2} ) - \\ \frac{d E ( {I}_{0} + ε {I}_{1} + {ε}^{2} {I}_{2} + {ε}^{3} {I}_{3} + {ε}^{4} {I}_{4} ) d}{d {x}_{1}^{2}}\end{matrix}\end{matrix} ] \qquad ( 23 )$$

Comparing Equations (22) and (23):

$${L}_{0} = [ \begin{matrix}- \frac{d κ {GA}_{0} d}{d {x}_{1}^{2}} & \frac{d κ {GA}_{0} d}{d {x}_{1}} \\ - \frac{κ {GA}_{0} d}{d {x}_{1}} & κ {GA}_{0} - \frac{d E ( {I}_{0} ) d}{d {x}_{1}^{2}}\end{matrix} ] \\ {L}_{1} = [ \begin{matrix}- \frac{d κ {GA}_{1} d}{d {x}_{1}^{2}} & \frac{d κ {GA}_{1} d}{d {x}_{1}} \\ - \frac{κ {GA}_{1} d}{d {x}_{1}} & κ {GA}_{1} - \frac{d E ( {I}_{1} ) d}{d {x}_{1}^{2}}\end{matrix} ] \\ {L}_{2} = [ \begin{matrix}- \frac{d κ {GA}_{2} d}{d {x}_{1}^{2}} & \frac{d κ {GA}_{2} d}{d {x}_{1}} \\ - \frac{κ {GA}_{2} d}{d {x}_{1}} & κ {GA}_{2} - \frac{d E ( {I}_{2} ) d}{d {x}_{1}^{2}}\end{matrix} ] \\ {L}_{3} = [ \begin{matrix}0 & 0 \\ 0 & - \frac{d E ( {I}_{3} ) d}{d {x}_{1}^{2}}\end{matrix} ] {L}_{4} = [ \begin{matrix}0 & 0 \\ 0 & - \frac{d E ( {I}_{4} ) d}{d {x}_{1}^{2}}\end{matrix} ] \qquad ( 24 )$$

In the above Equations, the subscript 0 is for the nominal quantities at an undamaged location.

As the quantity ε is small, the function φ(xⁱ) and λ are expanded using perturbation theory as the following series:

φ(xᵢ)=φ(xᵢ)⁰+εφ(xᵢ)¹+ε²φ(xᵢ)²− . . . λ=λ⁰+ελ¹+ε²λ²− . . . (25)

The superscripts of φ and λ denote the order of perturbation.

The next step is non-dimensionalization, which identifies the number of parameters affecting the results. The contents of the Equations are non-dimensionalized using:

$${ζ}_{i} = \frac{{x}_{i}}{L} {u}_{{z}_{i}} = \frac{{u}_{i}}{L} {θ}_{{z}_{i}} = {θ}_{i} {γ}_{z} ( {ζ}_{i} ) = γ ( {x}_{i} ) \qquad ( 26 )$$

The subscript z is used for the non-dimensionalized quantity.

Equations (22), (25) and (26) are substituted into (1), and then they are non-dimensionalized to give the Equations of order 0, 1, 2 and 3 in ε as

$$\begin{matrix} {ε}^{0} \text{:} {L}_{{z}_{0}} {φ}^{0} - {λ}_{z}^{0} {M}_{{z}_{0}} {φ}^{0} = 0 & ( 27 a ) \\ {ε}^{1} \text{:} {L}_{{z}_{0}} {φ}^{1} - {λ}_{z}^{0} {M}_{{z}_{0} } {φ}^{1} = {λ}_{z}^{1} {M}_{{z}_{0}} {φ}^{0} + {λ}_{z}^{0} {M}_{{z}_{1}} {φ}^{0} - {L}_{{z}_{1}} {φ}^{0} & ( 27 b ) \\ {ε}^{2} \text{:} {L}_{{z}_{0}} {φ}^{2} - {λ}_{z}^{0} {M}_{{z}_{0}} {φ}^{2} = {λ}_{z}^{2} {M}_{{z}_{0}} {φ}^{0} + {λ}_{z}^{1} M {z}_{1} {φ}^{0} + {λ}_{z}^{1} M {z}_{0} {φ}^{1} + {λ}_{z}^{0} M {z}_{2} {φ}^{0} + {λ}_{z}^{0} {M}_{{z}_{1}} {φ}^{1} - {L}_{{z}_{2}} {φ}^{0} - {L}_{{z}_{1}} {φ}^{1} & ( 27 c ) \\ {ε}^{3} \text{:} {L}_{{z}_{0}} {φ}^{3} - {λ}_{z}^{0} {M}_{{z}_{0}} {φ}^{3} = {λ}_{z}^{3} {M}_{{z}_{0}} {φ}^{0} + {λ}_{z}^{2} {M}_{{z}_{1}} {φ}^{0} + {λ}_{z}^{2} {M}_{{z}_{0}} {φ}^{1} + {λ}_{z}^{1} {M}_{{z}_{2}} {φ}^{0} + {λ}_{z}^{1} {M}_{{z}_{1}} {φ}^{1} + {λ}_{z}^{1} {M}_{{z}_{0}} {φ}^{2} + {λ}_{z}^{0} {M}_{{z}_{3}} {φ}^{0} + {λ}_{z}^{0} {M}_{{z}_{2}} {φ}^{1} + {λ}_{z}^{0} {M}_{{z}_{1}} {φ}^{2} - {L}_{{z}_{3}} {φ}^{0} - {L}_{{z}_{2}} {φ}^{1} - {L}_{{z}_{1}} {φ}^{2} & ( 27 d )\end{matrix}$$

For an Euler-Bernoulli beam, the symbols L_{z}_{ₒ}, M_{z}_{ₒ}, M_{z}_{₁}, L_{z}_{₁} and λ_{z}ⁱ represent the following:

$${L}_{zo} = \frac{{d}^{4}}{d {ζ}_{1}^{4}} {M}_{{z}_{o}} = 1 {L}_{{z}_{1}} = \frac{{d}^{2}}{d {ζ}_{1}^{2}} 3 {γ}_{z} ( {ζ}_{1} ) \frac{{d}^{2}}{d {ζ}_{1}^{2}} \\ {M}_{{z}_{1}} = {γ}_{z} ( {ζ}_{1} ) {λ}_{z}^{i} = \frac{m {λ}^{i} {L}^{4}}{{EI}_{3}} \qquad ( 28 )$$

and for Timoshenko beam theory, their values are:

$${L}_{{z}_{0}} = [ \begin{matrix}- \frac{{d}^{2}}{d {ζ}_{1}^{2}} & \frac{d}{d {ζ}_{1}} \\ - \frac{d}{d {ζ}_{1}} & - {σ}^{2} e \frac{{d}^{2}}{d {ζ}_{1}^{2}} + 1\end{matrix} ]$$

$${M}_{{z}_{0}} = [ \begin{matrix}{σ}^{2} e & 0 \\ 0 & {σ}^{4} e\end{matrix} ]$$

$${L}_{{z}_{1}} = [ \begin{matrix}- \frac{d {γ}_{z} ( {ζ}_{1} ) δ}{d {ζ}_{1}^{2}} & \frac{d {γ}_{z} ( {ζ}_{1} )}{d x} \\ - \frac{{γ}_{z} ( {ζ}_{1} ) d}{d {ζ}_{1}} & 3 {γ}_{z} ( {ζ}_{1} ) - \frac{d {σ}^{2} e {γ}_{z} ( {ζ}_{1} ) d}{d {ζ}_{1}^{2} }\end{matrix} ]$$

$${M}_{{z}_{1 }} = [ \begin{matrix}{σ}^{2} e {γ}_{z} ( {ζ}_{1} ) & 0 \\ 0 & 3 {σ}^{4} e {γ}_{z} ( {ζ}_{1} )\end{matrix} ]$$

$$e = \frac{E}{κ G}$$

$${σ}^{2} = \frac{I}{{AL}^{2}}$$

$${λ}_{z}^{i} = \frac{{ω}^{2} ρ {L}^{2}}{κ G}$$

The n^{th} term is compactly written as:

$${ε}^{n} \text{:} {L}_{{z}_{0}} {φ}^{n} - {λ}_{z}^{0} {M}_{{z}_{0}} {φ}^{n} = {λ}_{z}^{n} {M}_{{z}_{0}} {φ}^{0} + {\sum }_{j = 1}^{m i n ( n \vert \vert 4 )} ( {λ}_{z}^{0} {M}_{{z}_{j}} - L {z}_{j} ) {φ}^{n - j} + {\sum }_{i = 1}^{n - 1} {\sum }_{j = 0}^{m i n ( n - i \vert \vert 4 )} {λ}_{z}^{i} {M}_{{z}_{j}} {φ}^{n - i - j} . \qquad ( 30 )$$

To use orthogonality M_{zo} and L_{zo} terms should be written separately. The above Equation is rewritten as:

$${ε}^{n} \text{:} {L}_{{z}_{0}} {φ}^{n} - {λ}_{z}^{0} {M}_{{z}_{0}} {φ}^{n} = {λ}_{z}^{n} {M}_{{z}_{0}} {φ}^{0} + {\sum }_{j = 1}^{m i n ( n \vert \vert 4 )} ( {λ}_{z}^{0} {M}_{{z}_{j}} - {Lz}_{j} ) {φ}^{n - j} + {\sum }_{i = 1}^{n - 1} {λ}_{z}^{i} {M}_{{z}_{0}} {φ}^{n - i} + {\sum }_{i = 1}^{n - 1} {\sum }_{j = 1}^{m i n ( n - i \vert \vert 4 )} {λ}_{z}^{i} {M}_{{z}_{j}} {φ}^{n - i - j} . \qquad ( 31 )$$

Equation (27a) is the same as the eigenvalue problem for the undamaged elastic element, so the solution would be the same. Let the solution be given by S_{ud}(ζᵢ). For example, for an Euler-Bernoulli beam, the solution is given by:

S_{ud}(ζ₁)=A cos aζ₁B sin aζ₁+C sin haζ₁+D cos haζ₁ (32)

After applying the boundary conditions, the eigenvalue problem gives the mode shapes for the beam. Hence, the solution to the zeroth-order Equation is same as that for the undamaged beam given by:

λ_{z}⁰=λ_{z}_{ₖ}⁰φ⁰(ζᵢ)=φₖ⁰(ζᵢ),n=1,2,3, . . . ,∞ (33)

Next, the Equations of order higher than zero are solved. Since the solution of the zeroth-order gave an infinite number of modes, all the Equations higher than zeroth-order will have one Equation for each mode. The Equation for the k^{th} is given by:

$${ε}^{n} \text{:} {L}_{{z}_{0}} {φ}_{k}^{n} - {λ}_{{z}_{k}}^{0} {M}_{{z}_{k}} {φ}_{k}^{n} = {λ}_{{z}_{k}}^{n} {φ}_{k}^{0} + {\sum }_{j = 1}^{m i n ( n \vert \vert 4 )} ( {λ}_{{z}_{k}}^{0} {M}_{{z}_{j}} - {L}_{{z}_{j}} ) {φ}_{k}^{n - j} + {\sum }_{i = 1}^{n - 1} {λ}_{{z}_{k}}^{i} {M}_{{z}_{0}} {φ}_{k}^{n - i} + {\sum }_{i = 1}^{n - 1} {\sum }_{j = 1}^{m i n ( n - i \vert \vert 4 )} {λ}_{{z}_{k}}^{i} {M}_{{z}_{j}} {φ}_{k}^{n - i - j} \qquad ( 34 )$$

where k is the mode number considered. The unknowns in the above Equation are φₖⁿ and λ_{zk}. The total solution for the above Equation consists of a homogeneous part and a particular integral part (φₖⁿ=φₖⁿ|homogeneous+φₖⁿ|particular). Again, the above Equation, which is a representative Equation of higher order Equations, has the same left-hand side as Equation (27a), so the homogeneous part of the solution would be the same, i.e. S_{ud}(ζᵢ). To solve the particular integral part, the particular solution is represented as a summation of the undamaged orthogonal modes, or the zeroth-order solution modes, using the expansion theorem, viz.,

$${φ}_{k}^{n} {\vert}_{particular} = {\sum }_{p = 1}^{∞} {η}_{kp}^{n} {φ}_{p}^{0} . \qquad ( 35 )$$

where ηₖₚⁿ is a constant. Thus, the unknowns are now ηₖₚⁿ, p=1, 2, . . . ∞ and λ_{z}_{ₖ}ⁿ, and its solution for the first two orders is shown by Dixit and Hanagud (2011). The solution for the first-order equation is given by φₖ¹=φₖ⁰+Σ_{p=1p≠k}^{∞} ηₖₚ¹φₚ⁰ and solution for second-order equation is given by φₖ²=φₖ⁰+Σ_{p=1p≠k}^{∞} ηₖₚ²φₚ⁰. Using deductive reasoning, the solution for the r^{th}-order equation with r<n is φₖ^{r}=φₖ⁰+Σ_{p=kp≠k}^{∞} ηₖₚ^{r}φₚ⁰. Orthogonality of the undamaged modes is used to find the values of the unknowns. Equation (35) is premultiplied by (φₘ⁰(x))^{T} and integrated from ζᵢ=0 to ζᵢ=1 to yield

$${ε}^{n} \text{:} {\int }_{0}^{L} {( {φ}_{m}^{0} )}^{T} {L}_{{z}_{0}} {\sum }_{p = 1}^{∞} {η}_{kp}^{n} {φ}_{p}^{0} - {λ}_{{z}_{k}}^{0} {\int }_{0}^{L} {( {φ}_{m}^{0} )}^{T} {M}_{{z}_{0}} {\sum }_{p = 1}^{∞} {η}_{kp}^{n} {φ}_{p}^{0} = {λ}_{{z}_{k}}^{n} {\int }_{0}^{L} {( {φ}_{m}^{0} )}^{T} {M}_{{z}_{0}} {φ}_{k}^{0} + {\sum }_{j = 1}^{m i n ( n \vert \vert 4 )} {\int }_{0}^{L} {( {φ}_{m}^{0} )}^{T} ( {λ}_{{z}_{k}}^{0} {M}_{{z}_{j}} - {L}_{{z}_{j}} ) ( {φ}_{k}^{0} + {{\sum }_{p = 1 p \neq k}}^{∞} {η}_{kp}^{n - i} {φ}_{p}^{0} ) + {\sum }_{i = 1}^{n - 1} {λ}_{{z}_{k }}^{i} {\int }_{0}^{L} {( {φ}_{m}^{0} )}^{T} {M}_{{z}_{0}} ( {φ}_{k}^{0} + {\sum }_{p = 1 p \neq k}^{∞} {η}_{kp}^{n - i} {φ}_{p}^{0} ) + {\sum }_{i = 1}^{n - 1} {\sum }_{j = 1}^{m i n ( n - i \vert \vert 4 )} {λ}_{{z}_{k}}^{i} {\int }_{0}^{L} {( {φ}_{m}^{0} )}^{T} {M}_{{z}_{j}} ( {φ}_{k}^{0} + {{\sum }_{p = 1 p \neq k}}^{∞} {η}_{kp}^{n - i - j} {φ}_{p}^{0} ) \qquad ( 36 )$$

Using orthogonality, the following simplifications can be made:

∫₀^{L}(φₘ⁰)^{T}M_{z}_{₀}φₖ⁰=δₘₙCₘ=δₘₙCₙ

∫₀^{L}(φₘ⁰)^{T}L_{z}_{₀}φₖ⁰=δ_{mnλm}Cₘ=δₘₙλₙCₙ (37)

where δₘₙ is the Kronecker delta. Notice no orthogonality condition holds for j>1. Also, the following notations would be used to represent the Equation compactly:

∫₀^{L}(φₘ⁰)^{T}L_{z}_{ⱼ}φₖ⁰=αⱼ_{ₘₙ}

∫₀^{L}(φₘ⁰)^{T}M_{z}_{ⱼ}φₖ⁰=βⱼ_{ₘₙ} (38)

It can be shown at least for γ(ζᵢ)=Δlzδ(ζᵢ−ζ_{di})βⱼₘₙ=βⱼₙₘ and aⱼₘₙ=aⱼₙₘ. Using the orthogonality condition of Equation (37) and the compact notation of Equation (38), Equation (36) is now given by:

$${ε}^{n} \text{:} {η}_{k m}^{n} ( {λ}_{{z}_{m}}^{0} - {λ}_{{z}_{k}}^{0} ) {C}_{m} = {λ}_{{z}_{k}}^{n} {δ}_{mk} {C}_{k} + {\sum }_{j = 1}^{m i n ( n \vert \vert 4 )} ( {λ}_{{z}_{k}}^{0} {β}_{{j}_{mk}} {α}_{{j}_{mk}} + {\sum }_{p = 1 p \neq k}^{∞} {η}_{kp}^{n - j} ( {λ}_{{z}_{k}}^{0} {β}_{{j}_{m p}} - {α}_{{j}_{m p}} ) ) + {\sum }_{i = 1}^{n - 1} {λ}_{{z}_{k}}^{i} ( {δ}_{mk} {C}_{k} + {\sum }_{p = 1 p \neq k}^{∞} {η}_{kp}^{n - i} {δ}_{m p} {C}_{p} ) + {\sum }_{i = 1}^{n - 1} {\sum }_{j = 1}^{m i n ( n - i \vert \vert 4 )} {λ}_{{z}_{k}}^{i} ( {β}_{{j}_{mk}} + {\sum }_{p = 1 p \neq k}^{∞} {η}_{kp}^{n - i - j} {β}_{{j}_{m p}} ) \qquad ( 39 )$$

The unknowns of this Equation can be found by using the conditions m=k and m≠k. For m=k, the left-hand side vanishes, and the following expression is obtained for the λⁿₖ:

$${λ}_{{z}_{k}}^{n} = \frac{1}{{C}_{k}} ( \begin{matrix}{\sum }_{j = 1}^{m i n ( n \vert \vert 4 )} ( {α}_{{j}_{kk}} - {λ}_{{z}_{k}}^{0} {β}_{{j}_{kk}} + {{\sum }_{p = 1 p \neq k}}^{∞} {η}_{kp}^{n - j} ( {α}_{{j}_{kp}} - {λ}_{{z}_{k}}^{0} {β}_{{j}_{kp}} ) ) - \\ {\sum }_{i = 1}^{n - 1} {λ}_{{z}_{k}}^{i} {C}_{k} - {\sum }_{i = 1}^{n - 1} {\sum }_{j = 1}^{m i n ( n - i \vert \vert 4 )} {λ}_{{z}_{k}}^{i} ( {β}_{{j}_{kk}} - {\sum }_{p = 1 p \neq k}^{∞} {η}_{kp}^{n - i - j} {β}_{{j}_{kp}} )\end{matrix} ) \qquad ( 40 )$$

and for m≠k, the following expression is obtained for ηₖₘⁿ:

$${η}_{k m}^{n} = \frac{1}{( {λ}_{{z}_{m}}^{0} - {λ}_{{z}_{k}}^{0} ) {C}_{m}} ( \begin{matrix}{\sum }_{j = 1}^{m i n ( n \vert \vert 4 )} ( {λ}_{{z}_{k}}^{0} {β}_{{j}_{mk}} - {α}_{{j}_{mk}} + {\sum }_{p = 1 p \neq k}^{∞} {η}_{kp}^{n - j} ( {λ}_{{z}_{k}}^{0} {β}_{{j}_{m p}} - {α}_{{j}_{m p}} ) ) + \\ {\sum }_{i = 1}^{n - 1} {λ}_{{z}_{k}}^{i} ( {η}_{k m}^{n - i} {C}_{m} ) + {\sum }_{i = 1}^{n - 1} {\sum }_{j = 1}^{m i n ( n - i \vert \vert 4 )} {λ}_{{z}_{k}}^{i} ( {β}_{{j}_{mk}} + {\sum }_{p = 1 p \neq k}^{∞} {η}_{kp}^{n - i - j} {β}_{{j}_{m p}} )\end{matrix} ) \qquad ( 41 )$$

To complete the solution for mode shapes, the solution obtained until now is given by:

$${φ}_{k}^{n} = {S}_{ud} ( {ζ}_{i} ) + {\sum }_{p = 1 , p \neq k}^{∞} {η}_{kp}^{n} {φ}_{p}^{0} + {η}_{kk}^{n} {φ}_{k}^{0} \qquad ( 42 )$$

Notice ηⁿₖₖ is incorrectly deduced to be zero by Shi et al. (2000). Instead, this constant at this stage is still undetermined. There are as many unknowns in S_{ud} (ζᵢ) as there are boundary conditions as shown in the example expression given for an Euler-Bernoulli beam Equation (32). The ηⁿₖₖ just combines with those constants. The final solution after applying the boundary conditions is given by:

$${φ}_{k}^{n} = {φ}_{k}^{0} + {{\sum }_{p = 1 , p \neq k}}^{∞} {η}_{kp}^{n} {φ}_{p}^{0} \qquad ( 43 )$$

The solution has the mode shapes of the undamaged beam as one of the parts because of the unique choice of the particular solution. The particular solution independently already satisfied the boundary conditions. The final solution for the mode shape and natural frequencies of the damaged structure is determined by using Equation (25).

To determine the mode shapes and natural frequencies for an arbitrary damage profile, first the modes shapes and natural frequencies are determined using a sharp damage modeled using a delta function γ_{z} (ζᵢ)=δ(ζᵢ−ζ_{di}). Let the eigenfunction (mode shape) and the eigenvalue (which can be used to determine the natural frequency) be determined using such a damage profile being φ_{δk} (ζᵢ) and λ_{δk} respectively. A convolution integral in space domain is used to determine mode shapes and natural frequencies for any arbitrary damage profile. The final expression is given by:

φₖ(ζᵢ)=∫_{Ω}φ_{δ}_{ₖ}(ζᵢ−ζ_{d}_{ᵢ})γ(ζ_{d}_{ᵢ})dζ_{d}_{ᵢ}

λₖ=∫_{Ω}λ_{δ}_{ₖ}γ(ζ_{d}_{ᵢ})dζ_{d}_{ᵢ} (44)

where ζ_{d} is the spatial location of the damage. For multiple damage locations, the damage profile function for multiple damages given by Equation (18) is used:

$${φ}_{k} ( {ζ}_{i} ) = {\sum }_{j = 1}^{p} {\int }_{{Ω}_{j}} {φ}_{{δ}_{k}} ( {ζ}_{i} - {ζ}_{{d}_{i}} ) γ ( {ζ}_{{d}_{i}} ) d {ζ}_{{d}_{i}} \\ {λ}_{k} = {\sum }_{j = 1}^{p} {\int }_{{Ω}_{j}} {λ}_{{δ}_{k}} γ ( {ζ}_{{d}_{i}} ) d {ζ}_{{d}_{i}} \qquad ( 45 )$$

The subscript j denotes the damage number iterator and number, p denotes the total number of independent damage locations. Although, the natural frequency does not depend on the spatial variable ζᵢ, it still can be determined in the same way.

To verify the correctness of the expression, the first-order correction is compared against the ones derived for Euler-Bernoulli beams Dixit and Hanagud (2010b) and for Timoshenko beams Dixit and Hanagud (2009). They were found to be the same.

$${λ}_{{z}_{n}}^{1} = \frac{{α}_{nn} - {λ}_{{z}_{n}}^{0} {β}_{nn}}{{μ}_{nn}} \\ {η}_{nj}^{1} = \frac{{λ}_{{z}_{k}}^{0} {β}_{nj} - {α}_{nj}}{( {λ}_{{z}_{j}}^{0} - {λ}_{{z}_{n}}^{0} ) {μ}_{jj}} \qquad ( 46 )$$

The second-order correction quantities are obtained as the solution to Equation (27c):

$$\begin{matrix}{λ}_{{z}_{n}}^{2} = \frac{{α}_{{1}_{nn}} - {λ}_{{z}_{n}}^{1} {β}_{{1}_{nn}} - {λ}_{{z}_{n}}^{0} {β}_{{1}_{nn}}}{{C}_{n}} & ( 47 ) \\ {η}_{nj}^{2} = \frac{\begin{matrix}{λ}_{{z}_{n}}^{1} {β}_{{1}_{nj}} + {λ}_{{z}_{n}}^{1} {η}_{nj}^{1} {C}_{j} {λ}_{{z}_{n}}^{0} {β}_{{1}_{nj}} + \\ {λ}_{{z}_{n}}^{0} {\sum }_{l = 1 , l \neq n}^{∞} {η}_{nj}^{1} {β}_{{1}_{nj}} - {α}_{{1}_{nj}} - {{\sum }_{l = 1 , l \neq n}}^{∞} {η}_{nj}^{1} {α}_{{1}_{nj}}\end{matrix}}{{C}_{j} ( {λ}_{{z}_{j}}^{0} - {λ}_{{z}_{n}}^{0} )} & ( 48 )\end{matrix}$$

The present unified framework provides a general solution to damaged elastic structures. The damage can have any profile, and the elastic structure can have multiple damages. The elastic element can be supported on any set of orthogonal boundary conditions.

The present unified framework needs the theoretical undamaged modes. The primary advantage of the model lies in its apparent computational advantage over finite element models. The number of elements required to model a damaged element is very high, and is limited by the size of damage, at least in the vicinity of the damage.

So, in a beam of length 1 m and cross-sectional dimensions 0.02 m×0.005 m, if there is a through-thickness damage of depth 0.0005 m, the elements required to model this damaged beam would be two-dimensional plane stress elements with the smallest elements being of the order of 0.0005 m. This increases the computational requirement from using a few beam elements for the undamaged state to several plane stress elements for the damaged state. Using the present unified framework however, the modes of the undamaged beam can be used to model the damaged beam, which will be computationally much less expensive.

The present unified framework utilizes the mass defect, which has been neglected by conventional methods. The number of terms stemming from the mass defect is larger than the number of terms arising from the stiffness defect. Therefore, it can be concluded that the mass defect is an important parameter for modeling damage.

The present unified framework yields a series solutions that are asymptotically correct.

The unified framework is general, and while it is not possible to verify it fully in one application, different aspects of the theory have been verified for first-order perturbation correction in Euler-Bernoulli beams, and for first order correction, for Timoshenko beams.

The present unified framework presents a mathematical model for the damage. Such mathematical models allow for an understanding of the physics behind the problem, which helps in the explanation of experimental readings. They also allow a prediction of response of the structure. These studies are also useful for the development of new experimental techniques to address another important aspect of SHM, that of damage diagnosis. A method based on this framework for damage diagnosis (identification and localization) in Euler-Bernoulli beams, is disclosed herein. Similarly, methods based on the framework may be developed for damage diagnosis.

Thus, in a preferred embodiment of the unified framework, a process is used to model a structure with damage to obtain mode shapes and natural frequencies of the structure with damage, the process comprising providing the physical characteristics of the structure, providing the mode shapes and natural frequencies of the structure without damage, perturbing the mode shapes and natural frequencies of the structure without damage based on characteristics of the damage, calculating nth-order, perturbed differential equations governing the mode shapes and natural frequencies of the structure with damage, wherein n is 1 or greater, and solving the perturbed differential equations to obtain the mode shapes and natural frequencies of the structure with damage.

Solving the perturbed differential equations to obtain the mode shapes and natural frequencies of the structure with damage can include using a convolution integral in space domain over the domain of the damage.

The physical characteristics of the structure can include one or more of spatial, geometric and material characteristics of the structure and damage.

The structure can include more than one location of damage.

### Damage Localization Using Partial Response

As discussed, early vibration-based measures used to detect damages were-based on changes in natural frequencies. Natural frequencies are global parameters and give a global indication of change in the structural mass and stiffness distribution. An advantage of natural frequencies as a damage measure is that it is easy to obtain their values. A disadvantage is that being global parameters, they can just be used as indicative of damage. Also, since natural frequencies change due to environmental conditions like temperature, they cannot be considered as reliable indicators of damage.

The natural frequencies are functions of stiffness and mass. The change in mass due to damage can be of the same order of magnitude as that of the change of stiffness—yet change in mass is not considered by most researchers. Damage can result in changes of both the parameters, so a more severe damage may result in a lower change in natural frequencies than milder damage. Hence, even the severity of damage cannot be confidently adjudged using only changes in natural frequencies.

The change in natural frequency is dependent on the effective change in mass and stiffness. Effective change in mass or stiffness is dependent on the location of the damage, and modal energy associated with the damage. So, inherently, the inverse problem (problem of getting the damage parameters from the vibrational characteristics) has a non-unique set of solutions.

Another vibration-based measure used in damage detection is mode shapes. It alleviates some of the shortcomings of natural frequencies, since it can localize the damage, and also since the response due to damage is not erratic, with the change in the mode shapes being directly related to severity of the damage. However, the change in mode shapes is relatively very small, and sometimes can be of the same order as the noise during measurements, making it difficult to ascertain the change.

To remove the lack of sensitivity of mode shapes as damage indicators, researchers proposed curvature for damage detection. A mathematical explanation is that in the absence of any external moment acting at the damage location, the bending moment should be continuous across the damage. Bending stiffness is not continuous, since the depth of beam and hence the area moment of inertia, is not continuous. Therefore, the bending stiffness, which is a function of the area moment of inertia, is not continuous. This further implies curvature, which is the ratio of the bending moment and bending stiffness, is not continuous across the damage.

It was successfully shown that curvature mode shapes can be effectively used to determine and characterize damage. Several mathematical procedures were used to increase their sensitivity.

However, curvature is sometimes computed and as a secondary result, it is not measured directly. It is calculated using the numerical differentiation of mode shapes. So, no matter how well the mathematical differentiation is done, the sensitivity of the curvature as an effective damage measure depended on the accuracy of measurements of mode shapes, and its sensitivity to damage.

Strain energy is a product of discontinuous curvature with discontinuous bending stiffness. Researchers next exploited this double discontinuity of strain energy to devise methods to identify and characterize damage. It is known to provide a damage index as a function of strain energy. It is also known to provide a damage index without requiring the knowledge of the dynamic response of the undamaged structure.

A distributed parameter damage index, Modal Strain Energy Change Ratio (MSECR), based on the ratio of the change in strain energy of each element to the strain energy of undamaged state of that element is also known. The stiffness of the element was kept the same for the undamaged as well as damaged structure for strain energy computations of both states of the structure. The quality of this indicator is improved by summing the contributions of multiple modes in a normalized fashion as a cumulative damage index.

A different damage index can be based on strain energy ratios. For this, one divides the beam into a number of elements. A ratio of strain energy of each element with respect to all elements in the structure is formulated for the undamaged as well as the damaged structure. This has been implemented in investigation of two-dimensional structures.

In view of the above, and the shortcoming of the convention art, the present invention further comprises the alleviation of the lack of sensitivity of vibration-based techniques by presenting a new. physical quantity that gives accurate estimations of damage by making the damage detection parameter solely dependent on the damage.

This is achieved by first expressing the response of the damaged structure as a linear combination of the sum of the responses of the undamaged structure and the response due to damage alone. Subsequently, the part of the response due to the damage of the structure alone, herein termed the “damage signature”, is isolated to give information regarding the location of the damage.

The technique is applied to the free vibration modes (the terms “vibrational characteristics” and “vibration modes” are used herein, may signify, for example, the displacement mode, sectional rotation mode or any of the sectional strain modes (for example, bending and shear)) of the damaged structure.

As discussed above, if the free vibrations modes of the damaged structure are expanded, using the undamaged modes of the structure, as the basis functions as shown below:

$${μ}_{d}^{i} = {χμ}_{ud}^{i} + {\sum }_{j = 1 , j \neq i}^{∞} {ξ}_{ij} {μ}_{ud}^{j} = {R}_{1} ( x ) + {R}_{2} ( x ) χ < 1 , χ >> {η}_{ij} \qquad ( 49 )$$

(μ is the mode shape, the subscript ‘d’ denotes damaged and ‘ud’ denotes undamaged, χ and ξ are numerical factors), then the second part of the response (R₂(x)) gives the “damage signature”. Damage signature has a definitive spike at the damage location as it exists entirely due to the damage. In this case, the damage signature arises due to the partial mode contribution of the damaged structure, and hence the present method is termed herein the Partial Mode Contribution Method. This characteristic is used to identify the damage.

It is important to note that R2(x) is not the difference of undamaged and damaged mode shapes. (1−χ) μ_{ud}ⁱ−Σ_{j=1,j≠i}^{∞}ξᵢⱼμ_{ud}^{j} (1−χ)>>ξᵢⱼ. Since such a difference would be composed of a constituent of the main undamaged mode (1−χ)_{c}, which, is sometimes large enough to mute out any damage indication expressed by R₂(x), thereby explaining the lack of sensitivity of conventional vibration-based damage detection methods that were based on either directly the damaged mode shapes, or even the difference between normalized modes of damaged and undamaged structures.

As discussed above, the unified framework finds the modes and natural frequencies of damaged elastic structures like rods, beams, plates and shells. The derivation is valid for conservative distributed structures that represent a very large and important class of systems, namely self-adjoint systems. The method is reproduced once again for completeness, and also to demonstrate, that although the results are presented for beams using Euler-Bernoulli beam theory, they are also valid for other theories like Timoshenko beam theory, or for plate and shell structures. The general equation to determine the mode shapes and natural frequencies of elastic elements like rods, beams, plates and shells is given by:

Lφ(x)−λMφ(x)=0 (50)

where L is the stiffness operator, M is the inertia matrix and λ a non-dimensional parameter (eigenvalue). λ=χ² where ω is the natural frequency of the elastic structure and φ(x) is the eigenfunction or the mode shape. x is the space dimension, and denotes the one-dimensional space in case of beams, the two-dimensional space in case of plates and shells, and the three-dimensional space in case of three-dimensional structures. In the case of Euler-Bernoulli beam, their values are

$$L = \frac{{d}^{2}}{d {x}^{2}} {H}_{33} ( x ) \frac{{d}^{2}}{d {x}^{3}} \\ M = m ( x ) \\ φ ( x ) = w ( x ) \qquad ( 51 )$$

and in case of a Timoshenko beam their values are:

$$L = [ \begin{matrix}- \frac{d {K}_{22} ( x ) d}{d {x}^{2}} & \frac{d {K}_{22} ( x )}{d x} \\ - \frac{{K}_{22} ( x ) d}{d x} & {K}_{22} ( x ) - \frac{d {H}_{33} ( x ) d}{d {x}^{2}}\end{matrix} ] \\ M = [ \begin{matrix}m ( x ) & 0 \\ 0 & J ( x )\end{matrix} ] \\ φ ( x ) = \{ \begin{matrix}w ( x ) \\ ψ ( x )\end{matrix} \} \qquad ( 52 )$$

where H₃₃(x)=E(x)I(x), m(x)=ρ(x)A(x) and K₂₂(x)=κG(x)A(x). E(x), G(x), I(x), m(x) and J(x) are the Young's modulus, shear modulus, area moment of inertia, mass per unit length and mass moment of inertia per unit length, respectively, at a section ‘x’ of the beam, ρ(x) is the density and A(x) the area at the same section. w(x) is the transverse displacement and ψ(x) the rotation of the section. L is a partial differential operator if the structure is a plate or a shell. The order of L is an even integer, 2p.

The boundary conditions for Equation (50) are given by:

Bᵢφ(x)=0 i=1,2 . . . ,p (53)

where Bᵢ is a differential operator of maximum order of 2p−1. Examples of the clamped free boundary condition for Euler-Bernoulli and Timoshenko beam theories are given below:

$$\begin{matrix}{B}_{1} = \{ \begin{matrix}1 \\ \frac{d}{d x}\end{matrix} \} @ x = 0 \\ {B}_{2} = EI \{ \begin{matrix}\frac{{d}^{2}}{d {x}^{2}} \\ \frac{{d}^{3}}{d {x}^{3}}\end{matrix} \} @ x = {L}_{b} & ( 54 ) \\ {B}_{1} = [ \begin{matrix}1 & 0 \\ 0 & 1\end{matrix} ] @ x = 0 \\ {B}_{2} = [ \begin{matrix}κ GA \frac{d}{d x} & κ GA \\ 0 & EI \frac{d}{d x}\end{matrix} ] @ x = {L}_{b} & ( 55 )\end{matrix}$$

Similar matrices can be defined for other linear elastic structures too, and for other boundary conditions. Consider a uniform rectangular cross-section of width b and depth h as shown in FIG. 1. A damage is located at x=x_{d} with a width of Δl and depth of h_{d}. Therefore, at the damage location, the depth of the beam is reduced to h−h_{d}. For a notch-shaped damage, the crack profile can be approximated by using Heaviside functions H(x−x_{d})−H(x−x_{d}−Δl). Then, the sectional bending stiffness EI(x) and the sectional mass (mass per unit length) m(x) for the beam is given as:

$$\begin{matrix}\begin{matrix}I ( x ) = \frac{{bh ( x )}^{3}}{12} \\ = \frac{{b ( h - {h}_{d} ( x ) )}^{3}}{12} \\ = \frac{{bh}^{3}}{12} {( 1 - \frac{{h}_{d}}{h} ( H ( x - {x}_{d} ) - H ( x - {x}_{d} - Δ l ) ) )}^{3} \\ = {{I}_{0} ( 1 - \frac{{h}_{d}}{h} ( H ( x - {x}_{d} ) - H ( x - {x}_{d} - Δ l ) ) )}^{3} \\ = {{I}_{0} ( 1 - \frac{{h}_{d}}{h} ( γ ( x , {x}_{d} ) ) )}^{3}\end{matrix} & ( 56 ) \\ \begin{matrix}A ( x ) = {A}_{0} ( 1 - \frac{{h}_{d}}{h} ( H ( x - {x}_{d} ) - H ( x - {x}_{d} - Δ l ) ) ) \\ = {A}_{0} ( 1 - \frac{{h}_{d}}{h} ( γ ( x , {x}_{d} ) ) )\end{matrix} & \end{matrix}$$

Assuming Δl to be small, H(x−x_{d})−H(x−x_{d}−Δl)∝Δlδ(x−x_{d}) or H(x−x_{d})−H(x−x_{d}−Δl)=kΔlδ(x−x_{d}) for sharp cracks, where δ(x) is the dirac delta function and k is a proportionality constant. Expanding the above Equation binomially, and retaining only the term up until order one in Δl, the following expressions are obtained:

$$\begin{matrix}I ( x ) = {I}_{0} ( 1 - 3 ε k Δ l δ ( x - {x}_{d} ) ) = {I}_{0} ( 1 - 3 ε {γ}_{0} ( x , {x}_{d} ) ) & ( 57 a ) \\ A ( x ) = {A}_{0} ( 1 - ε {γ}_{0} ( x , {x}_{d} ) ) \\ ε = \frac{{h}_{d}}{h} & ( 57 b )\end{matrix}$$

In the above Equation, I₀ and A₀ are nominal quantities at an undamaged location. As the quantity ε is small, the function φ(x) and λ are expanded using perturbation theory as the following series:

φ(x)=φ(x)⁰+εφ(x)¹+ε²φ(x)²− . . . λ=λ⁰+ελ¹+ε²λ²− . . . (58)

The superscripts of φ and λ denote the order of perturbation. The next step is non-dimensionalization, the process of non-dimensionalization identifies the number of parameters affecting the results. The contents of the Equations are non-dimensionalized using:

$$ζ = \frac{x}{{L}_{b}} \\ {w}_{z} ( ζ ) = \frac{w ( ζ )}{{L}_{b}} \\ e = \frac{E}{κ G} \\ {σ}^{2} = \frac{I}{{AL}^{2}} \\ Δ {L}_{z} = \frac{Δ l}{{L}_{b}} \\ {δ}_{z} ( ζ - {ζ}_{d} ) = {L}_{b} δ ( x - {x}_{d} ) \\ α ( ζ ) = {L}_{b} {γ}_{0} ( x , {x}_{d} ) \qquad ( 59 )$$

The subscript ‘z’ is used for the non-dimensionalized quantity. In the above Equation, the identity for scaling the delta function is used, according to which

$$δ ( ay ) = \frac{δ ( y )}{\vert a \vert} .$$

Equations (57a), (57b), (58) and (59) are substituted into Equation (50) to give the Equations of order 0, 1 and 2 in ε as:

ε⁰:L_{z}_{₀}φ⁰−λ_{z}⁰M_{z}_{₀}φ⁰=0 (60a)

ε¹:L_{z}_{₀}φ¹−λ_{z}⁰M_{z}_{₀}φ¹=λ_{z}¹M_{z}_{₀}φ⁰+λ_{z}⁰M_{z}_{₁}φ⁰−L_{z}_{₁}φ⁰ (60b)

ε²:L_{z}_{₀}φ²−λ_{z}⁰M_{z}_{₀}φ²=λ_{z}²M_{z}_{₀}φ⁰+λ_{z}¹M_{z}_{₁}φ⁰+λ_{z}¹M_{z}_{₀}φ¹+λ_{z}⁰M_{z}_{₁}φ¹−L_{z}_{₁}φ¹ (60c)

In the above φⁱ=φ(ζ)ⁱ, which is the non-dimensionalized version of φ(x)ⁱ. The boundary conditions corresponding to Equations (61) and (62) are given by:

$$\begin{matrix}{B}_{{z}_{1}} = \{ \begin{matrix}1 \\ \frac{d}{d ζ}\end{matrix} \} @ ζ = 0 \\ {B}_{{z}_{2}} = \{ \begin{matrix}\frac{{d}^{2}}{d {ζ}^{2}} \\ \frac{{d}^{3}}{d {ζ}^{3 }}\end{matrix} \} @ ζ = 1 & ( 61 ) \\ {B}_{{z}_{1}} = [ \begin{matrix}1 & 0 \\ 0 & 1\end{matrix} ] @ ζ = 0 \\ {B}_{{z}_{2}} = [ \begin{matrix}\frac{d}{d ζ} & 1 \\ 0 & e {σ}^{2} \frac{d}{d ζ}\end{matrix} ] @ ζ = 1 & ( 62 )\end{matrix}$$

For example, in an Euler-Bernoulli beam Equation, the symbols L_{z}_{ₒ}, M_{z}_{ₒ}, M_{z}_{₁}, L_{z}_{₁} represent:

$${L}_{{z}_{0}} = \frac{{d}^{4}}{d {ζ}^{4}} \\ {M}_{{z}_{0}} = 1 \\ {L}_{{z}_{1}} = \frac{{d}^{2}}{d {ζ}^{2}} 3 α ( ζ ) \frac{{d}^{2}}{d {ζ}^{2}} \\ {M}_{{z}_{1}} = α ( ζ ) \\ {λ}_{z}^{i} = \frac{ρ A {λ}^{i} {L}_{b}^{4}}{{EI}_{0}} \qquad ( 63 )$$

and for Timoshenko beam theory, their values are:

$${L}_{{z}_{0}} = [ \begin{matrix}- \frac{{d}^{2}}{d {ζ}^{2}} & \frac{d}{d ζ} \\ - \frac{d}{d ζ} & - {σ}^{2} e \frac{{d}^{2}}{d {ζ}^{2}} + 1\end{matrix} ] \\ {M}_{{z}_{0}} = [ \begin{matrix}{σ}^{2} e & 0 \\ 0 & {σ}^{4} e\end{matrix} ] \\ {L}_{{z}_{1}} = [ \begin{matrix}- \frac{d α ( ζ ) d}{d {ζ}^{2}} & \frac{d α ( ζ )}{d ζ} \\ - \frac{α ( ζ ) d}{d ζ} & 3 α ( ζ ) - \frac{d {α}^{2} e α ( ζ ) d}{d {ζ}^{2}}\end{matrix} ] \\ {M}_{{z}_{1}} = [ \begin{matrix}{σ}^{2} e α ( ζ ) & 0 \\ 0 & 3 {σ}^{4} e α ( ζ )\end{matrix} ] \\ {λ}_{z}^{i} = \frac{{ω}^{2} ρ {L}^{2}}{κ G} . \qquad ( 64 )$$

It is noted regarding the perturbed differential Equations that the zeroth-order Equation is the same Equation as that for the undamaged case, so the solution is the same as that for the undamaged case. This is true for any elastic structure with any boundary condition similar to Equation (53). It is assumed that the solution for the undamaged case is known and is given by:

λ⁰=λₙ⁰n=1,2,3 . . . ,∞φ⁰(ζ)=φₙ⁰(ζ),n=1,2,3, . . . ,∞ (65)

In the solution for higher order Equations, it is noted that there is a right hand side, and hence the total solution consists of a solution to the homogeneous Equation, homogeneous part and a particular integral part (φₙ¹I=φₙ¹|_{homogeneous}+φₙ¹|_{particular}). Using expansion theorem, the particular solution is expanded in terms of the orthogonal modes of the undamaged beam. This implies that the particular solution satisfies the boundary conditions; therefore, the homogeneous solution should also independently satisfy the boundary conditions. Further, the homogeneous part of the higher order Equations is same as that of the zeroth-order Equation. Based on the above two facts, the solution of the homogeneous part of higher order Equations is same as the solution of the zeroth-order Equation, or the solution to the undamaged beam, therefore:

$${φ}_{n}^{1} {\vert}_{homogeneous} = {φ}_{n}^{0} \\ {φ}_{n}^{1} {\vert}_{particular} = {\sum }_{k = 1}^{∞} {η}_{nk} {φ}_{k}^{0} \qquad ( 66 )$$

Since the system was assumed to be self adjoint which implies orthogonality of the eigenmodes φ⁰, the following two Equations are obtained:

∫₀¹(φₘ⁰)L_{z}_{₀}(φₙ⁰)dζ=λ_{z}⁰∫₀¹(φₘ⁰)M_{z}_{₀}(φₙ⁰)dζ=δₘₙQₘₙ (67)

where δₘₙ is the Kronecker delta, and Qₘₙ is a constant.

From Equations (60b), (65) and (66), we obtain the following Equation (one for each mode of vibration for the beam):

$${L}_{{z}_{0}} {\sum }_{k = 1}^{∞} {η}_{nk} ( {φ}_{k}^{0} ) - {λ}_{z}^{0} {M}_{{z}_{0}} {\sum }_{k = 1}^{∞} {η}_{nk} ( {φ}_{k}^{0} ) = {λ}_{z}^{1} {M}_{{z}_{0}} {φ}_{n}^{0} + {λ}_{z}^{0} {M}_{{z}_{1}} {φ}_{n}^{0} - {L}_{{z}_{1}} {φ}_{n}^{0} \qquad ( 68 )$$

Multiplying Equation (68) by (φⱼ⁰)^{T} and integrating from ζ=0 to ζ=1, we get:

$${\int }_{0}^{1} {( {φ}_{j}^{0} )}^{T} {L}_{{z}_{0}} {\sum }_{k = 1}^{∞} {η}_{nk} ( {φ}_{k}^{0} ) d ζ - {λ}_{z}^{0} {\int }_{0}^{1} {( {φ}_{j}^{0} )}^{T} {M}_{{z}_{0}} {\sum }_{k = 1}^{∞} {η}_{nk} ( {φ}_{k}^{0} ) d ζ = {λ}_{z}^{1} {\int }_{0}^{1} {( {φ}_{j}^{0} )}^{T} {M}_{{z}_{0}} {φ}_{n}^{0} d ζ + {λ}_{z}^{0} {\int }_{0}^{1} {( {φ}_{j}^{0} )}^{T} {M}_{{z}_{1}} {φ}_{n}^{0} d ζ - {\int }_{0}^{1} {( {φ}_{j}^{0} )}^{T} {L}_{{z}_{1}} {φ}_{n}^{0} d ζ . \qquad ( 69 )$$

The integrals in Equation (69) are evaluated as follows:

∫₀¹(φⱼ⁰)^{T}M_{z}_{₀}φₙ⁰dζ=δₙⱼμₙⱼ (70a)

∫₀¹(φⱼ⁰)^{T}M_{z}_{₁}φₙ⁰dζ=(φⱼ⁰)^{T}|_{ζ=ζ}_{_{d}}M₁φₙ⁰|_{ζ=ζ}_{_{d}}=Eₘ_{ₙⱼ} (70b)

∫₀¹(φⱼ⁰)^{T}L_{z}_{₁}φₙ⁰dζ=(εⱼ⁰)^{T}|_{ζ=ζ}_{d}K₁εₙ⁰|_{ζ=ζ}_{_{d}}=Eₛ_{ₙⱼ} (70c)

where M₁ and K₁ are the mass and the stiffness operators associated with the first order correction respectively. Eₘ_{ₙⱼ} and Eₛ_{ₙⱼ} are the mass and stiffness defect associated with the damage. There are two primary things used to evaluate the above expressions for Eₘ and Eₛ. First

$${\int }_{a}^{b} f ( x ) δ ( x - {x}_{d} )$$

for a<x_{d}<b is f(x_{d}) and integrations by parts.

The objective of integration by parts is to remove any differentiation of the discontinuous function α(ζ). As an example, the calculation for Eₘ and Eₛ for Euler-Bernoulli beam Equations is shown:

$$\begin{matrix}{\int }_{0}^{1} {( {φ}_{j}^{0} )}^{T} α ( ζ ) {φ}_{n}^{0} d ζ = {( {φ}_{j}^{0} ( {ζ}_{d} ) )}^{T} Δ {L}_{z} k {φ}_{n}^{0} ( {ζ}_{d} ) \\ = {( {φ}_{j}^{0} ( {ζ}_{d} ) )}^{T} {M}_{1} {φ}_{n}^{0} ( {ζ}_{d} ) \\ = {E}_{{m}_{nj}} {\int }_{0}^{1} {( {φ}_{j}^{0} )}^{T} \frac{{d}^{2}}{d {ζ}^{2}} [ 3 α ( ζ ) {( {φ}_{n}^{0} )}^{″} ] d ζ \\ {= {( {φ}_{j}^{0} )}^{T} \frac{d}{d ζ} [ 3 α ( ζ ) {( {φ}_{n}^{0} )}^{″} ] \vert}_{0}^{1} - \\ { {( {φ}_{j}^{0} )}^{′ T} [ 3 α ( ζ ) {( {φ}_{n}^{0} )}^{″} ] \vert}_{0}^{1} + \\ {\int }_{0}^{1} {( {φ}_{j}^{0} )}^{″ T} [ 3 α ( ζ ) {( {φ}_{n}^{0} )}^{″} ] d ζ \\ {{= {( {ε}_{j}^{0} )}^{T} \vert}_{ζ = {ζ}_{d}} {K}_{1} {ε}_{n}^{0} \vert}_{ζ = {ζ}_{d}} \\ = {E}_{{s}_{nj}}\end{matrix} \qquad \begin{matrix}\begin{matrix}\begin{matrix}\begin{matrix}\begin{matrix}\begin{matrix}\begin{matrix}\begin{matrix}\begin{matrix}\begin{matrix}\begin{matrix}\begin{matrix}( 71 a ) \\ \end{matrix} \\ \end{matrix} \\ \end{matrix} \\ \end{matrix} \\ \end{matrix} \\ \end{matrix} \\ \end{matrix} \\ \end{matrix} \\ ( 71 b )\end{matrix} \\ \end{matrix} \\ \end{matrix} \\ \end{matrix}$$

The first two terms in Equation (71b) are zero because δ(ζ−ζd)=0 at both ζ=1, and ζ=0 and also the modal quantities associated with them are zero (force displacements duality). Similarly the Eₘ and Eₛ for the Timoshenko beam are given by:

$$\begin{matrix}\begin{matrix}{E}_{{s}_{nj}} = {\int }_{0}^{1} {( {φ}_{j}^{0} )}^{T} {L}_{{z}_{1}} {φ}_{n}^{0} d ζ \\ = {\int }_{0}^{1} {{w}_{{z}_{j}} ( α ( ζ ) ( {ψ}_{n} - {w}_{n}^{′} ) )}^{′} d ζ + {\int }_{0}^{1} {ψ}_{j} α ( ζ ) ( {ψ}_{n} - {w}_{n}^{′} ) d ζ - \\ {\int }_{0}^{1} {{ψ}_{j} ( α ( ζ ) {ψ}_{n}^{′} )}^{′} d ζ \\ = {w}_{{z}_{j}} ( α ( ζ ) ( {ψ}_{n} - {w}_{n}^{′} ) ) {\vert}_{0}^{1} - {\int }_{0}^{1} {w}_{{z}_{j}}^{′} α ( ζ ) ( {ψ}_{n} - {w}_{n}^{′} ) d ζ + \\ {\int }_{0}^{1} {ψ}_{j} α ( ζ ) ( {ψ}_{n} - {w}_{n}^{′} ) d ζ - {ψ}_{j} α ( ζ ) {ψ}_{n}^{′} {\vert}_{0}^{1} + {\int }_{0}^{1} {ψ}_{j}^{′} α ( ζ ) {ψ}_{n}^{′} d ζ \\ = {\int }_{0}^{1} {( {ε}_{j}^{0} )}^{T} [ \begin{matrix}- 1 δ ( ζ - {ζ}_{d} ) & 0 \\ 0 & - 3 {σ}^{2} e δ ( ζ - {ζ}_{d} )\end{matrix} ] {ε}_{s} \\ = {ε}_{s}^{T} {\vert}_{ζ = {ζ}_{d}} [ \begin{matrix}- 1 & 0 \\ 0 & - 3 {σ}^{2} e\end{matrix} ] ( {ε}_{n}^{0} ) {\vert}_{ζ = {ζ}_{d}} \\ = {( {ε}_{j}^{0} )}^{T} {\vert}_{ζ = {ζ}_{d}} {K}_{1} ( {ε}_{j}^{0} ) {\vert}_{ζ = {ζ}_{d}}\end{matrix} & ( 72 ) \\ \begin{matrix}{E}_{{m}_{nj}} = {\int }_{0}^{1} {( {φ}_{j}^{0} )}^{T} {M}_{{z }_{1}} {φ}_{n}^{0} d ζ \\ = {( {φ}_{j}^{0} )}^{T} {\vert}_{ζ = {ζ}_{d}} [ \begin{matrix}- {σ}^{2} e & 0 \\ 0 & - 3 {σ}^{4} e\end{matrix} ] {φ}_{n}^{0} {\vert}_{ζ = {ζ}_{d}} \\ = {( {φ}_{j}^{0} )}^{T} {\vert}_{ζ = {ζ}_{d}} {M}_{1} {φ}_{n}^{0} {\vert}_{ζ = {ζ}_{d}}\end{matrix} & \end{matrix}$$

The first integral on the L.H.S. of Equation (69) is simplified using orthogonality in Equation (67) as:

$$\begin{matrix}{\int }_{0}^{1} {( {φ}_{j}^{0} )}^{T} {L}_{{z }_{0}} {{\sum }_{k = 1}}^{∞} {η}_{nk} ( {φ}_{k}^{0} ) d ζ = {η}_{nj} {\int }_{0}^{1} {( {φ}_{j}^{0} )}^{T} {L}_{{z }_{0}} ( {φ}_{j}^{0} ) d ζ \\ = {λ}_{{z}_{j}}^{0} {η}_{nj} {\int }_{0}^{1} {( {φ}_{j}^{0} )}^{T} {M}_{{z }_{0}} ( {φ}_{j}^{0} ) d ζ\end{matrix} \qquad ( 73 )$$

Similarly, the second term of left hand side of Equation (69) is simplified using Equation (67). The left hand side of Equation (69) is transformed as:

ηₙⱼ(λ_{z}_{ⱼ}⁰−λ_{z}_{ₙ}⁰)∫₀¹(φⱼ⁰)^{T}M_{z}_{₀}(φⱼ⁰)dζ (74)

The expression

$${\int }_{0}^{1} {( {φ}_{p}^{0} )}^{T} {M}_{{z}_{0}} ( {φ}_{q}^{0} ) d ζ$$

in the above Equation is denoted by μ_{pg}. Equation (69) is now written as:

ηₙⱼμⱼⱼ(λ_{z}_{ⱼ}⁰−λ_{z}_{ₙ}⁰)=λ_{z}_{ₙ}¹μₙⱼδₙⱼ+λ_{z}_{ₙ}⁰Eₘ_{ₙⱼ}−Eₐ_{ₙⱼ} (75)

For j=n, the left hand side becomes zero and hence:

$$\begin{matrix}{λ}_{{z}_{n}}^{1} = \frac{{E}_{{s}_{nn}} - {λ}_{{z}_{n}}^{0} {E}_{{m}_{nn}}}{{μ}_{nn}} \\ For n \neq j \text{:} & ( 76 ) \\ {η}_{nj} = \frac{{λ}_{{z}_{n}}^{0} {E}_{{m}_{nj}} - {E}_{{s}_{nj}}}{{μ}_{jj} ( {λ}_{{z}_{j}}^{0} - {λ}_{{z}_{n}}^{0} )} & ( 77 ) \\ {φ}_{n}^{1} = {φ}_{n}^{0} + {\sum }_{j = 1 , j \neq n}^{∞} {η}_{nj} {φ}_{j}^{0} & ( 78 )\end{matrix}$$

The second order perturbation is required for calculation of strain energy. The same procedure is used to solve Equation (60c) i.e. multiplying the Equation by (φⱼ⁰)^{T} and integrating from 0 to 1. The simplified Equation is obtained as:

$${β}_{nj} {μ}_{jj} ( {λ}_{{z}_{j}}^{0} - {λ}_{{z}_{n}}^{0} ) = {λ}_{{z}_{n}}^{2} {μ}_{nj} {δ}_{nj} + {λ}_{{z}_{n}}^{1} {E}_{{m}_{nj}} + {λ}_{{z}_{n}}^{1} {μ}_{jj} {η}_{nj} ( 1 - {δ}_{nj} ) + {λ}_{{z}_{n}}^{0} {E}_{{m}_{nj}} + {λ}_{{z}_{n}}^{0} {\sum }_{l = 1 , l \neq n}^{∞} {η}_{nl} {E}_{{m}_{nl}} - {E}_{{s}_{nj}} - {\sum }_{l = 1 , l \neq n}^{∞} {η}_{nl} {E}_{{s}_{nl}} \qquad ( 79 )$$

The expression 1−δₙⱼ behaves opposite to Kronecker's delta: it is zero when n=k and is one when n≠k. The second order correction quantities are obtained as:

$$\begin{matrix}{λ}_{{z}_{n}}^{2} = \frac{{E}_{{s}_{nn}} - {λ}_{{z}_{n}}^{1} {E}_{{m}_{nn}} - {λ}_{{z}_{n}}^{0} {E}_{{m}_{nn}}}{{μ}_{nn}} & ( 80 ) \\ {β}_{nj} = \frac{\begin{matrix}{λ}_{{z}_{n}}^{1} {E}_{{m}_{nj}} + {λ}_{{z}_{n}}^{1} {η}_{nj} {μ}_{jj} {λ}_{{z}_{n}}^{0} {E}_{{m}_{nj}} + \\ {λ}_{{z}_{n}}^{0} {\sum }_{l = 1 , l \neq n}^{∞} {η}_{nl} {E}_{{m}_{nl}} - {E}_{{s}_{nj}} - {\sum }_{l = 1 , l \neq n}^{∞} {η}_{nl} {E}_{{s}_{nl}}\end{matrix}}{{μ}_{jj} ( {λ}_{{z}_{j}}^{0} - {λ}_{{z}_{n}}^{0} )} & ( 81 ) \\ {φ}_{n}^{2} = {φ}_{n}^{0} + {\sum }_{l = 1 , l \neq n}^{∞} {β}_{nl} {φ}_{l}^{0} & ( 82 )\end{matrix}$$

Finally, the natural frequency and mode shape correction to the perturbation of order 2 for a damaged beam is given by:

$$\begin{matrix}{φ}_{n} = {φ}_{n}^{0} + ε [ {φ}_{n}^{0} + {\sum }_{j = 1 , j \neq n}^{∞} {η}_{nj} {φ}_{j}^{0} ] + {ε}^{2} [ {φ}_{n}^{0} + {\sum }_{l = 1 , l \neq n}^{∞} {β}_{nl} {φ}_{l}^{0} ] & ( 83 a ) \\ {λ}_{{z}_{n}} = {λ}_{{z}_{n}}^{0} + {ελ}_{{z}_{n}}^{1} + {ε}^{2} {λ}_{{z}_{n}}^{2} & ( 83 b )\end{matrix}$$

It should be noted that Equation (83a) and Equation (49) are of the same form. Comparing Equations (83a) and (49) we get μ_{d}ⁱ=φₙ or μ_{d}ⁱ=φ′ₙ the values obtained for χ and ξ are:

χ=1+ε+ε²ξᵢⱼ=εηₙⱼ+ε²βₙⱼ (84)

Hence, the theoretical assertion of the introduction is verified by the analytical derivation presented.

Experimental validation has been done for damaged mode shapes and natural frequencies of an Euler-Bernoulli beam. The same experimental setup and readings are used herein to verify the existence of the “damage signature” as the partial mode contribution, and its ability to identify the damage. It is also verified that the partial mode contribution is more sensitive to damage identification than the displacement or curvature mode shapes for the damaged beam, or the difference between normalized displacement or curvature mode shapes of the damaged and the undamaged beams. Finally, the effect of noise on detection of damage is studied.

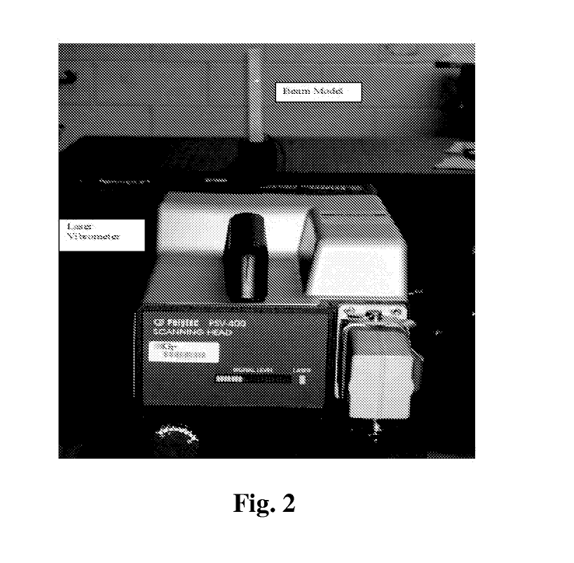

The experimental process is reproduced here for completeness. The experimental setup is illustrated in FIG. 2. Polytec™ Scanning Doppler Laser Vibrometer (SDLV8) was used to generate an input voltage. The signal generated (4V) by the SDLV was amplified 100 times by an amplifier. A broadband white noise was used as the input excitation. A piezoelectric actuator was fixed towards the clamped end of the beam at about 0.15 the length of the beam, to provide the input excitation. Frequencies up to 2 KHz were excited. Low pass signal filtering was used. A grid consisting of 105 points was used for an undamaged beam. For the damaged beam, 505 points were used to take the readings. More points were used for the damaged case to be able to see any minute changes in mode shapes and curvature shapes at the damage location.

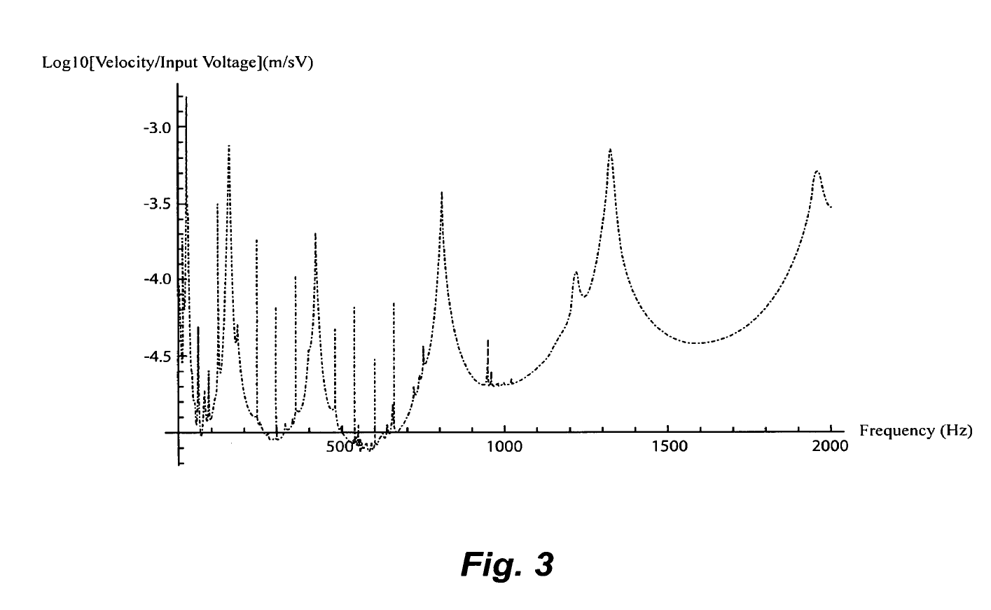

The resonance frequencies, where the Frequency Response Function (FRF) is given in FIG. 3, reached the peak amplitudes, and were retained as modal frequencies. The other sharp peaks, other than the peaks for natural frequencies, were the harmonics of the power signal, since they occur at multiples of 60 Hertz. Ten readings were taken with the remeasure option being switched on. Data acquisition was done using Polytec™ data acquisition software. The obtained modal data, in universal file format, was processed using in-house developed software. The average was taken for the points across the beam to simulate the beam neutral axis. Curve fitting was done to get a continuous curve for the Operating Deflected Shape (OSD). OSD was assumed to be equivalent to the mode shape for this experiment.

A fiberglass beam with clamped free boundary conditions was used for the experiment. Modes were calculated experimentally for both damaged and undamaged beam. A rectangular notch-shaped damage was made at 0.35 the length of the beam (ζd=0.35 L). The damage was 0.1 the depth (ε=0.1), and the notch length was 0.05 the length of the beam (Δl=0.05 L). The Young's modulus for the beam was 30 GPa, the density of the beam 3749 kg/m³, the length 0.267 m, the moment of inertia 1.28×10⁻¹⁰m⁴, and area 10⁻⁴m². The first four modes are used to detect the damage for this beam.

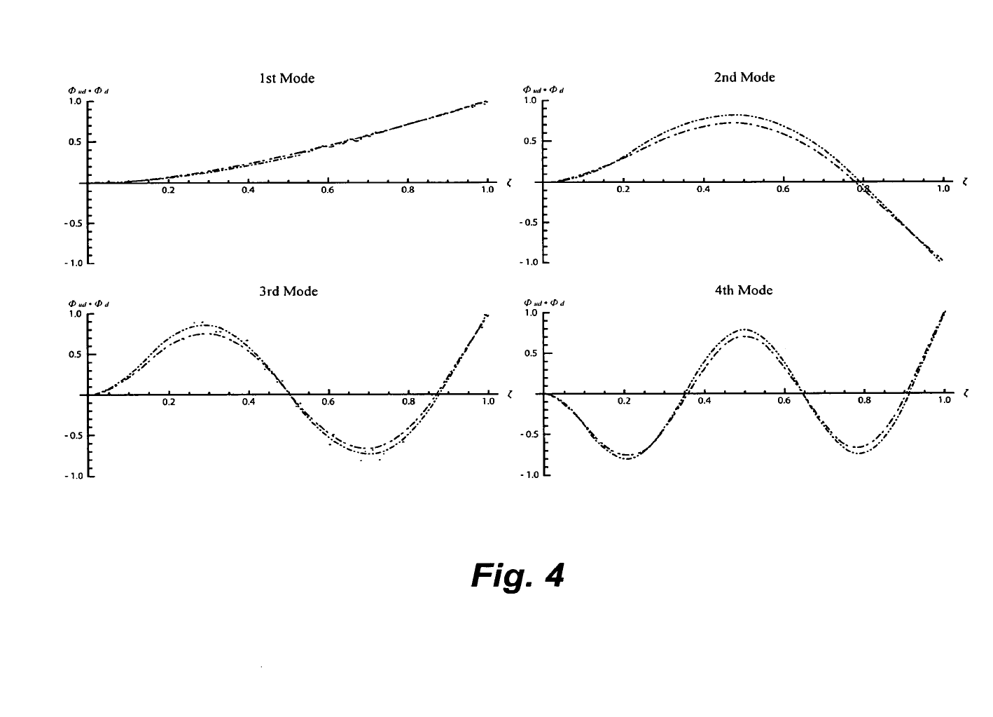

It should be noted that noise in the measurement ambience is different for different modes. As can be seen from the experimental data plots of mode shapes in FIG. 4, the modes shapes in order of increasing noise are 4^{th}, 2^{nd}, 1^{st} and 3^{rd}. As found by others, the first mode is found to contain much ambient noise. The third mode natural frequency coincides with one of the harmonics of the power supply (420 Hz), and hence again has a high amount of ambient noise. The modes are not neglected since the actual measurements in the field may have data with high ambient noise.

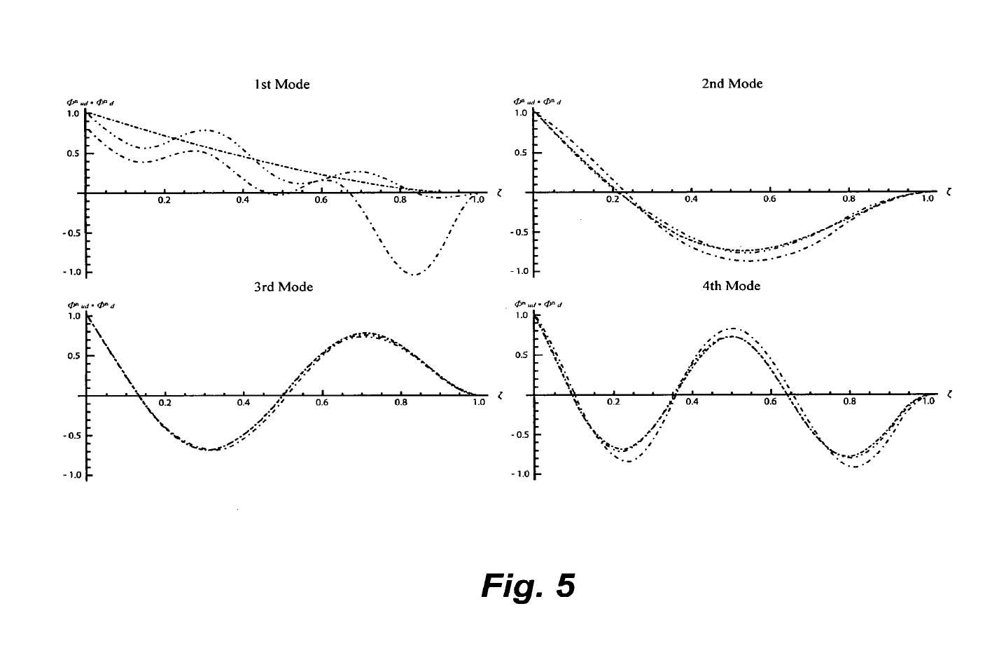

In FIG. 4, the experimental data for mode shapes of the damaged beam, experimental data curve fitted using the undamaged modes, and analytical displacement modes for the damaged and undamaged beams are shown for mode numbers 1 to 4. Similarly in FIG. 5, the experimental curvature shape for the undamaged beam, experimental curvature for damaged beam, and analytically derived curvature for damaged and undamaged beam, is shown. All the mode shapes and curvature shapes are normalized such that the maximum value is one. It is seen that for both the displacement mode shapes given in FIG. 4, and curvature mode shapes given in FIG. 5, the profiles for the modes shapes for the damaged and the undamaged beams are similar and damage cannot be ascertained by looking at the mode shapes.

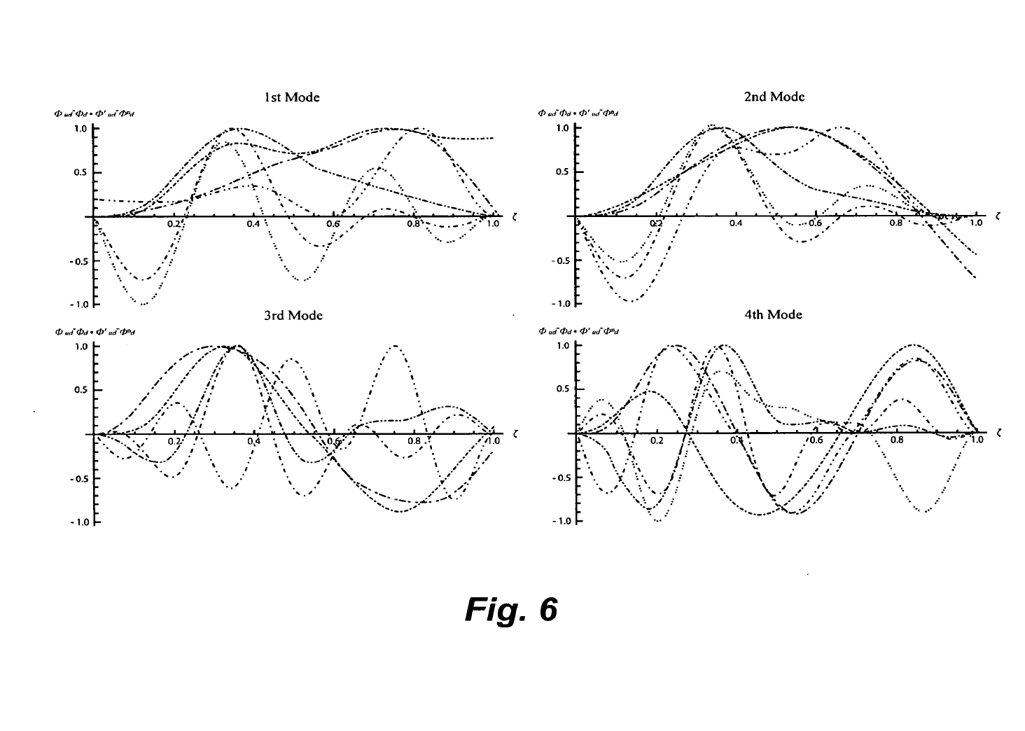

Next, the damage is ascertained using the difference between the normalized displacement and curvature mode shapes for the damaged and undamaged cases in FIG. 6. Six cases are considered, the difference between normalized modes for the case of: experimental displacement of the damaged beam and analytical displacement of the undamaged beam; experimental displacement of the damaged beam and experimental displacement of the undamaged beams; analytical displacement of the damaged beam and analytical displacement of the undamaged beam; experimental curvature of the damaged beam and analytical curvature of the undamaged beam; experimental curvature of the damaged beam and experimental curvature of the undamaged beam; and, analytical curvature of the damaged beam and analytical curvature of the undamaged beam. The resulting curves are normalized such that the maximum value is one. The peaks are used to determine the position of damage.

First, it is seen that the difference between the displacement and curvature mode for the damaged and undamaged beams, for the analytical case, gives the damage location correctly. Among the other curves, the difference between experimentally observed curvature of the damaged beam and analytically obtained curvature of the undamaged beam, is able to predict the damage location correctly for the first three mode shapes.

The difference between experimentally observed displacement modes and curvature modes of the damaged and undamaged cases is not able to give correct location of damage. The difference between experimental displacement mode and analytical displacement mode is able to give the location of damage only for the third mode shape.

Based on the above observations, it is concluded that although the difference between the analytical mode shapes gives the location of damage, this observation is not corroborated experimentally. The reason is that the change in mode shapes due to small defects is extremely small, even a slight amount of numerical errors or experimental noise can compensate for this change, and hence give incorrect damage information. It can also be concluded that from among the cases considered to identify damage using experiments, the best results are from the difference between the experimental curvature for the damaged beam and the analytical curvature for the undamaged beam.

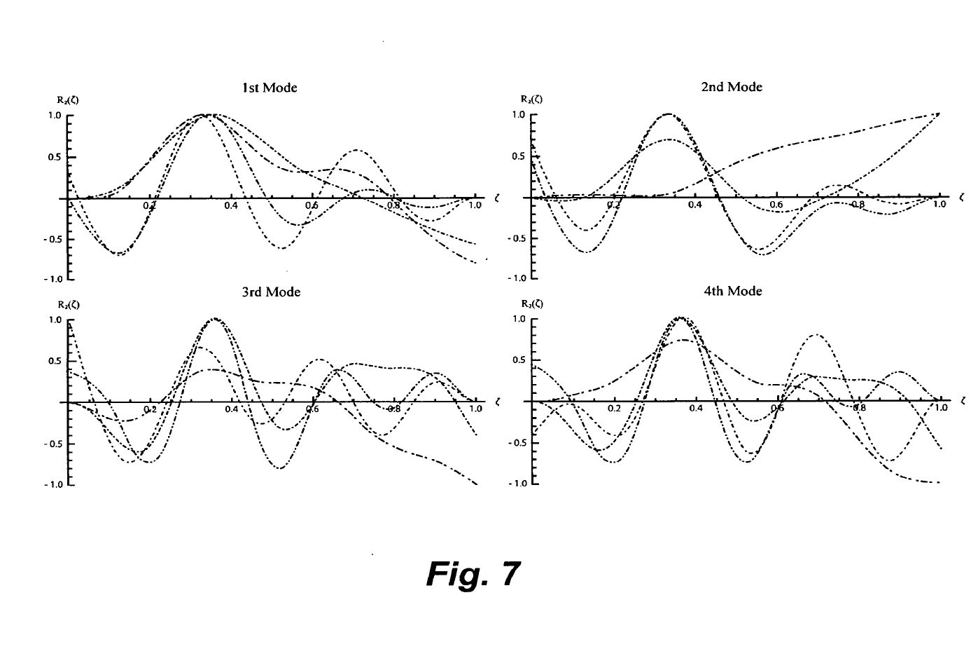

Next, the partial mode contribution is shown in FIG. 7. Four cases are considered: the partial mode contribution for displacement and curvature modes of damaged beams for the experimental data and those for analytical plots. The partial mode contribution for the analytical displacement and curvature mode shapes of damaged beams give a sharp peak at the damage location. Similarly, the partial mode contribution for the experimental data gives sharp peaks at the damage location for all the curvature shapes.

For the case of displacement mode shapes, modes one, three and four correctly identify the damages. It can therefore be concluded that the partial mode contribution can be effectively used to detect the position of damage, especially those for the curvature mode shapes of damaged beams. It can also be concluded that noise in the case of mode shapes one and three did not have an effect on determining the damage position. This was because the mode shapes do not have a magnitude, in the case of random and unbiased noise—for every deviation on one side, there would be a corresponding compensating deviation on the other side such that the mode shape integrity was maintained. In case of random biased noise, the mode shape would be shifted uniformly up or down, again maintaining the integrity of the shape. However, in the case of damage, there is local deviation, which is neither compensated nor globally uniform, and hence a parameter that can detect this local change in mode shape would be able to identify the damage—as in the case of the presently disclosed partial mode contribution parameter.

To illustrate the validity of the method for different boundary conditions, and to adjudge the relative sensitivity of the displacement mode shapes versus curvature mode shapes, beams with three different boundary conditions were modeled in ABAQUS™ using two-dimensional plane stress elements. The beams were modeled using ABAQUS™ software. The length of the beam was lm and the cross-sectional dimensions were 0.02 m and 0.0201 m respectively, the density was 7890 kg/m³, Young's modulus E=210 GPa and Poisson's ratio v=0.3. The slight change in the cross-sectional dimensions was necessary because otherwise, the modes obtained were coupled for the two bending directions.

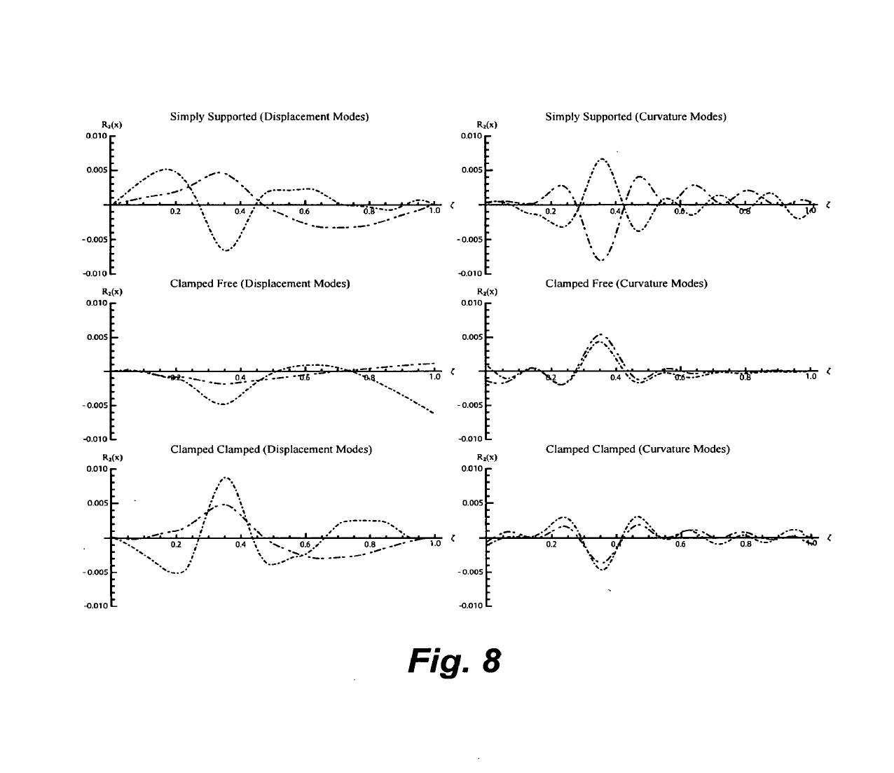

The curves for the damaged beam displacement and curvature mode shapes were normalized such that the maximum value is one. The curves were subsequently curve fitted using modes of the undamaged beam for the same boundary condition. The effect of the main mode (the mode that contributed the most to the curve fitted data) was zeroed out. The plots for the contribution of the rest of the undamaged modes, to the curve fitted damaged mode, is given in FIG. 8. Since the modes shapes have been normalized, the sensitivity of the different modes can be determined. It is seen that curvature shapes are more sensitive by an order of magnitude compared to displacement mode shapes, but they also have a higher number of oscillations. The same sensitivity is shown for mode shapes one and two when comparing displacement mode shapes with displacement mode shapes and curvature mode shapes with curvature mode shapes for different boundary conditions.

The range of valid values for different damage parameters like location of damage ζd, depth of damage ε and width of damage ΔL_{z} is explored. The modes used are derived using the previously disclosed unified framework. Beams with four different boundary conditions are considered: simply supported, clamped free, clamped clamped and propped cantilever. For all the plots, the damage parameters are ζd=0.35 L, ε=0.1, ΔL_{z}=0.01.

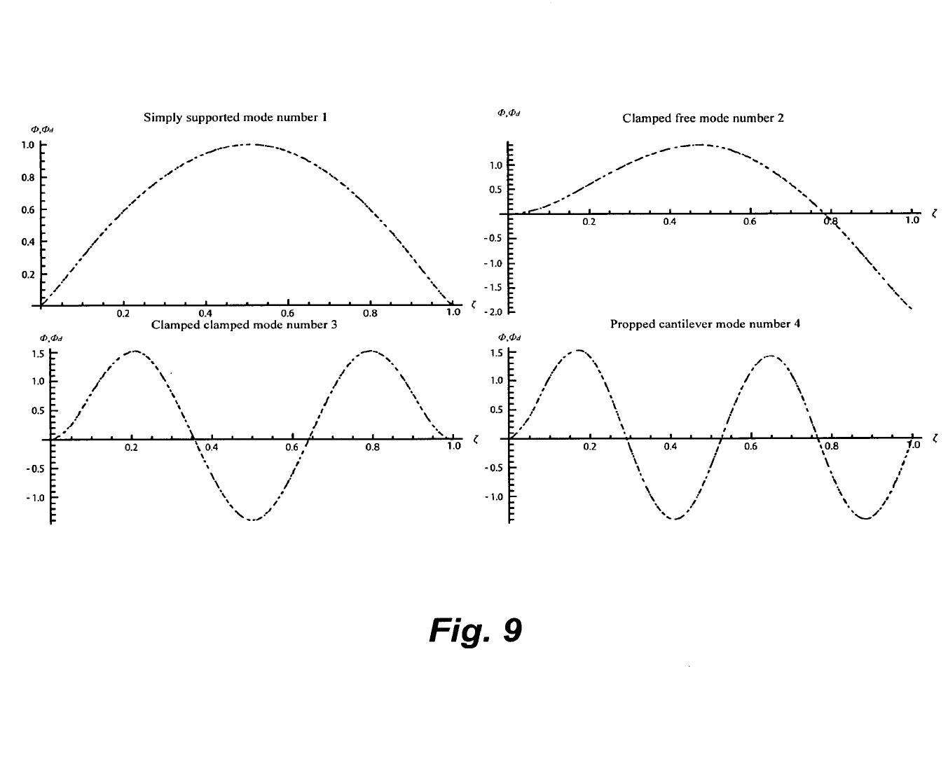

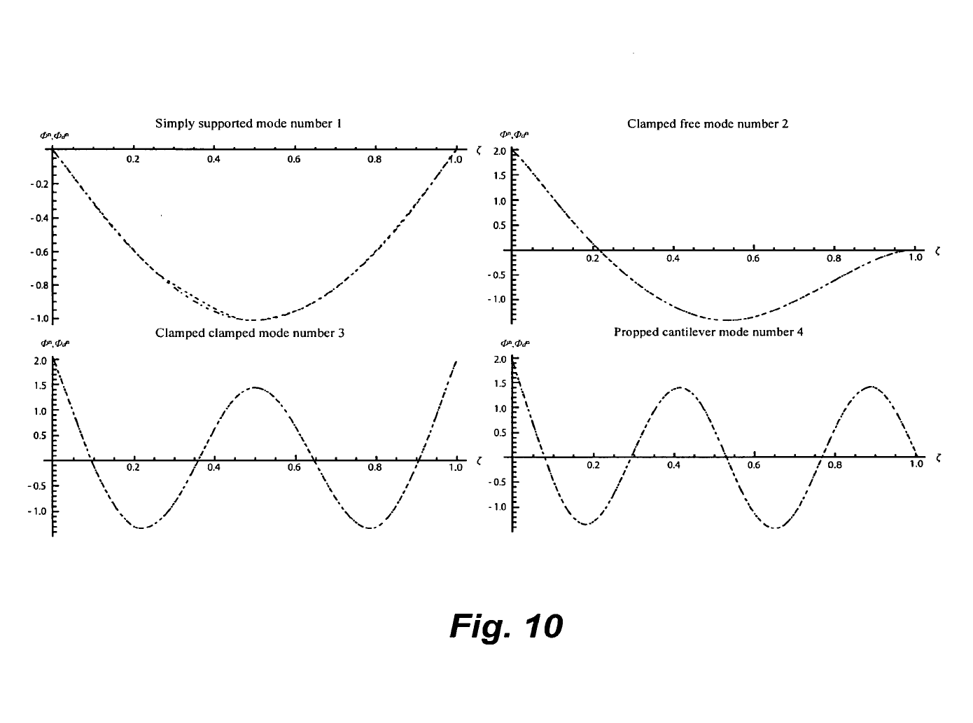

First, in FIG. 9, the normalized modes of the damaged beam using the analytical expressions obtained in the derivation above in Equation (83a), correct up until the first order, are given alongside the normalized modes of the undamaged beams. The first set of modes is given for the simply supported boundary condition, a second set for the clamped free boundary condition, a third set for the clamped clamped boundary condition, and a fourth set for the propped cantilever boundary condition. Similarly in FIG. 10, the normalized curvature shapes are given (same modes and same beams) alongside normalized curvature shapes for the damaged and undamaged beams. Since Euler-Bernoulli beam theory is considered for these plots, the plots are the same for any material or geometric characteristics of the beam. That is not the case if Timoshenko beam theory is used. It is seen that mode profiles of the damaged and undamaged beams are similar, and the damage cannot be identified just by looking at the mode profiles. Only the first curvature mode of the damaged case for the simply supported boundary condition shows a deviation from curvature mode shape of the undamaged case, at the damage location.

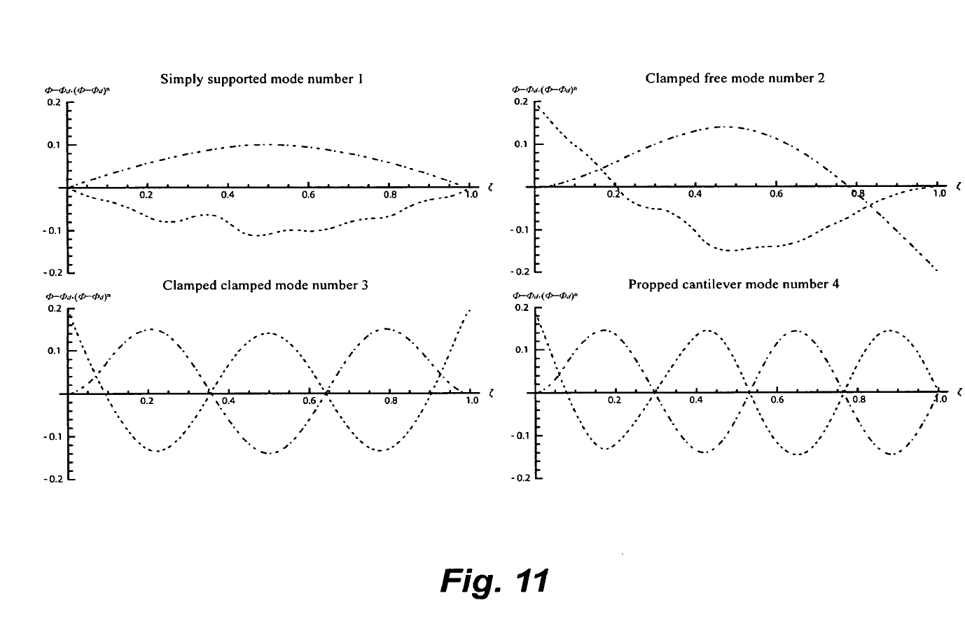

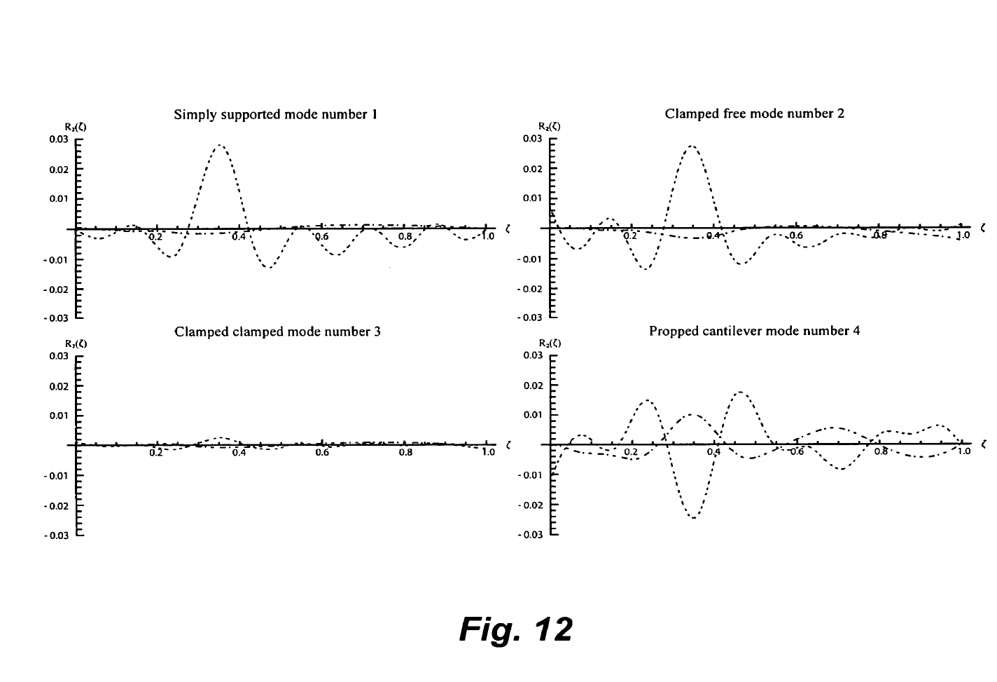

Next, in FIG. 11 the difference of normalized mode and curvature shape for the damaged and undamaged case is given. The damage location can be identified only for mode number one for the simply supported boundary condition, and mode number two for the clamped free boundary condition. Damage cannot be identified for mode three and mode four for the clamped clamped and propped cantilever cases, respectively. FIG. 12 gives the plot of R₂(x) as defined in Equation (49) for the mode shape and curvature shape. For example, for the 2^{nd} damaged mode, it gives the contribution of all the undamaged modes other than the contribution of the 2^{nd} undamaged mode to the 2^{nd} damaged mode. Mode shapes up through the 12^{th} mode are considered. Damage is identified for all the mode shapes and for all the different boundary conditions. The spike at the damage location is muted in case of displacement modes, but pronounced in case of curvatures. It is seen that different modes (curvature and displacement) for different beams are excited to varying amounts at the damage location, but all modes show clear indications of damage.

To study the phenomenon further, parametric studies are performed on different damage parameters. Since an Euler-Bernoulli beam is considered, the only parameters affecting the mode shapes are the three damage parameters, the location of damage ζd, the depth of damage ε and the extent of damage ΔL_{z}. The first set of plots are given for the location of damage at ζd=0.5 and ζd=0.7. ζd=0.35 has already been considered in the plots given in FIGS. 9-12. The rest of the parameters remain the same as earlier i.e. ε=0.1 and ΔL_{z}=0.01.

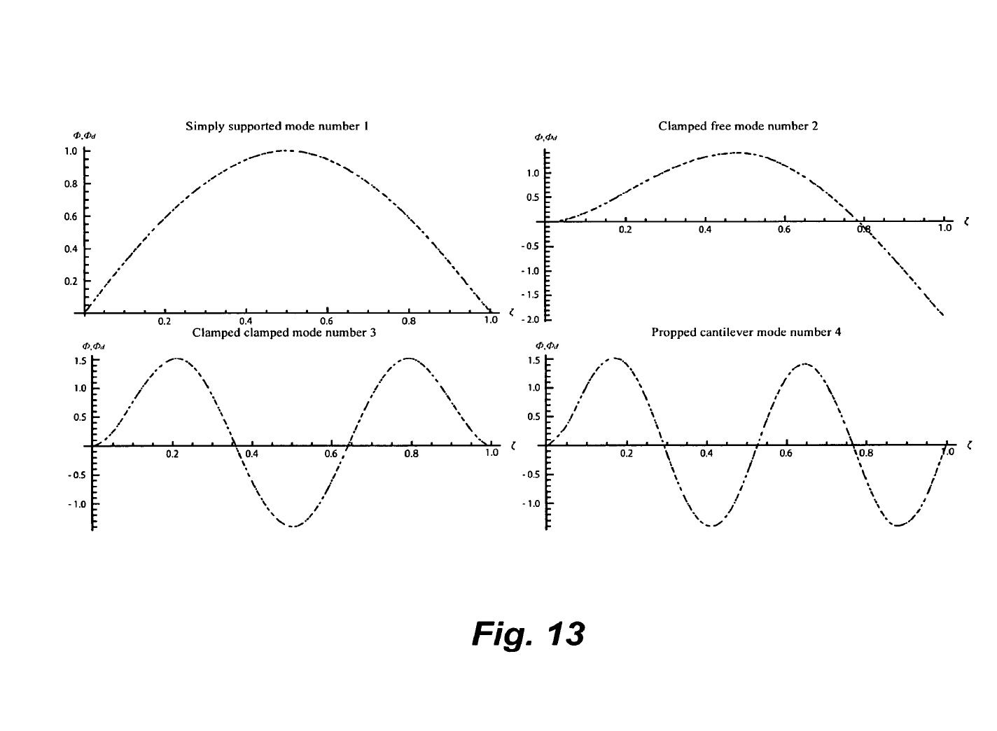

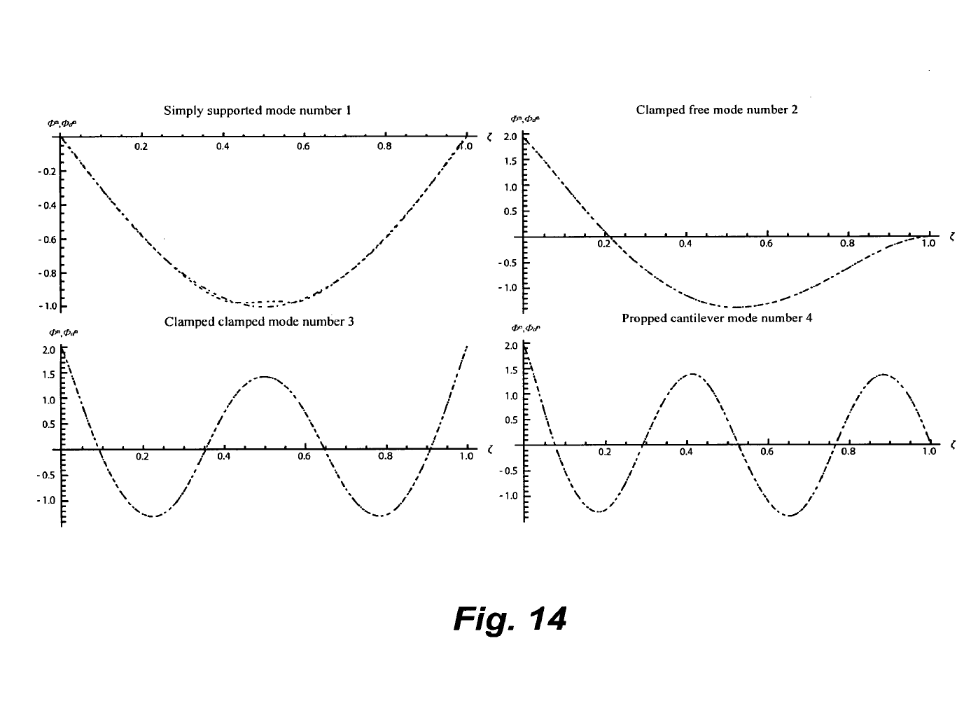

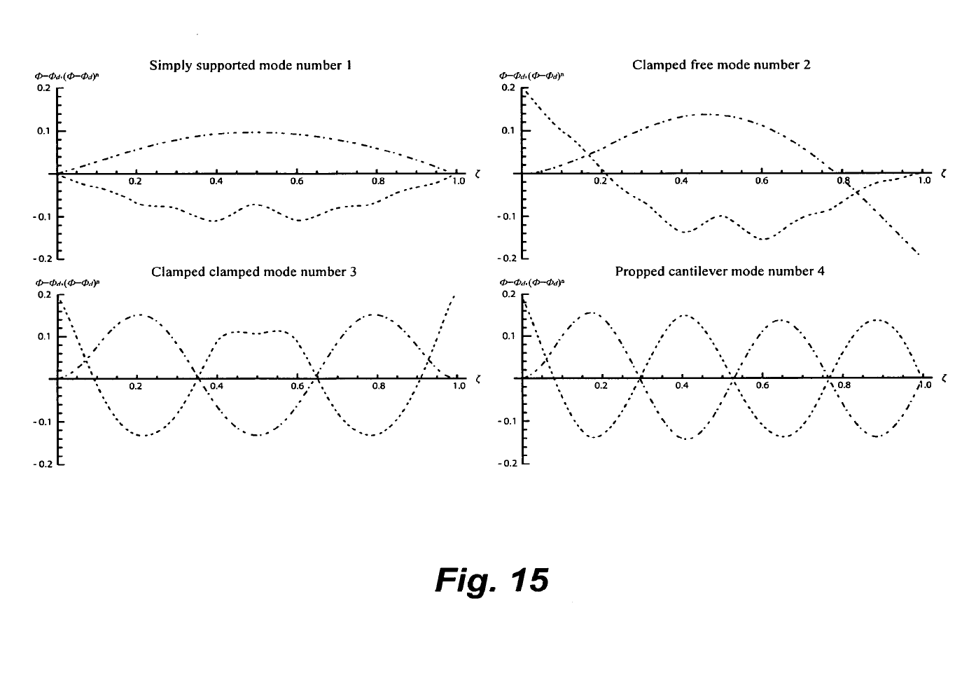

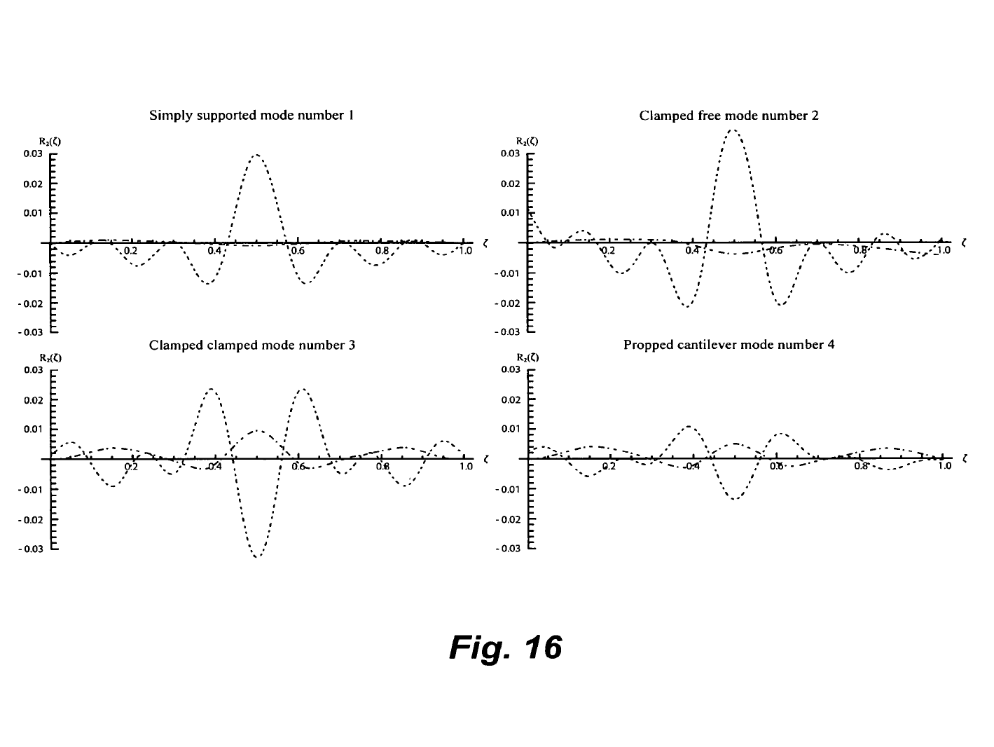

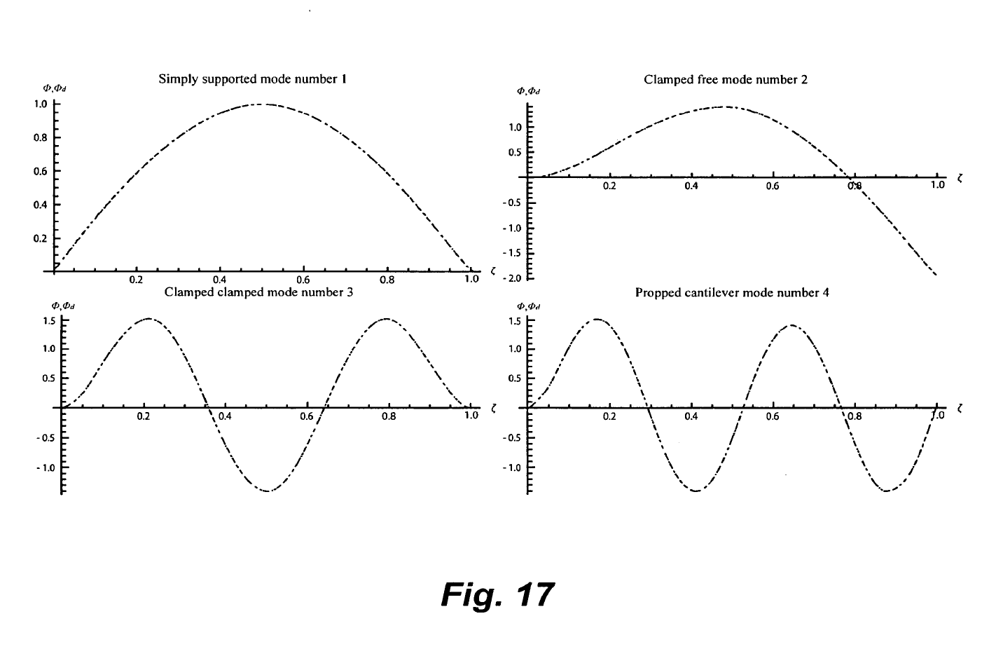

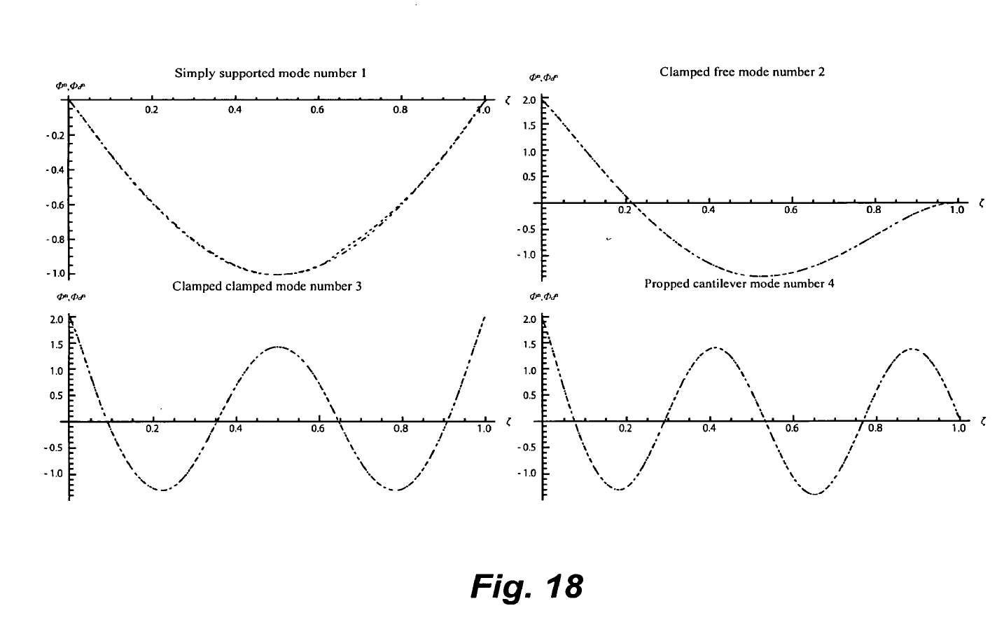

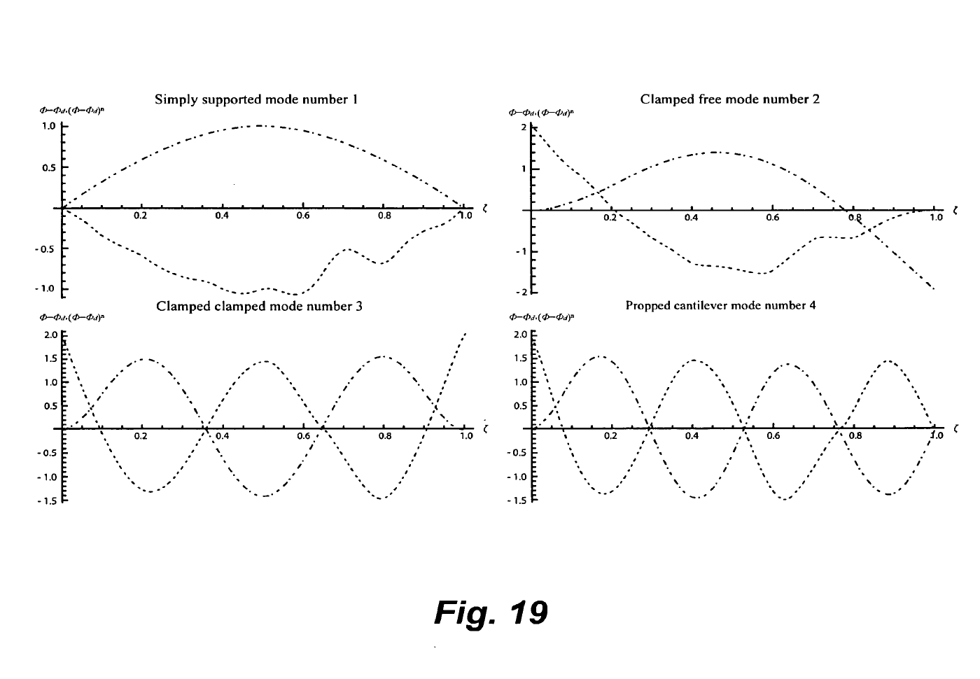

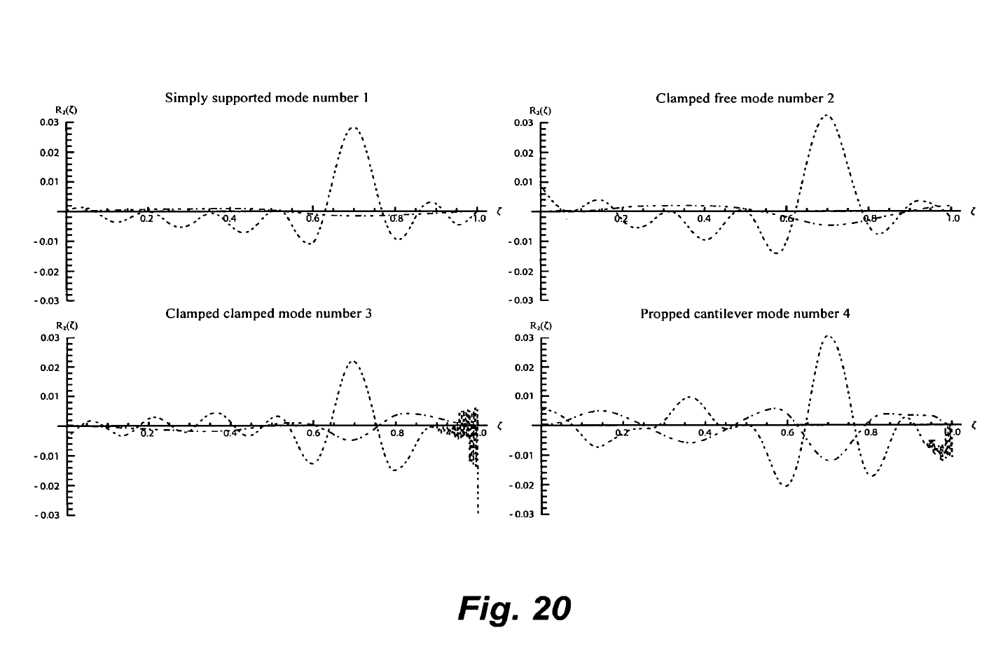

The mode shapes for the first case are given in FIG. 13, curvature shapes in FIG. 14, difference of normalized modes in FIG. 15, and the partial mode contribution (R₂(x)) in FIG. 16. Similarly for the second case ζd=0.7, the plots are given in FIG. 17 for mode shapes, FIG. 18 for curvature shapes, FIG. 19 for the difference between normalized modes, and FIG. 20 for the partial mode contribution.

The observations from these figures are similar as from the first set of FIGS. 9, 10, 11 and 12, i.e. that none of the three quantities: mode shapes, curvature shapes, or the difference between normalized modes and curvature shapes, are able to identify the damages for the four kinds of beams considered. Only the “damage signature”, in the form of the partial mode contribution, is able to identify the damage in all twelve cases considered.

The next damage parameter considered is the ratio of the depth of damage to the total depth of the beam, given by ε. Two cases are considered ε=0.01 and ε=0.4 along with the one already considered, that of ε=0.1. The plots for the mode shapes are similar to those in FIG. 9, so they are not given again. The curvature shapes for the case ε=0.01 are again similar to that for FIG. 10, however, when the damage depth increases to ε=0.4, there is a more marked damage location in the curvature mode shape for the simply supported, mode one and clamped free, mode two.

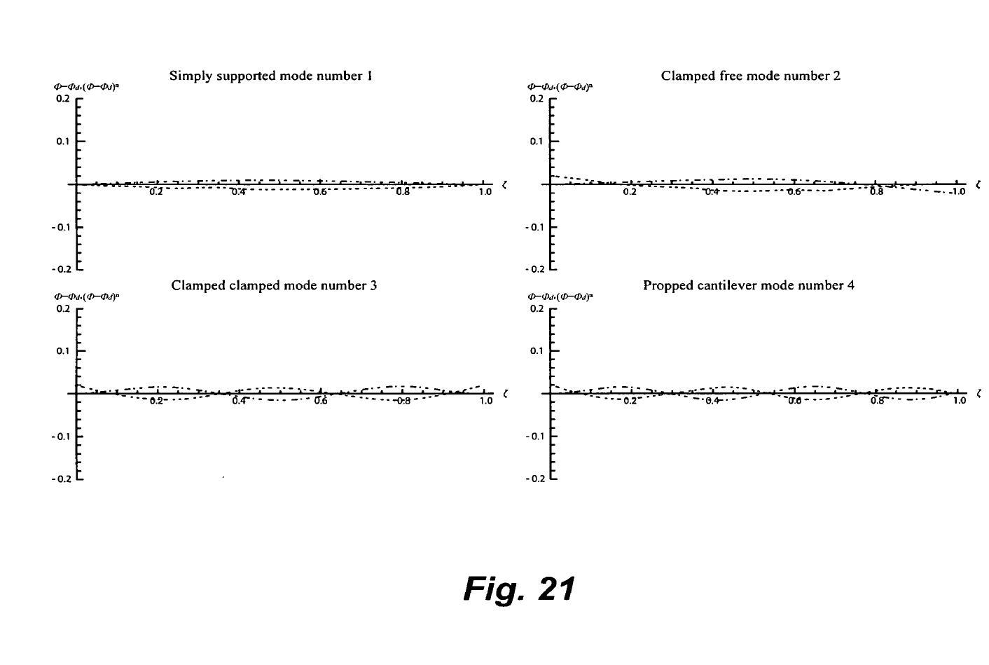

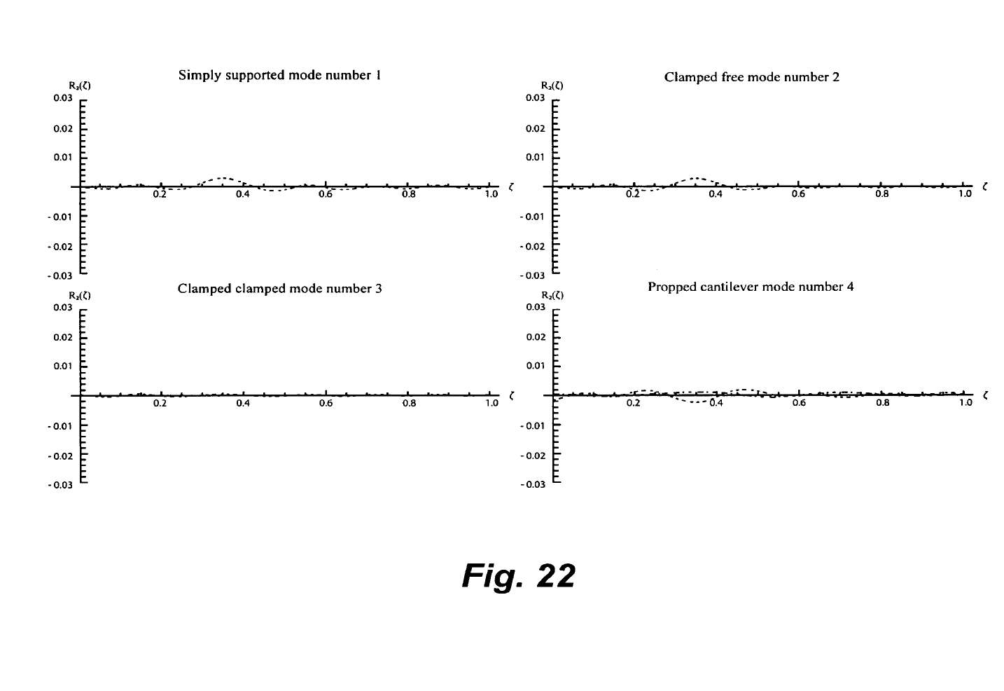

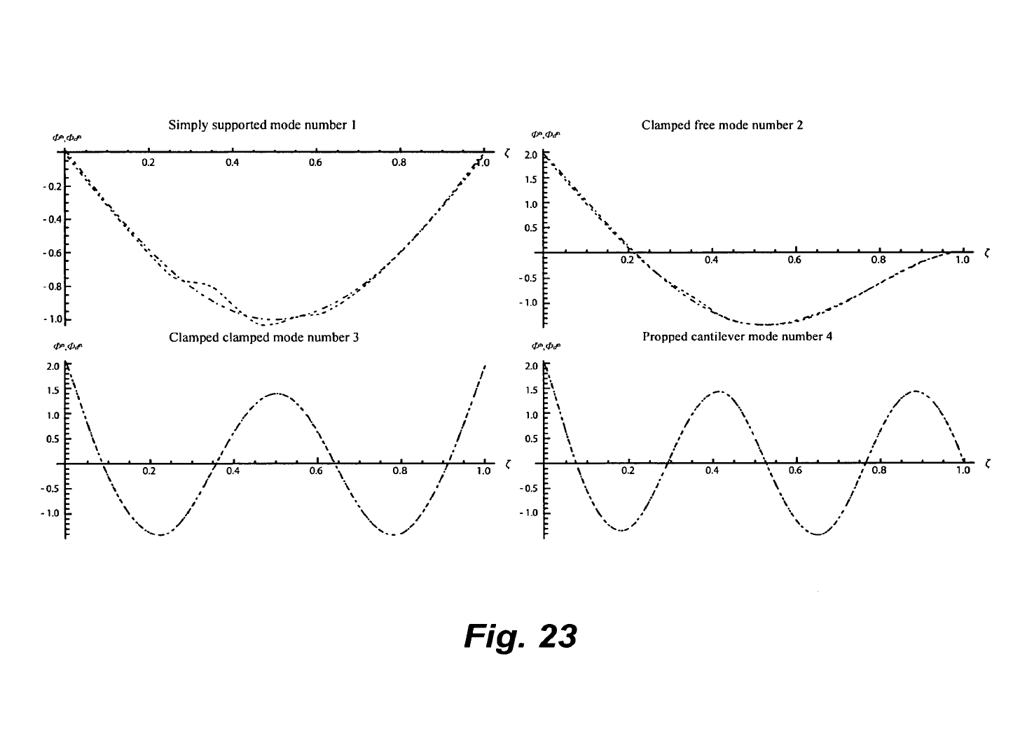

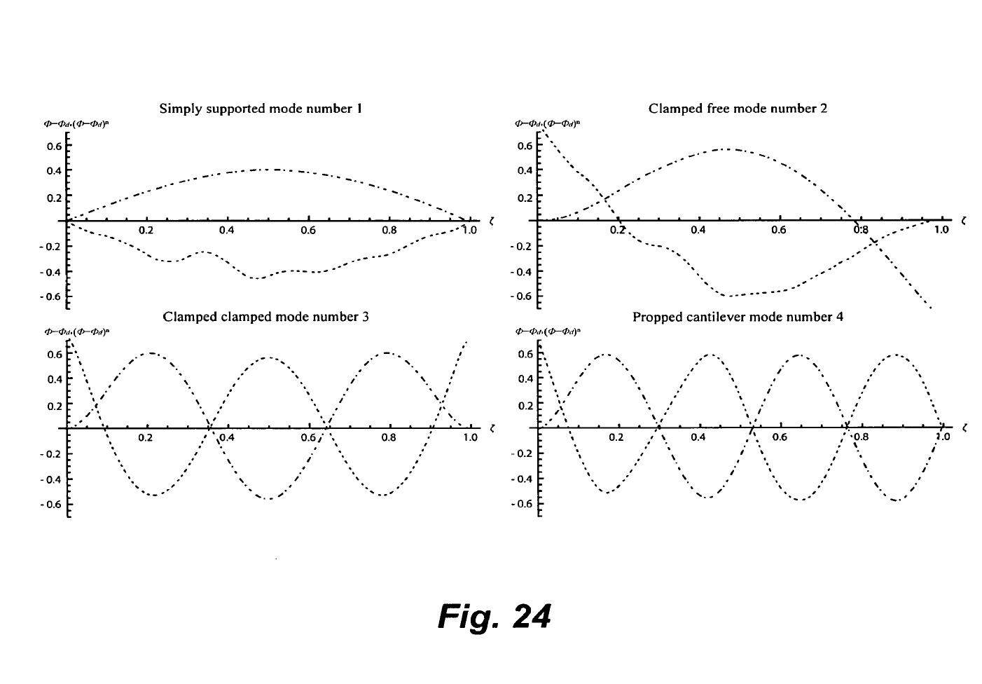

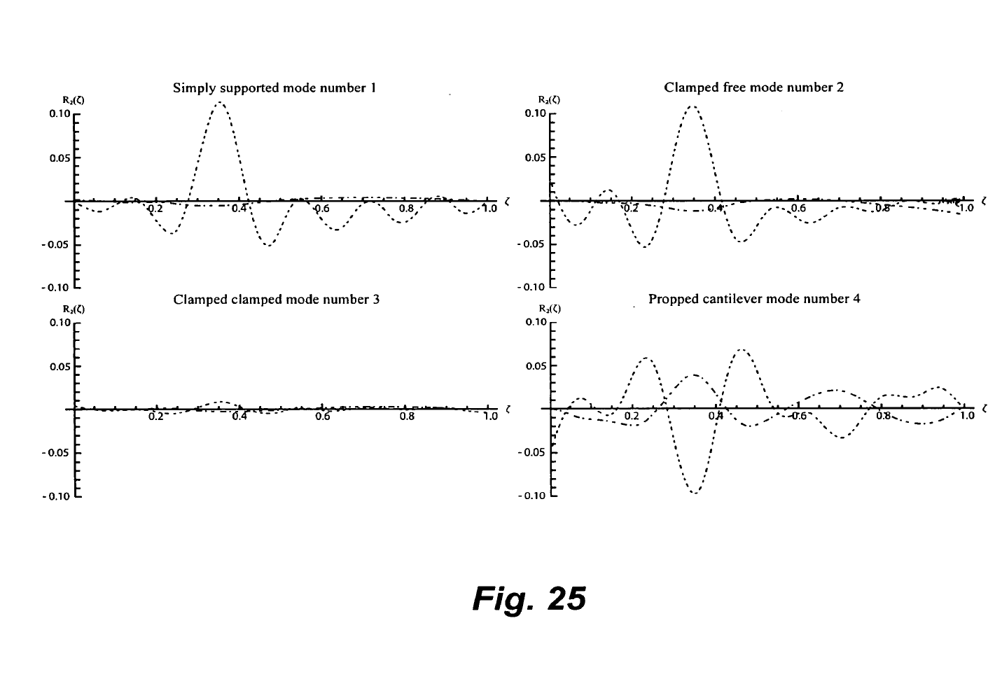

The damage is still not identifiable using the curvature shapes for the clamped clamped case and the propped cantilever case. The plots for curvature shapes for ε=0.4 is given in FIG. 23. The modal difference for the normalized modes is given in FIGS. 21 and 24 for the cases ε=0.01 and ε=0.4. In the former, the damage location is less demarked for the simply supported and clamped free boundary condition cases, however, it is still distinguishable. The damage location is again not identified for both the clamped clamped and the propped cantilever cases for both the ε values considered. The damage signature plots are presented in FIGS. 22 and 25. The damage location is again clearly identified for all the cases.

The change in the scale for both the modal difference and for damage signature for the case of ε=0.4 plots should be noted. It changes from 0.2 to 0.7 for the modal difference plots since the modal difference increases between the modes of the damaged and the undamaged beam; however, there was no corresponding positive effect on the damage identification. It changed from 0.03 to 0.1 for the “damage signature” plots. There was a positive effect on damage identification in these cases, since the peaks became of higher magnitude.

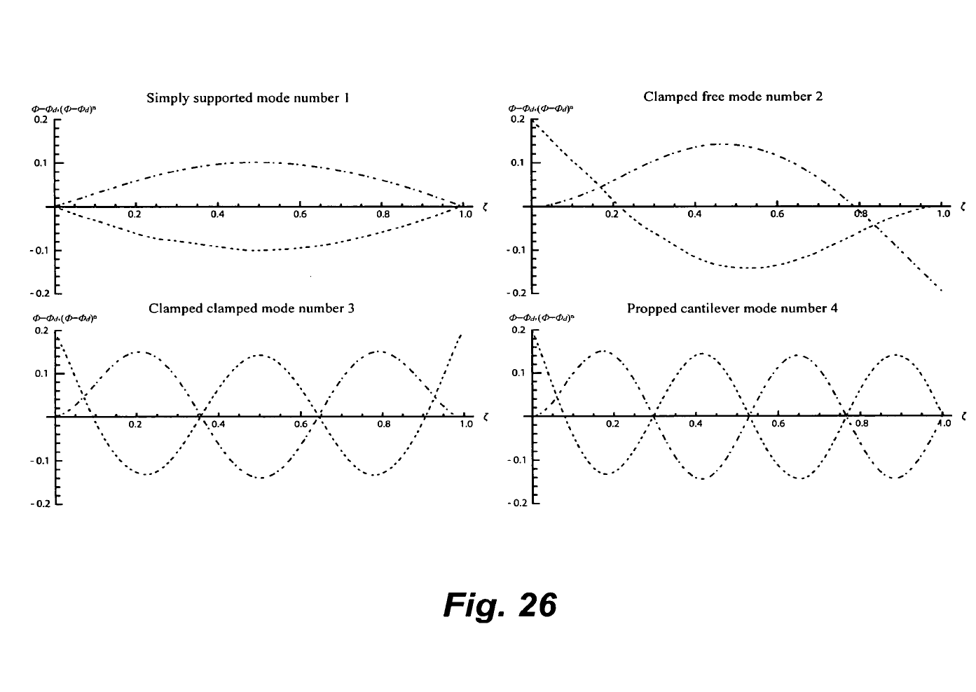

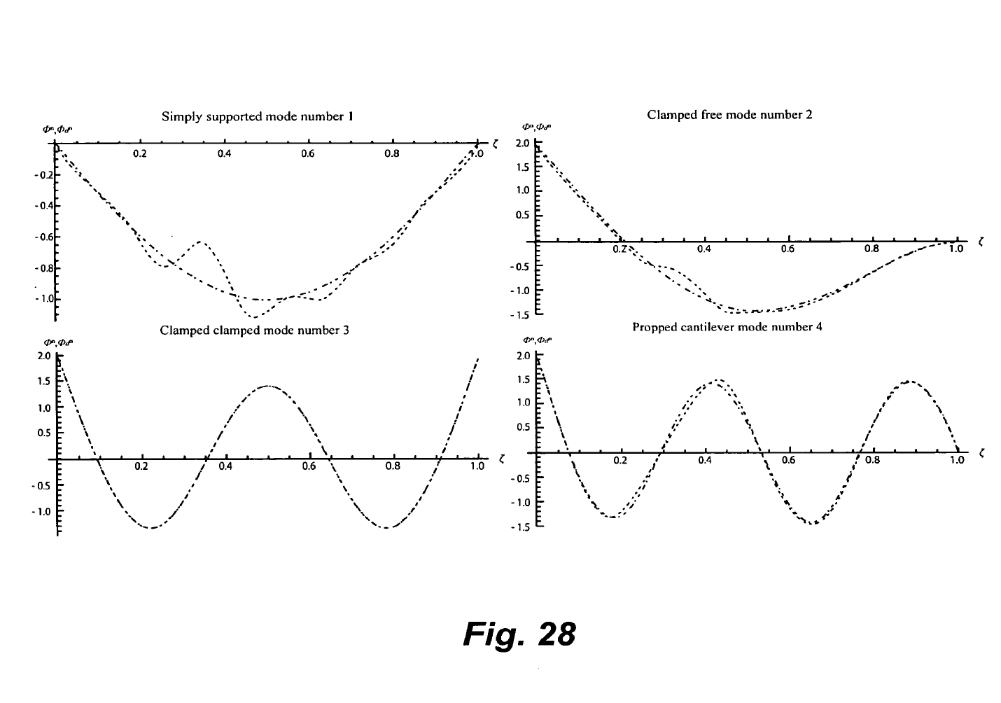

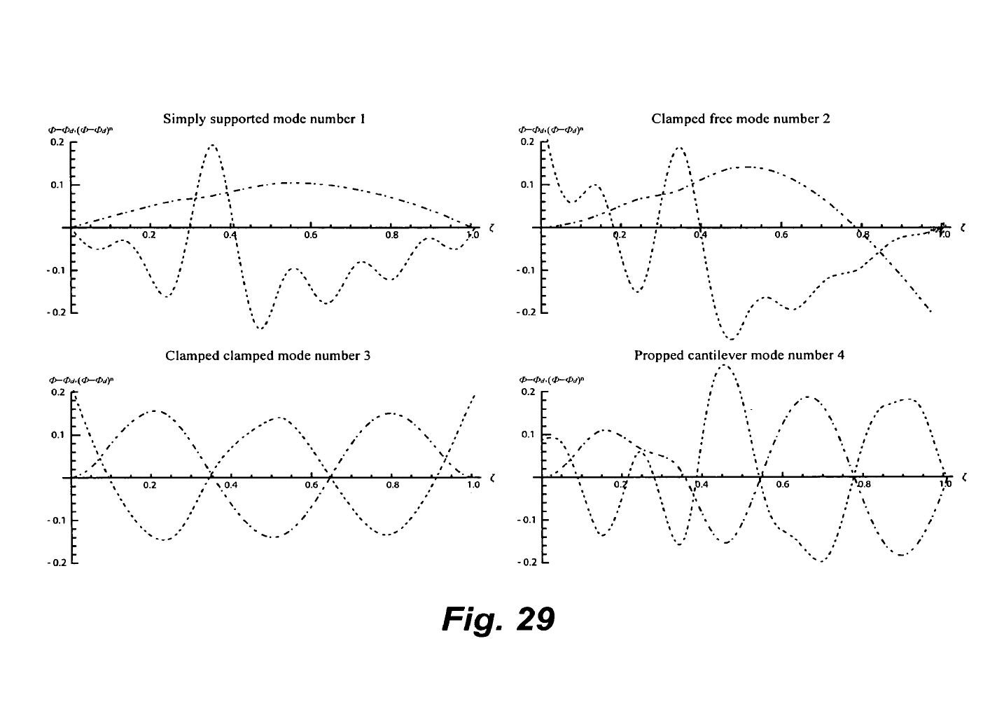

The last damage parameter i.e. the extent of damage, was investigated. The two cases considered are for ΔL_{z}=0.001 and ΔL_{z}=0.1 along with the case ΔL_{z}=0.01 considered earlier. The mode shapes are similar in characteristics to the plots in the FIG. 9 for both cases. The curvature shape too has the same characteristics for the case of ΔL_{z}=0.001; however, for the case of ΔL_{z}=0.1, the damage is more prominently identified. The curvature shapes for ΔL_{z}=0.1 are given in FIG. 28. The modal difference plots are given in FIGS. 26 and 29. None of the four modes are able to identify the damage for the first case ΔL_{z}=0.001. For the latter case ΔL_{z}=0.1, the peaks become sharper for the first mode for the simply supported case, and the second mode, clamped free case. The third mode with the clamped clamped boundary still does not give any indication of damage. An important feature is that the propped cantilever, mode four, gives an incorrect indication for the location of damage.

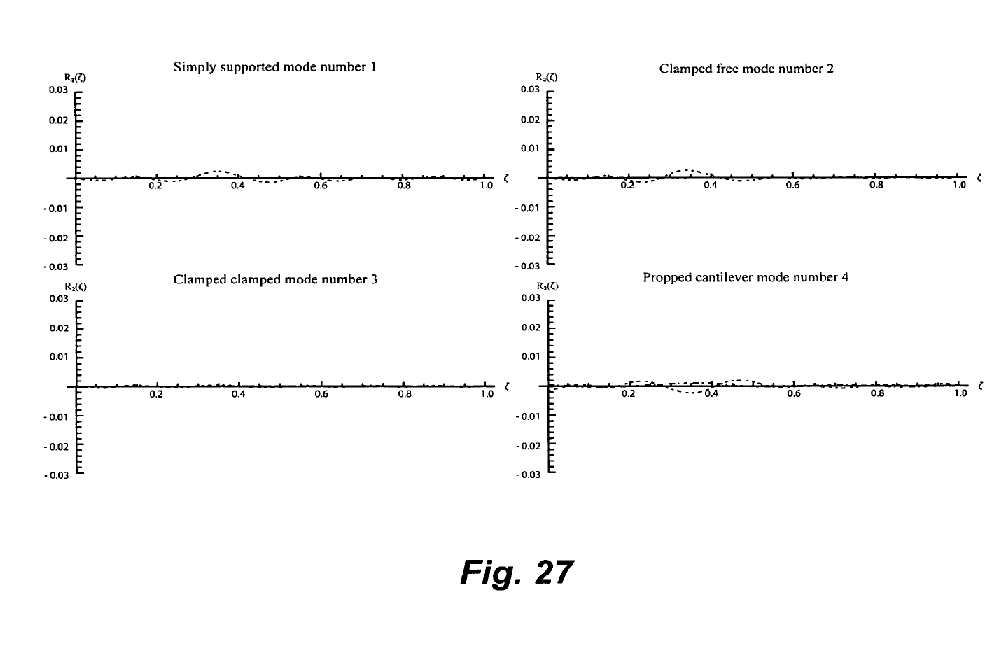

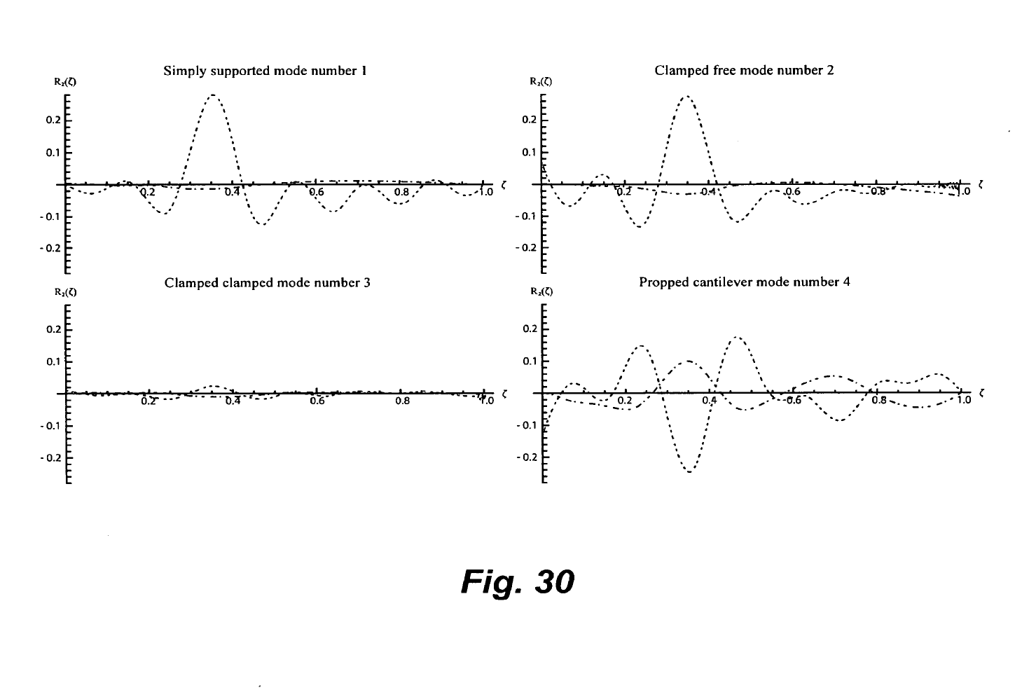

The plots giving the damage signature are given in FIGS. 27 and 30. The y-axis range for the plots is increased from 0.03 to 0.3 to be able to see the peaks clearly for the case when ΔL_{z}=0.1. Unlike the normalized modal difference plots, the damage can still be identified for the case of ΔL_{z}=0.001, although the peaks are diminished. Also, unlike the normalized modal difference plots, there are no false damage locations identified.

The present invention provides a new physical quantity, “damage signature” expressed as the “partial mode contribution” physically explained hereinbefore in Equation (49), and verified by the analytical derivation presented Equation (84). An application of the partial mode contribution to damage identification in the field of SHM is shown.

The method outlined herein addresses two challenges in the field of vibration-based SHM, that of

(i) sensitivity, since the presented quantity—the partial mode contribution—was shown to be more sensitive than existing physical quantities like displacement mode shapes, curvature mode shapes and the difference of the normalized displacement or curvature shape between the damaged and undamaged states of the beam. The sensitivity was maintained for mode shapes that had experimental noise. Also, the sensitivity was uniform when mode shapes were compared for different boundary conditions; and

(ii) the conventional requirement of baseline data from the undamaged structural state, since the presented physical quantity does not require a baseline to identify the damage.

As shown, the difference between the normalized mode shape and curvature shape gives a false indication of damage in cases of damage as shown in FIG. 29 for the propped cantilever case.

The partial mode contribution is a primary physical quantity, and does not require derivative numerical processes as required by natural frequencies and strain energy-based damage identification procedures. Similar to the derivative procedures for displacement and curvature mode shapes, like calculation of strain energy, derivative procedure for partial mode contribution based on strain energy are being investigated for damage characterization and quantification. The derivative procedures should have higher sensitivity compared to existing damage detection measures, since the dependent physical quantity is more sensitive compared to dependent physical quantities for existing damage measures.

The present method was applied to structures using an Euler-Bernoulli beam theory. It was seen that the order of sensitivity was same for different boundary conditions. The sensitivity, however, was greater for curvature mode shapes as compared to displacement mode shape as were the number of oscillations. The ability of these two parameters to detect damage can be studied for different levels of noise in the measured data.

The present invention provides that the partial mode contribution lacks dependence upon environmental conditions like temperature.

Thus, in a preferred process of damage localization using the partial mode contribution, a process is disclosed for detecting damage in a structure, wherein the structure has one or more undamaged parts, each with no damage, and if the structure has damage, the structure also has one or more damaged parts, each with damage, the process comprising providing the mode shapes of the structure modeled having no damage, determining the mode shapes of the structure having damage, expressing the mode shapes of the structure as a sum of the mode shapes due to the structure having no damage to obtain the part of the mode shapes due to the undamaged part of the structure, and the part of the mode shapes due to the damaged part of the structure, and isolating the part of the mode shapes due to the damaged part of the structure, wherein the part of the mode shapes due to the damaged part of the structure is the partial mode contribution.

The structure can include more than one location of damage.

### Spectral Finite Element: Equivalent Force And Equivalent Stiffness Methods

The present invention further comprises using Equivalent Force Method (EFM) and Equivalent Stiffness Method (ESM) to determine vibration characteristics of a multi-element structure if the location and magnitude of the damage are known. The present invention is a robust process to extend the procedure to multi-element scenario, which has heretofore not been known.

Two algorithms to extend the procedure to multi-element scenarios are disclosed and compared for their computation efficiency. Examples of the present methods are investigated taking the vibration of structures having rod elements as an example. Further, a notch is added to the rod elements as an example of damage. The analytical model used is Spectral Finite Element Method (SFEM). SFEM is used in conjunction with the perturbation technique, to determine the vibration characteristics, in particular the displacements of these three-dimensional truss structures.

SFEM is similar to Finite Element Method (FEM), but solves the problems in spectral or frequency domain. To tackle the case in which the notch is also present in the element, the displacements are perturbed taking the ratio of dimensions of the notch to that of the rod as the perturbation parameter. This introduces higher order displacements into the Equation. It is shown that each order of displacement is governed by an Equation similar to the Governing Differential Equation (GDE) of the element under question. This enables the representation of GDE in the form of a matrix, ordered as per the order of perturbation correction on displacements. It is shown that reordering the displacement according to the joint numbers, and treating the higher order correction to displacements as additional fictitious degrees of freedom, transformation of element matrices to global coordinate system and subsequently assembling them to structural matrices can be performed in a manner similar to FEM.

The above is implemented using ESM and EFM. In the force equivalent form, the notch is modeled as an equivalent force. The stiffness matrix at an element level is the same as that for an undamaged rod with an order of 2*2. The solution procedure is composed of several steps. First zeroth-order displacements are determined, by inverting the undamaged stiffness matrix. Next, equivalent first order forces are determined. Finally, first order perturbation displacements are calculated. The same process is repeated for higher order displacements. Hence, if the order of correction in the perturbation Equation is n, then the number of steps involved in the equivalent force method would be 2n+1.

In the stiffness equivalent form, the notch is modeled as a change in stiffness of the undamaged rod, and the nodal force matrix remains unchanged in this case. The stiffness matrix is composed of the stiffness matrix of undamaged rod, and a correction introduced due to damage. This composite stiffness matrix is inverted to get all the displacements (zeroth-order, first order perturbation, and so on). In the stiffness equivalent form, only one matrix of order (2+2n)*(2+2n) is inverted to get the displacements in a single step. Note again that n is the order of asymptotic correction.

A full three-dimensional truss analysis program based on the direct stiffness method is developed. The truss members comprising the truss structure may have damage that is modeled as notches anywhere in the element. The number of members is limited by the computer memory rather than the procedure itself. Unlike conventional methods, no node is placed at the damage location. Yet, this seemingly innocuous change has important implications, since, now the inverse problem may be solved by taking the damage location and magnitude as the unknowns. The program is developed using C programming language. The present invention demonstrates the commercial viability of SFEM in solving real vibration problems with damages in members.

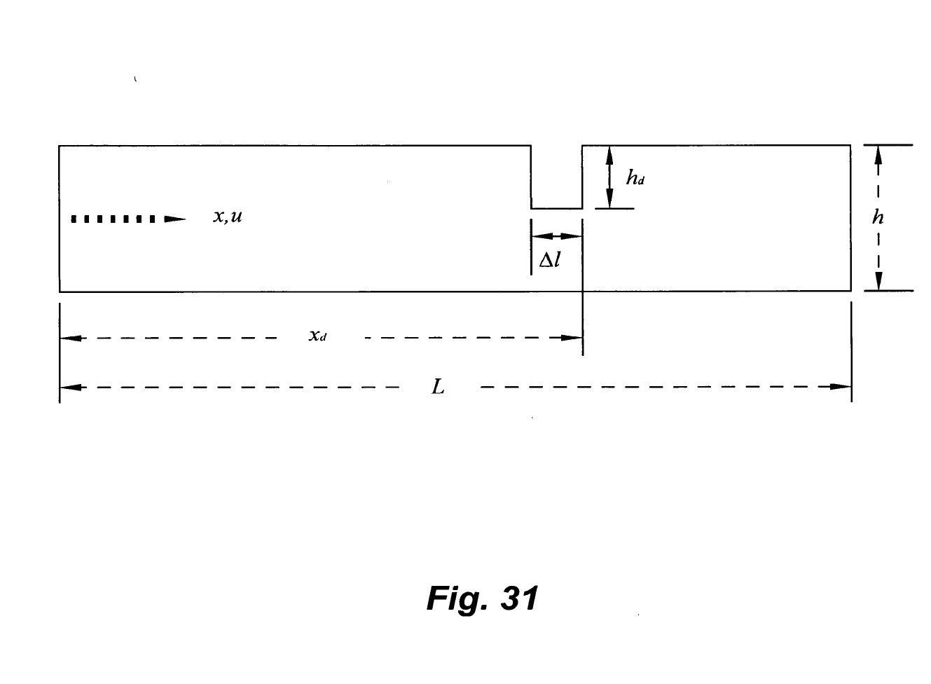

The development of the equivalent force and equivalent stiffness method is as follows. The Governing Differential Equation (GDE) for a uniform rod as shown in FIG. 31 is:

$$\frac{\partial }{\partial x} [ E A ( x ) \frac{\partial u}{\partial x} ] - ρ A ( x ) \frac{{\partial }^{2} u}{\partial {t}^{2}} = - f ( x , t ) \qquad ( 85 )$$

where E and ρ are the Young's modulus and the mass density respectively, f(x, t) is the applied load and u is same as u(x, t) and is the axial displacement. We consider a rod of length L, height h and width b. A notch with length Δl and depth h_{d} is placed at the distance x_{d}. The cross-sectional area along the rod is given by A(x). The lateral area of the undamaged rod is A₀=bh.

The lateral area of the damaged rod is calculated as:

$$A ( x ) = {A}_{0} \{ 1 - \frac{{h}_{d}}{h} [ H ( x - ( {x}_{d} - Δ l ) ) - H ( x - {x}_{d} ) ] \} \qquad ( 86 )$$

where H is the Heaviside step function. Let

$$ɛ = \frac{{h}_{d}}{h} .$$

Putting Equation (85) in Equation (86), the Governing Differential Equation for a damaged rod is obtained:

$$\frac{\partial }{\partial x} \{ E {A}_{0} [ 1 - ɛ {γ}_{d} ( x ) ] \frac{\partial u}{\partial x} \} - ρ {A}_{0} [ 1 - ɛ {γ}_{d} ( x ) ] \frac{{\partial }^{2} u}{\partial {t}^{2}} = - f ( x , t ) \qquad ( 87 )$$

where γ_{d}=H(x−(x_{d}−ΔL))−H(x−x_{d}).

Equation (87) is conveniently expressed in the frequency domain through the Discrete Finite Fourier Transformation (DFT) of the applied load f(x, t) and rod displacement u(x, t), which is expressed as:

$$f ( x , t ) = {\sum }_{k} {\hat{f}}_{k} ( x , {ω}_{k} ) {e}^{i {ω}_{k} t} \\ u ( x , t ) = {\sum }_{k} {\hat{u}}_{k} ( x , {ω}_{k} ) {e}^{i {ω}_{k} t} \qquad ( 88 )$$

where i=\sqrt{−1}, and \hat{f}ₖ(x,ωₖ) denotes the harmonic component of the generalized load at frequency ωₖ, and ûₖ(x, ωₖ) is the displacement corresponding to the k-th harmonic component of the load. For simplicity, in the remainder of the disclosure, the subscript k is dropped so that the following notation is adopted

ωₖ=ω,ûₖ(x,ωₖ)=û(x,ω) and \hat{f}ₖ(x,ωₖ)=\hat{f}(x,ω). The hat on top of u and f represent that the quantities are at an element level. Substituting Equation (88) in Equation (87) we get:

$$[ 1 - {ɛγ}_{d} ( x ) ] ( \hat{u} {,}_{xx} + \frac{{ω}^{2}}{{c}^{2}} \hat{u} ) - {ɛγ}_{d , x} {\hat{u}}_{x} = \frac{1}{ρ {A}_{0} {c}^{2}} \hat{f} ( x , ω ) \qquad ( 89 )$$

where c²=E/ρ and the subscript (.)_{,x} denotes the derivative with respect to x.

Next, the axial displacement of the rod is considered as a perturbation, over the small parameter ε, of the axial displacement of the undamaged rod:

û(x,ω)=û⁽⁰⁾(x,ω)−εû⁽¹⁾(x,ω)−O(ε²) (90)

The i in u⁽ⁱ⁾ represents the order of correction in the perturbation Equation and O(ε²) represents the term of order higher than two. Replacing the unknown function û given by Equation (90) into the differential Equation (89), and collecting the coefficients of the ε⁰ and ε¹, the governing Equations of the damaged rod can be written as:

$$\begin{matrix} {ɛ}^{0} \text{:} \hat{u} {,}_{xx}^{( 0 )} ( x , ω ) + \frac{{ω}^{2}}{{c}^{2}} {\hat{u}}^{( 0 )} ( x , ω ) = \frac{1}{{A}_{0} E} \hat{f} ( x , ω ) & ( 91 ) \\ {ɛ}^{1} \text{:} \hat{u} {,}_{xx}^{( 1 )} ( x , ω ) + \frac{{ω}^{2}}{{c}^{2}} {\hat{u}}^{( 1 )} ( x , ω ) = - {γ}_{d} ( x ) [ \hat{u} {,}_{xx}^{( 0 )} ( x , ω ) + \frac{{ω}^{2}}{{c}^{2}} {\hat{u}}^{( 0 )} ( x , ω ) ] - {γ}_{d , x} ( x ) \hat{u} {,}_{x}^{( 0 )} ( x , ω ) & ( 92 )\end{matrix}$$

Equation (91) is same as the GDE for a rod with constant area and E. The left hand side of Equation (92) is again same as that for a rod, if the right hand side is regarded as an expression of the force acting on the rod, Equation (92) too becomes the GDE for the rod. Hence, the solution procedure for both Equations (91) and (92) can be same as that for the GDE of the rod. The complementary solution for the rod problem is given by:

\hat{u}(x,ω)=A(ω)e^{-ikx}+B(ω)e^{-ik(L-x)} (93)

where

$$k = \frac{ω}{c} .$$

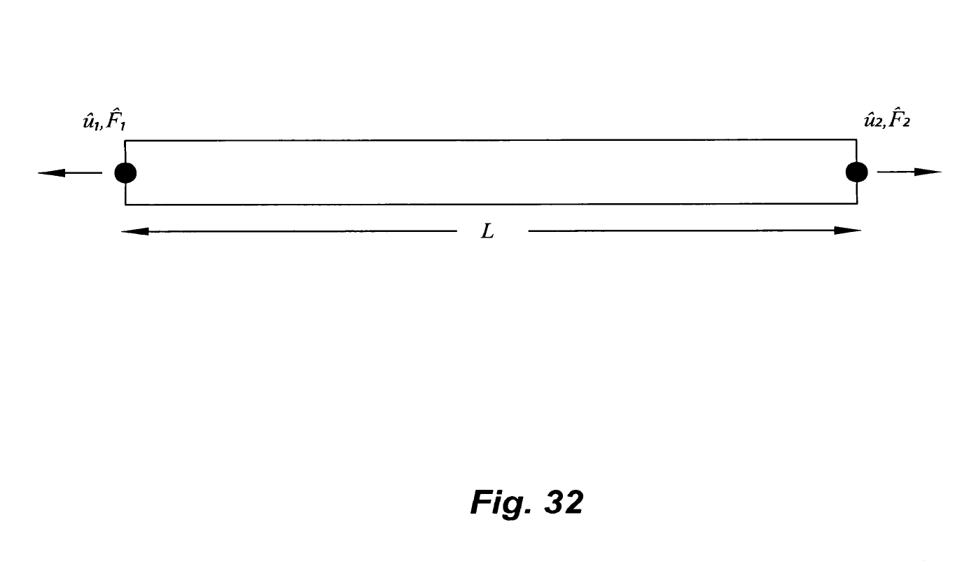

The values of the constants can be found by applying the boundary conditions for the element of FIG. 32.

$$\begin{matrix}\{ \begin{matrix}A \\ B\end{matrix} \} = \frac{1}{( 1 - {e}^{- 2 i k L} )} [ \begin{matrix}1 & {e}^{- k L} \\ {e}^{- k L} & 1\end{matrix} ] \{ \begin{matrix}{\hat{u}}_{1} \\ {\hat{u}}_{2}\end{matrix} \} & ( 94 ) \\ \begin{matrix}\hat{u} ( x , ω ) = \frac{sin [ k ( L - x ) ]}{sin ( k L )} {\hat{u}}_{1} + \frac{sin ( k x )}{sin ( k L )} {\hat{u}}_{2} \\ = {h}_{1} ( x , ω ) {\hat{u}}_{1} ( ω ) + {h}_{2} ( x , ω ) {\hat{u}}_{2} ( ω )\end{matrix} & ( 95 )\end{matrix}$$

Substituting the Equations (95) in the Governing Differential Equation, the expression is written in stiffness equivalent form as:

$$[ \begin{matrix}\hat{K} ( ω ) & 0 \\ - \hat{A} ( ω ) & \hat{K} ( ω )\end{matrix} ] \{ \begin{matrix}{\hat{d}}^{( 0 )} ( ω ) \\ {\hat{d}}^{( 1 )} ( ω )\end{matrix} \} = \{ \begin{matrix}{\hat{f}}^{( 0 )} ( ω ) \\ 0\end{matrix} \} \qquad ( 96 )$$

Here, \hat{K}(ω) is the stiffness of the undamaged rod, and Â(ω) is the term that couples the first order displacements to the zeroth-order displacement, and it occurs due to the presence of notch. This term occurs due to the pseudo force applied at the location of the notch due to presence of the notch. The value of the force is given by:

$$\hat{g} ( x , ω ) = {γ}_{d} ( x ) {\hat{u ,}}_{xx}^{( 0 )} ( x , ω ) + {γ}_{d} ( x ) \frac{{ω}^{2}}{{c}^{2}} {\hat{u}}^{( 0 )} ( x , ω ) + {γ}_{d , x} {\hat{u ,}}_{x}^{( 0 )} ( x , ω ) ( 97 )$$

The Â(ω) is then constructed by substituting û from Equation (95):

$$\{ \begin{matrix}{\int }_{0}^{L} \hat{g} {h}_{1} d x \\ {\int }_{0}^{L} \hat{g} {h}_{2} d x\end{matrix} \} = \hat{A} ( ω ) {\hat{d}}^{( 0 )} ( ω ) \qquad ( 98 )$$

In the force equivalent form, the Equations are:

\hat{K}(ω)\hat{d}⁽⁰⁾(ω)=\hat{f}⁽⁰⁾(ω)

\hat{K}(ω)\hat{d}⁽¹⁾(ω)=\hat{f}⁽¹⁾(ω)

where \hat{f}⁽¹⁾(ω)=Â(ω)\hat{d}⁽⁰⁾(ω) (99)

Until this point, the general SFEM formulation for rod elements has been extended to a rod with a notch using perturbation of displacements. The two algorithms, namely the Equivalent Stiffness Method and the Equivalent Force Method are below disclosed, which extend this formulation to a multi-element scenario.

Equivalent Stiffness Method

Consider Equation (99), the displacements for a m joints n^{th} order perturbation Equation can be represented as \hat{d}(ω)={\hat{d}⁰(ω)\hat{d}¹(ω) . . . \hat{d}ⁱ(ω)}^{T}, here \hat{d}²(ω)={\hat{d}₁(ω)ⁱ\hat{d}₂(ωⁱ . . . \hat{d}ₘ (ω)ⁱ}^{T}.The generalized stiffness matrix in Equation (99) is represented by \hat{K}ₑ (ω) and the generalized force matrix by \hat{f}ₑ(ω), where the force matrix is arranged similar to the displacement matrix. The subscript denotes the joint number, and the superscript denotes the order of correction in the perturbation Equation.

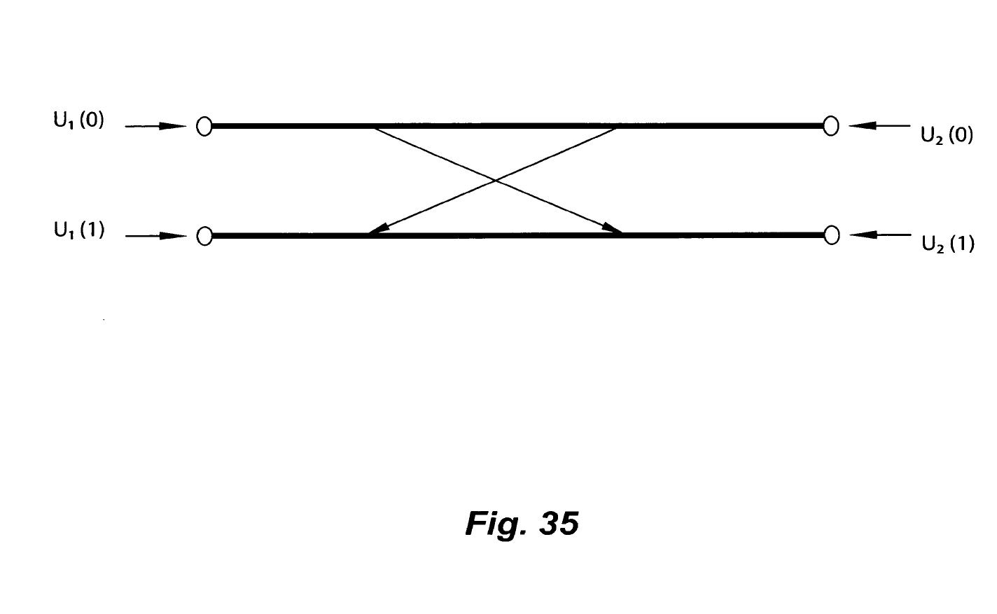

In the FEM, the element assemblage and obtaining a global structural matrix depends on transformation of the element matrix to a global coordinate system. This is not possible in the present form, since the displacements are arranged by collecting all the displacements for all the joints of a particular order of perturbation correction put together. To be able to determine the transformation matrix and allow element assemblage the element matrices are rearranged by collecting all the displacements (comprising all orders of correction) for a particular joint together. The displacement matrix will then look like \hat{d}(ω)={\hat{d}₁(ω)\hat{d}₂(ω) . . . \hat{d}ₙ(ω)}^{T}, here \hat{d}ⱼ(ω)={\hat{d}ⱼ⁰(ω)\hat{d}ⱼ¹(ω) . . . \hat{d}ⱼⁿ(ω)}. The different representation gives a different perspective to the problem. The problem is now phrased in typical FE language, where each order of correction is displacement, representing a degree of freedom in FE language. The end conditions of these degrees of freedom are same as the joint degrees of freedom for the zeroth-order correction. A schematic of the finite element for a truss element considering only first order correction, as outlined in the procedure is shown in FIG. 35.

Due to this re-organization of displacements, the element stiffness \hat{K}ₑ (ω) and the force matrix \hat{f}ₑ(ω) are also changed correspondingly. Let the new element stiffness matrix be \hat{K}^{c}(ω) and the force matrix \hat{f}^{c}(ω).

The element equilibrium Equation is then written as:

[\hat{K}]^{c}{\hat{d}}^{c}={\hat{f}}^{c} (100)

Substituting \hat{d}^{c}=[T]*\hat{d}_{g} and \hat{f}^{c}=[T]*\hat{f}_{g} in Equation (100), and then pre-multiplying by {T}^{T}, using matrix algebra it can be shown that {T}^{T}*{T}=[I] and also {T}^{T}*\hat{K}^{c}*{T}=\hat{K}_{g}, where \hat{K}_{g} denotes the element stiffness matrix in global coordinate system. The matrices can now be assembled using standard element assemblage rules to give a global structural Equation as given by Equation (101). The Equation can now be solved to obtain the displacements and perturbation corrections simultaneously.

[K]{d}={f} (101)

Equivalent Force Method

In the above procedure, the displacement perturbations were made analogous to a degree of freedom at the joint, and this made the standard procedure of FEA applicable. However there is another important characteristic of the Equation (96). Equation (96) has in its stiffness matrix upper right quadrant zero—this decouples the zeroth-order correction from the first order correction, and so on. Or in other words, there is only one way coupling of displacements. This means that the zeroth-order displacements are determined by invoking a process outlined in the previously, on Equation (99). This will result in an Equation similar to Equation (101), but the displacement matrix is composed of only zeroth-order displacements, and the force matrix is composed of only zeroth-order or nodal forces. The zeroth-order displacements can now be determined.

For Equation (99) because of the previous analogy between perturbation displacements and degrees of freedom, it is seen that \hat{d}_{g}⁽¹⁾(ω)={T}*\hat{d}⁽¹⁾(ω) and \hat{f}_{g}⁽¹⁾(ω)={T}*\hat{f}⁽¹⁾(ω). Put the relations in Equation (99), and pre-multiply it with {T}^{T}, and the following relation is then obtained:

\hat{K}(ω)*{T}*\hat{d}_{g}⁽¹⁾(ω)=Â(ω)*{T}*\hat{d}_{g}⁽⁰⁾(ω) (102)

Pre-multiplying the above Equation with {T} and using \hat{K}_{g}(ω)={T}*\hat{K}(ω)*{T}^{T}A_{g}(ω) provides the right hand side of Equation (102) with an expression {T}*Â(ω)*{T}^{T}. Although Â is not a stiffness matrix, it is a second order tensor so the transformation rule for the second order tensor is valid for it as well The expression can be represented by Â_{g} (w). Putting these in Equation (102) provides:

\hat{K}_{g}(ω)\hat{d}_{g}⁽¹⁾(ω)=Â_{g}(ω)\hat{d}_{g}⁽⁰⁾(ω) (103)

Both the \hat{K}_{g}(ω) and Â₈(ω) are again assembled from element global matrices to structural global matrices using standard finite element algorithms (direct stiffness method was used to make the program for the purpose of the present invention). The final Equation is represented as Equation (104). The first order displacements are now to be determined. The higher order displacements are determined using a similar procedure:

\hat{K}(ω)\hat{d}⁽¹⁾(ω)=Â(ω)\hat{d}⁽⁰⁾(ω) (104)

It should be noted that neither the global structural stiffness matrix of Equation (101) nor the damaged stiffness matrices Equation (102) are actual stiffness matrices, as they are non symmetric. Neither are the corrections due to perturbations in additional degrees of freedom for the structure. The description given makes the understanding of the processes easier rather than having any physical meaning.

The two methods ESM, EFM, were written in C and compared for computational cost. The program is a full three-dimensional truss analysis program that can handle notches as damages. The program is based on the direct stiffness method. First, the joint inputs and member inputs are taken. The joint inputs are support conditions, nodal forces, support settlement if any, and nodal coordinates. The member inputs are member lengths, their areas, temperature change if any, and fabrication error regarding the length of the member. The inputs are sent to the analysis routine where the element stiffness matrix is calculated.

This matrix is changed to an element global stiffness matrix using a transformation matrix composed of direction cosines. The element global stiffness matrix for each element is put together in a structural global stiffness matrix. The nodal force too is similarly transformed and assembled. The support conditions then now applied to separate the unknown forces and unknown displacements. The unknown displacements are then calculated using the structural global stiffness matrix. The known displacements can then be used to calculate the member forces and support reactions.

The shortcomings of the program include that it uses only static memory allocation that severally restricts the maximum number of members. Also, presently, only one notch per member can be handled. The computational efficiency is hampered due to the sparse distribution of the stiffness matrix.

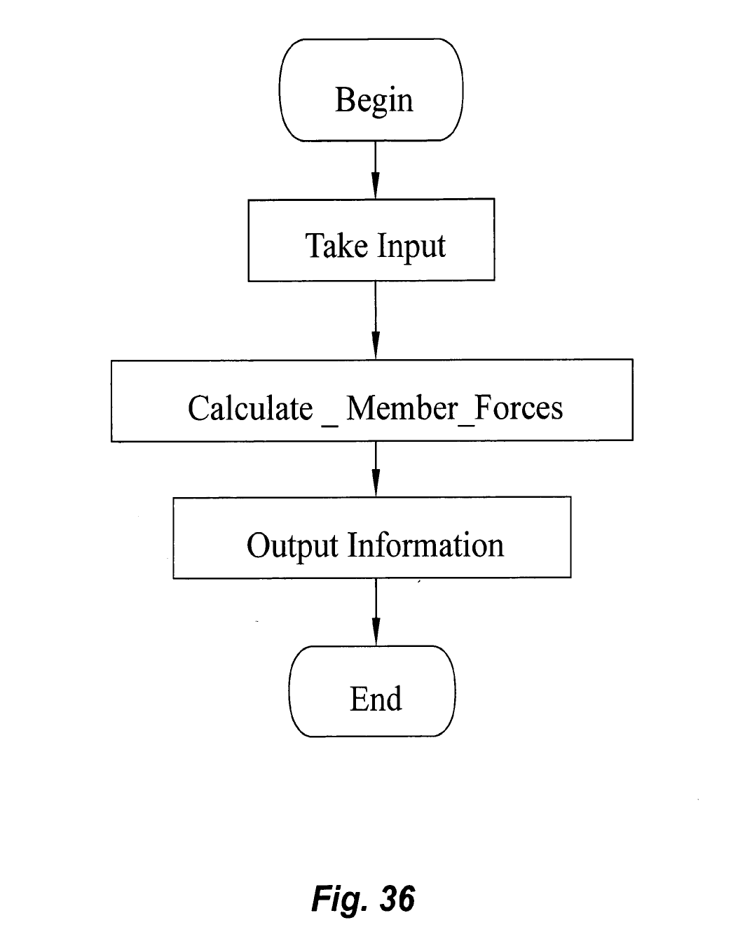

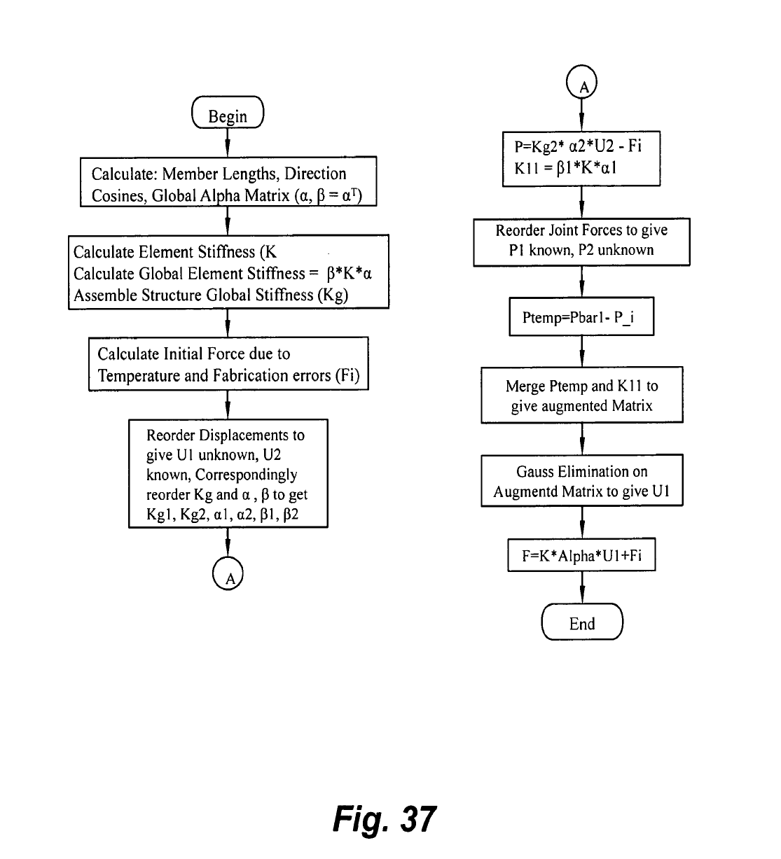

A flow chart for the program explaining the direct stiffness method is provided in FIGS. 36 and 37. This method is iterated for all the frequencies considered for according to the method (ESM or EFM) considered.

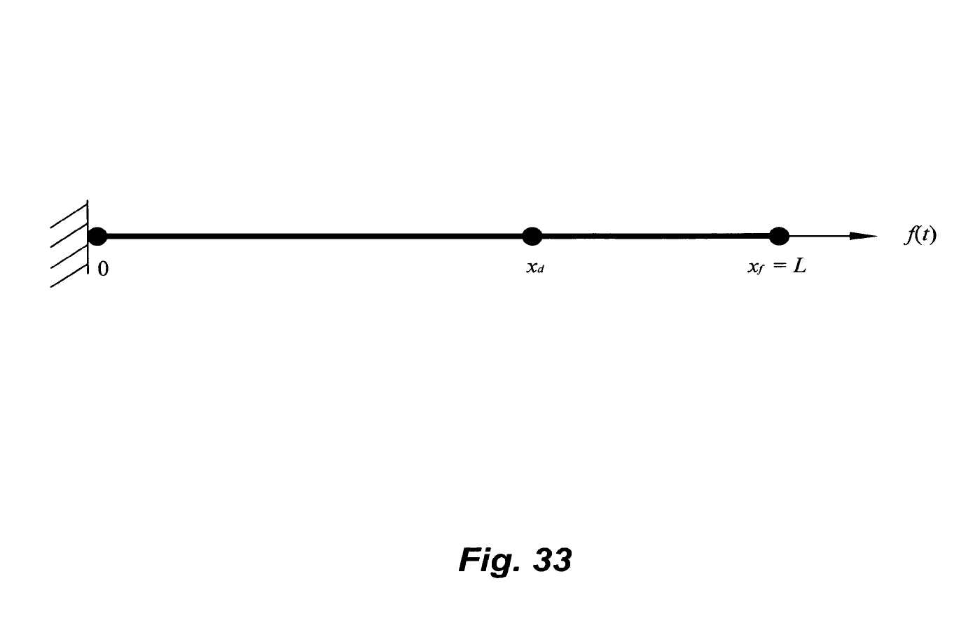

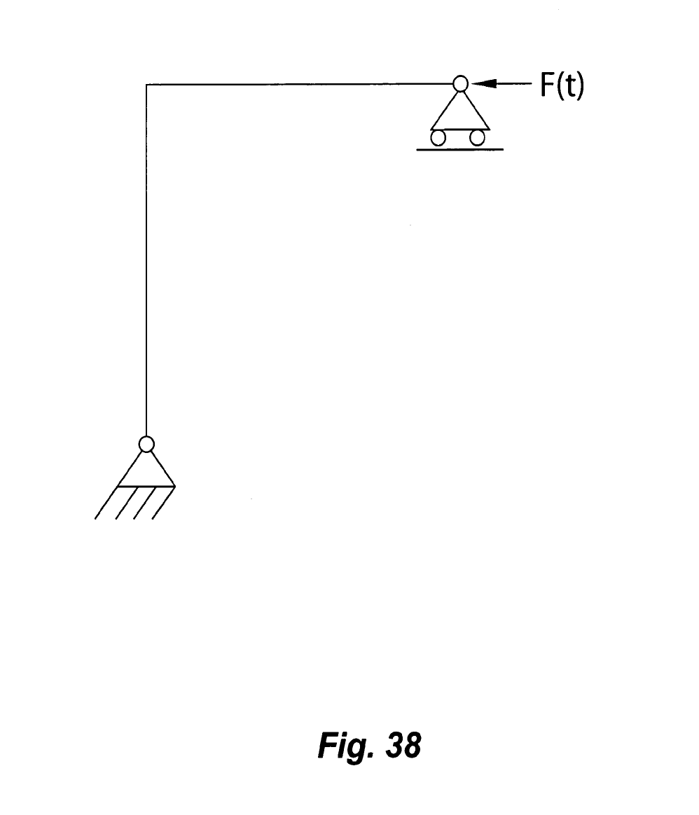

The specimens chosen to run an experiment are shown in FIGS. 33 and 38.

The members are of length L=1 m, width b=0.05 m and thickness h=0.01 m. The rod is modeled using one element, unlike two elements as previously discussed, i.e. there is no node present at the notch location. The material properties are: Young's modulus E=70 GPa and mass density ρ=2750 kg/m³. A notch with depth h_{d}=h/30 and length Δl=0.01 is placed at distance x_{d}=3 L/4.

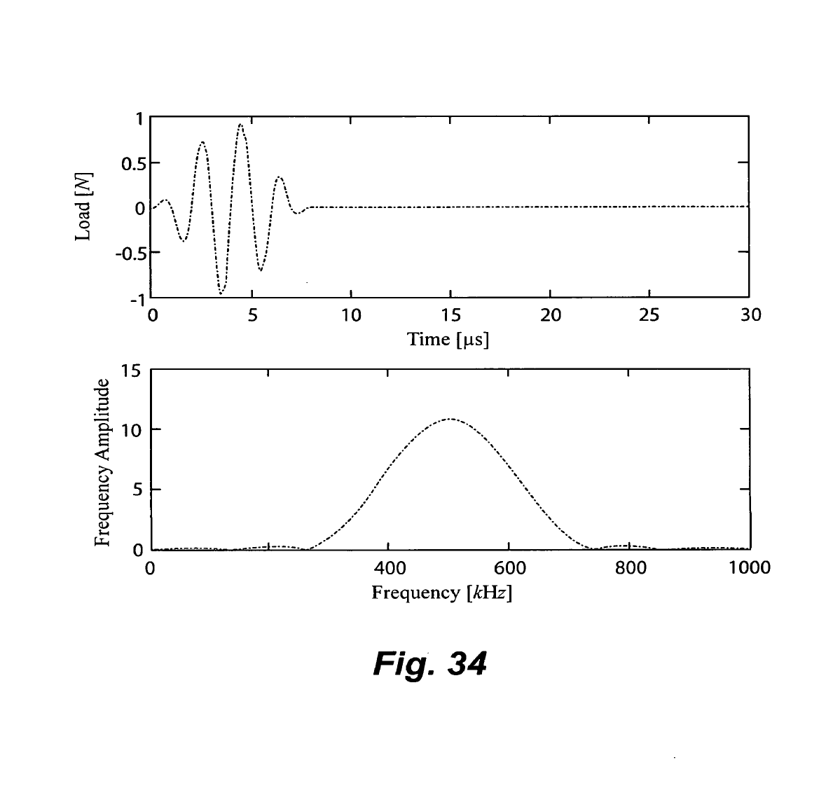

The three types of loads considered are a sinusoidal load, a step function, and a hanning window as presented in FIG. 34 (in both time and frequency domains).

The stiffness matrix for ESM is twice the size than that of EFM, hence the memory for ESM is four times the memory requirement for EFM. The memory requirement for ESM and even for EFM can be substantially reduced if the sparseness of the matrix is considered.

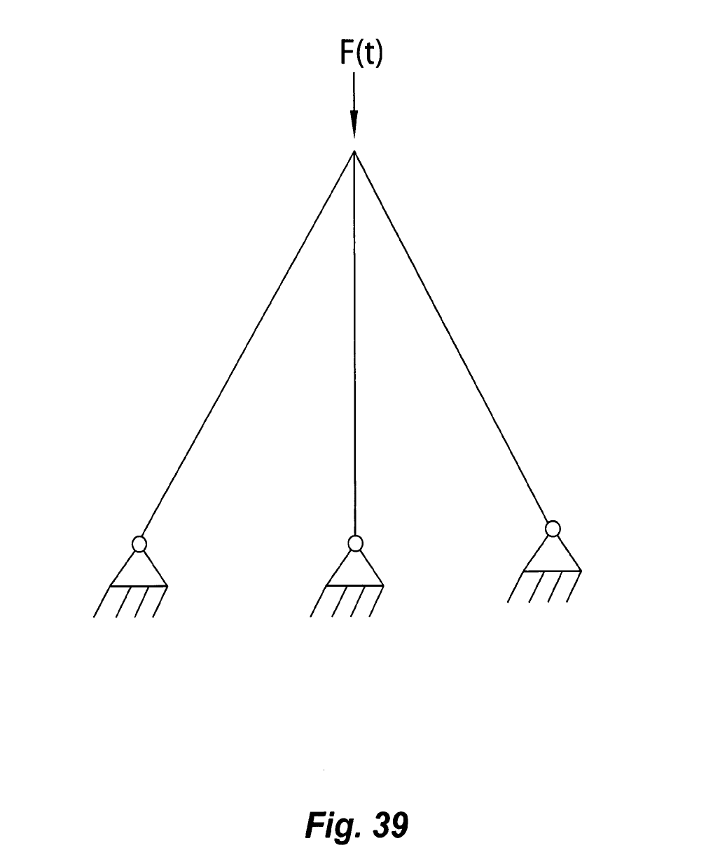

TABLE 1 illustrates the computational speed comparison for the two methods, ESM and EFM. The time is given in seconds. Serial number (SN) 1 represents the rod structure shown in FIG. 33, SN 2 represents the rod structure shown in FIG. 38, and SN 3 represents the structure shown in FIG. 39. The three load cases (LC) considered are, LC1=sin(2*t*75000*π), LC2=a unit step function, and LC3=0.5*(1−cos(2*π*i/(NumDiv−1)))* sin(2*t*75000*π), where t is the time, NumDiv is the total division for the time interval, and i the division iterator.

TABLE 1

| SN | LC | ESM | EFM |
|---|---|---|---|
| 1 | 1 | 2 | 1 |
| 2 | 1 | 13 | 2 |
| 3 | 1 | 30 | 9 |
| 1 | 2 | 2 | 1 |
| 2 | 2 | 13 | 2 |
| 3 | 2 | 31 | 8 |
| 1 | 3 | 2 | 1 |
| 2 | 3 | 13 | 2 |
| 3 | 3 | 30 | 9 |

The present invention for the first time shows the commercial viability in the field of SHM of extensibility using SFEM in conjunction with perturbation techniques.

As is shown, the memory requirement is higher for ESM than EFM, but this is because the order of stiffness matrices and all the other dependent computational matrix in the EFM method is equal to the number of joints by number of joints. However, in the case of ESM, the order is the product of the number of joints and the correction order in the perturbation of displacement Equation.

The results are same for the examples considered to the third decimal place when expressed in exponential form, for both zeroth and first order displacements. The accuracy of displacements of order higher than zeroth displacement may drop if composite or non-linear elements are considered. This is because at each step of computation, the accuracy decreases and the number of steps involved in the EFM are higher than in the ESM.

The speed requirement increases exponentially with the number of members, where ESM is faster than EFM as seen in TABLE 1.

The ability of the program to deal with ESM, which can be interpreted as an addition of a degree of freedom gives the program the ability to be extended to higher degrees of freedom elements like beams and plates.

The program can be upgraded to use dynamic memory allocation. The sparseness of the stiffness matrix should be dealt with in a more efficient manner.

Also as can be seen from TABLE 1, the type of direction of force or the placement or number of notches do not affect the computational speed.

Since no node is required to be placed at the notch location, it can be explored if the inverse problem can now be solved. In the inverse problem, the problem is expressed in terms of damage parameters.

Thus, in a preferred embodiment of the spectral finite element: equivalent force and equivalent stiffness methods, a process of modeling three-dimensional multi-structural structure with finite element analysis is provided, wherein at least one of the structures has damage, the process to obtain mode shapes and natural frequencies of the three-dimensional structure, the process comprising, for each of the structures of the three-dimensional structure having damage, providing the physical characteristics of the structure, providing a finite element method code, perturbing the mode shapes and natural frequencies of the structure without damage based on the physical characteristics of the damage, calculating nth-order, perturbed differential equations governing the mode shapes and natural frequencies of the structure with damage, wherein n is 1 or greater, and forming a finite element where the damage is modeled as an equivalent (negative) force, wherein the finite element is used with the finite method element code to obtain the mode shapes and natural frequencies of the three-dimensional structure.

The step of forming a finite element where the discontinuity is modeled as an equivalent (negative) force can be replaced with the step of forming a finite element where the discontinuity is modeled as an equivalent (negative) stiffness.

The physical characteristics of each structure can include one or more of spatial, geometric and material characteristics of the structure and damage.

The structure can include more than one location of damage.

### Investigation of the Effect of Damage Shape and Beam Shape Using a Unified Framework

The general eigenvalue problem to determine the mode shapes and natural frequencies of elastic structures, such as rods, beams, plates and shells, is given as discussed previously:

Lφ(x₁)−λMφ(x₁)=0 (105)

where L is the stiffness operator, M is the inertia matrix and λ is the eigenvalue. The order of L is an even integer, 2p. The Equation is valid for conservative distributed parameter structures, which represent a very large and important class of systems, namely self-adjoint systems. Note that λ=ω² where ω is the natural frequency, and φ is the eigenfunction or the mode shape.

The independent variables xᵢ (i=1, 2, 3) denote the spatial dimensions (with i representing the direction). Therefore, it denotes the one-dimensional space in the case of beams, the two-dimensional space in the case of plates and shells, and the three-dimensional space in the case of three-dimensional structures. The displacements and rotations corresponding to the spatial dimension xᵢ are uᵢ and θᵢ, respectively. In case of an Euler-Bernoulli beam, the variables of Equation (105) are given by:

$$L = \frac{{d}^{2} {H}_{33} ( {x}_{1} )}{d {x}_{1}^{2}} \frac{{d}^{2}}{d {x}_{1}^{2}} \\ M = m ( {x}_{1} ) \\ φ ( {x}_{1} ) = {u}_{1} ( {x}_{1} ) \\ {H}_{33} ( {x}_{1} ) = E ( {x}_{1} ) {I}_{3} ( {x}_{1} ) \qquad ( 106 )$$

and in the case of a Timoshenko beam, their values are:

$$L = [ \begin{matrix}- \frac{d {K}_{22} ( {x}_{1} ) d}{d {x}_{1}^{2}} & \frac{d {K}_{22} ( {x}_{1} ) d}{d {x}_{1}} \\ - \frac{{K}_{22} ( {x}_{1} ) d}{d {x}_{1}^{2}} & {K}_{22} ( {x}_{1} ) - \frac{d {K}_{33} ( {x}_{1} ) d}{d {x}_{1}^{2}}\end{matrix} ] \\ M = [ \begin{matrix}m ( {x}_{1} ) & 0 \\ 0 & J ( {x}_{1} )\end{matrix} ] \\ φ ( x ) = \{ \begin{matrix}{u}_{1} ( {x}_{1} ) \\ {θ}_{3} ( {x}_{1} )\end{matrix} \} {K}_{22} ( {x}_{1} ) = κ G ( {x}_{1} ) A ( {x}_{1} ) \qquad ( 107 )$$

where E, G, I, m and J are the Young's modulus, shear modulus, area moment of inertia, mass per unit length, and mass moment of inertia per unit length, respectively, ρ is the density and A the area. All these quantities are functions of space dimension x₁. Finally, κ is the shear factor.

The boundary conditions for Equation (105) are given by

Bᵢφ(xⱼ)=0 i=1,2 . . . ,p (108)

where Bᵢ is a differential operator of maximum order of 2p−1. Examples of clamped, pinned, and free boundary conditions for Euler-Bernoulli are given by:

$${B}_{i} = \{ \begin{matrix}1 \\ \frac{d}{d {x}_{1}}\end{matrix} \} \\ @ {x}_{1} = clamped \\ {B}_{i} = EI \{ \begin{matrix}1 \\ \frac{{d}^{2}}{d {x}_{1}^{2}}\end{matrix} \} \\ @ {x}_{1} = pinned \\ {B}_{i} = EI \{ \begin{matrix}\frac{{d}^{2}}{d {x}_{1}^{2}} \\ \frac{{d}^{3}}{d {x}_{1}^{3}}\end{matrix} \} \\ @ {x}_{1} = free \qquad ( 109 )$$

and for Timoshenko beam theory by:

$${B}_{i} = [ \begin{matrix}1 & 0 \\ 0 & 1\end{matrix} ] \\ @ {x}_{1} = clamped \\ {B}_{i} = [ \begin{matrix}1 & 0 \\ 0 & \frac{d}{d {x}_{1}}\end{matrix} ] \\ @ {x}_{1} = pinned \\ {B}_{i} = [ \begin{matrix}\frac{d}{d {x}_{1}} & - 1 \\ 0 & \frac{d}{d {x}_{1}}\end{matrix} ] \\ @ {x}_{1} = free \qquad ( 110 )$$

The damage model presented herein models the change in cross-sectional thickness at the damage location. If the damage depth is h_{d}(x₁), then at the damage location, the depth becomes h−h_{d}(x₁), where h is the constant depth at the undamaged location. Further a quantity h_{d} is defined to give the average depth of the damage, given by:

$${\overline{h}}_{d} = {\int }_{Ω} {h}_{d} ( {x}_{i} ) d {x}_{i} \qquad ( 111 )$$

where Ω gives the domain of damage. Therefore, the depth of the structure is given by:

$$h ( {x}_{i} ) = h - {\overline{h}}_{d} γ ( {x}_{i} ) = h [ 1 - ε γ ( {x}_{i} ) ] \\ ε = \frac{{\overline{h}}_{d}}{h} \qquad ( 112 )$$

where γ(xᵢ) is the damage profile function and c gives ratio of the depth of damage to the depth at the undamaged location.

For example, consider a beam of uniform rectangular cross-section of width b and depth h as shown in FIG. 1. A rectangular through-thickness notch-shaped damage is located at x=x_{d} with a width of Δl and depth of h_{d}. Notice in this case h̅_{d}=h_{d}. The damage profile function is given by:

h(x₁)=h− h̅_{d}[H(x₁−x_{1d})−H(x₁−x_{1d}−Δl)]=h[1−εγ(x₁)]

γ(x₁)=H(x₁−x_{1d})−H(x₁−x_{1d}−Δl) (113)

Here H(x−x₁) denotes the Heaviside function. Other representations of the crack profile functions of beams for different types of damage are given by:

For a V-shaped notch:

γ(x₁)= [symbol] x₁−x_{1d} [symbol] −2 [symbol] x₁−x_{1d}−Δl/2 [symbol] + [symbol] x₁−x_{1d}−Δl [symbol] (114)

where ( ) denotes ramp function. For a half V notch

γ(x₁)= [symbol] x₁−x_{1d} [symbol] −H(x₁−x_{1d}−Δl)+ [symbol] x₁−x_{1d}−Δl [symbol] (115)
For a saw-cut damage the definition of differentiation is used

γ(x₁)=H(x₁−x_{1d})−H(x₁−x_{1d}−Δl)=Δlδ(x₁−x_{1d}) (116)

Damage does not always occur in shapes giving regular profiles. In the cases where damage cannot be represented as a regular profile as listed above, a convolution integral is used to obtain the expressions for mode shapes and natural frequencies using the crack profile function of saw cut damage as described hereinafter.

The concept of damage profile functions may be applied to multi-dimensional structures and multi-dimensional damage. For a plate, the damage profile function defined for a sharp crack is given by:

$$\begin{matrix}γ ( {x}_{1} , {γ}_{1} ) = [ H ( {x}_{1} - {x}_{1 d} ) - H ( {x}_{1} - {x}_{1 d} - Δ {l}_{1} ) ] \\ [ H ( {y}_{1} - {y}_{1 d} ) - H ( {y}_{1} - {y}_{1 d} - Δ {l}_{2} ) ] \\ = Δ A δ ( {x}_{1} - {x}_{1 d} ) δ ( {y}_{1} - {y}_{1 d} )\end{matrix} \qquad ( 117 )$$

where Δlᵢ gives the width of the damage in the i^{th} direction.

Multiple types of damage may be tackled using this methodology by summing the different crack profile functions for individual points of damage to represent a consolidated crack profile function, as:

$$γ ( {x}_{j} ) = {\sum }_{i = 1}^{i = N} {γ}_{i} ( {x}_{j} ) \qquad ( 118 )$$

The change in the depth also manifests itself as changes in cross-sectional properties. The change in moment of inertia and cross-sectional area can be written as:

I(x)=I₀+εIₐ+ε²I_{b}+ε³I_{c}+ε⁴I_{d}A(x)=A₀+εAₐ+ε²A_{b} (119)

For example, for a rectangular beam the moment of inertia is given by:

$$I = \frac{{bh ( x )}^{3}}{12} = \frac{b {h}^{3}}{12} [ 1 - 3 ε γ ( x ) + 3 {ε}^{2} {γ ( x )}^{2} - {ε}^{3} {γ ( x )}^{3} ] \qquad ( 120 )$$

Comparing with Equation (119):

Iₐ=−3I₀γ(x)I_{b}=3I₀ε²γ(x)²I_{c}=−ε³γ(x)³I₀I_{d}=0 (121)

Based on the above explanation, the stiffness and mass operator are written as:

L=L₀+εL₁+ε²L₂+ε³L₃+ε⁴L₄

M=M₀+εM₁+ε²M₂+ε³M₃+ε⁴M₄ (122)

For example, the stiffness operator for Timoshenko beam theory can be written as:

$$( 123 )$$

$$L = [ \begin{matrix}- \frac{d κ G ( {A}_{0} + ε {A}_{1} + {ε}^{2} {A}_{2} ) d}{d {x}_{1}^{2}} & \frac{d κ G ( {A}_{0} + ε {A}_{1} + {ε}^{2} {A}_{2} ) d}{d {x}_{1}} \\ - \frac{κ G ( {A}_{0} + ε {A}_{1} + {ε}^{2} {A}_{2} ) d}{d {x}_{1}} & \begin{matrix}κ G ( {A}_{0} + ε {A}_{1} + {ε}^{2} {A}_{2} ) - \\ \frac{d E ( {I}_{0} + ε {I}_{1} + {ε}^{2} {I}_{2} + {ε}^{3} {I}_{3} + {ε}^{4} {I}_{4} ) d}{d {x}_{1}^{2}}\end{matrix}\end{matrix} ]$$

Comparing Equations (122) and (123):

$${L}_{0} = [ \begin{matrix}- \frac{d κ G {A}_{0} d}{d {x}_{1}^{2}} & \frac{d κ G {A}_{0} d}{d {x}_{1}} \\ - \frac{κ G {A}_{0} d}{d {x}_{1}} & κ G {A}_{0} - \frac{d E ( {I}_{0} ) d}{d {x}_{1}^{2}}\end{matrix} ] \\ {L}_{1} = [ \begin{matrix}- \frac{d κ G {A}_{1} d}{d {x}_{1}^{2}} & \frac{d κ G {A}_{1} d}{d {x}_{1}} \\ - \frac{κ G {A}_{1} d}{d {x}_{1}} & κ G {A}_{1} - \frac{d E ( {I}_{1} ) d}{d {x}_{1}^{2}}\end{matrix} ] \\ {L}_{2} = [ \begin{matrix}- \frac{d κ G {A}_{2} d}{d {x}_{1}^{2}} & \frac{d κ G {A}_{2} d}{d {x}_{1}} \\ - \frac{κ G {A}_{2} d}{d {x}_{1}} & κ G {A}_{2} - \frac{d E ( {I}_{2} ) d}{d {x}_{1}^{2}}\end{matrix} ] \\ {L}_{3} = [ \begin{matrix}0 & 0 \\ 0 & - \frac{d E ( {I}_{3} ) d}{d {x}_{1}^{2}}\end{matrix} ] \\ {L}_{4} = [ \begin{matrix}0 & 0 \\ 0 & - \frac{d E ( {I}_{4} ) d}{d {x}_{1}^{2}}\end{matrix} ] \qquad ( 124 )$$

In the above Equations, the subscript 0 is for the nominal quantities at an undamaged location.

As the quantity c is small, the function φ(x₁) and λ are expanded using perturbation theory as the following series:

φ(x₁)=φ(xᵢ)⁰+εφ(xᵢ)¹+ε²φ(xᵢ)²− . . . λ=λ⁰+ελ¹+ε²λ²− . . . (125)

The superscripts of φ and λ denote the order of perturbation.

The next step is non-dimensionalization, which identifies the number of parameters affecting the results. The contents of the Equations are non-dimensionalized using:

$${ζ}_{i} = \frac{{x}_{i}}{L} {u}_{{z}_{i}} = \frac{{u}_{i}}{L} {θ}_{{z}_{i}} = {θ}_{i} {γ}_{z} ( {ζ}_{i} ) = γ ( {x}_{i} ) \qquad ( 126 )$$

The subscript z is used for the dimensionless quantity.

Equations (122), (125) and (126) are substituted in Equation (105), and then they are non-dimensionalized to give the Equations of order 0, 1, 2 and 3 in ε as:

$$\begin{matrix} {ε}^{0} \text{:} {L}_{{z}_{0}} {φ}^{0} - {λ}_{z}^{0} {M}_{{z}_{0}} {φ}^{0} = 0 & ( 127 a ) \\ {ε}^{1} \text{:} {L}_{{z}_{0}} {φ}^{1} - {λ}_{z}^{0} {M}_{{z}_{0} } {φ}^{1} = {λ}_{z}^{1} {M}_{{z}_{0}} {φ}^{0} + {λ}_{z}^{0} {M}_{{z}_{1}} {φ}^{0} - {L}_{{z}_{1}} {φ}^{0} & ( 127 b ) \\ {ε}^{2} \text{:} {L}_{{z}_{0}} {φ}^{2} - {λ}_{z}^{0} {M}_{{z}_{0}} {φ}^{2} = {λ}_{z}^{2} {M}_{{z}_{0}} {φ}^{0} + {λ}_{z}^{1} M {z}_{1} {φ}^{0} + {λ}_{z}^{1} M {z}_{0} {φ}^{1} + {λ}_{z}^{0} M {z}_{2} {φ}^{0} + {λ}_{z}^{0} {M}_{{z}_{1}} {φ}^{1} - {L}_{{z}_{2}} {φ}^{0} - {L}_{{z}_{1}} {φ}^{1} & ( 127 c ) \\ {ε}^{3} \text{:} {L}_{{z}_{0}} {φ}^{3} - {λ}_{z}^{0} {M}_{{z}_{0}} {φ}^{3} = {λ}_{z}^{3} {M}_{{z}_{0}} {φ}^{0} + {λ}_{z}^{2} {M}_{{z}_{1}} {φ}^{0} + {λ}_{z}^{2} {M}_{{z}_{0}} {φ}^{1} + {λ}_{z}^{1} {M}_{{z}_{2}} {φ}^{0} + {λ}_{z}^{1} {M}_{{z}_{1}} {φ}^{1} + {λ}_{z}^{1} {M}_{{z}_{0}} {φ}^{2} + {λ}_{z}^{0} {M}_{{z}_{3}} {φ}^{0} + {λ}_{z}^{0} {M}_{{z}_{2}} {φ}^{1} + {λ}_{z}^{0} {M}_{{z}_{1}} {φ}^{2} - {L}_{{z}_{3}} {φ}^{0} - {L}_{{z}_{2}} {φ}^{1} - {L}_{{z}_{1}} {φ}^{2} & ( 127 d )\end{matrix}$$

For an Euler-Bernoulli beam, the symbols symbols L_{z}_{ₒ}, c, M_{z}_{₁}, L_{z}_{₁} and λ_{z}ⁱ represent the following:

$${L}_{{z}_{0}} = \frac{{d}^{4}}{d {ζ}_{1}^{4}} \\ {M}_{{z}_{0}} = 1 \\ {L}_{{z}_{1}} = \frac{{d}^{2}}{d {ζ}_{1}^{2}} 3 {γ}_{z} ( {ζ}_{1} ) \frac{{d}^{2}}{d {ζ}_{1}^{2}} \\ {M}_{{z}_{1}} = {γ}_{z} ( {ζ}_{1} ) \\ {λ}_{z}^{i} = \frac{m {λ}^{i} {L}^{4}}{E {I}_{3}} \qquad ( 128 )$$

and for Timoshenko beam theory their values are:

$${L}_{{z}_{0}} = [ \begin{matrix}- \frac{{d}^{2}}{d {ζ}_{1}^{2}} & \frac{d}{d {ζ}_{1}} \\ - \frac{d}{d {ζ}_{1}} & - {σ}^{2} e \frac{{d}^{2}}{d {ζ}_{1}^{2}} + 1\end{matrix} ] \\ {M}_{{z}_{0}} = [ \begin{matrix}{σ}^{2} e & 0 \\ 0 & {σ}^{1} e\end{matrix} ] \\ {L}_{{z}_{1}} = [ \begin{matrix}- \frac{d {γ}_{z} ( {ζ}_{1} ) d}{d {ζ}_{1}^{2}} & \frac{d {γ}_{z} ( {ζ}_{1} )}{d x} \\ - \frac{{γ}_{z} ( {ζ}_{1} ) d}{d {ζ}_{1}} & 3 {γ}_{z} ( {ζ}_{1} ) - \frac{d {σ}^{2} e {γ}_{z} ( {ζ}_{1} ) d}{d {ζ}_{1}^{2}}\end{matrix} ] \\ {M}_{{z}_{1}} = [ \begin{matrix}{σ}^{2} e {γ}_{z} ( {ζ}_{1} ) & 0 \\ 0 & 3 {σ}^{4} e {γ}_{z} ( {ζ}_{1} )\end{matrix} ] \\ e = \frac{E}{κ G} \\ {σ}^{2} = \frac{I}{A {L}^{2}} \\ {λ}_{z}^{i} = \frac{{ω}^{2} ρ {L}^{2}}{κ G} \qquad ( 129 )$$

The n^{th} term is compactly written as:

$${ε}^{n} \text{:} {L}_{{z}_{0}} {φ}^{n} - {λ}_{z}^{0} {M}_{{z}_{0}} {φ}^{n} = {λ}_{z}^{n} {M}_{{z}_{0}} {φ}^{0} + {\sum }_{j = 1}^{min ( n \vert \vert 4 )} ( {λ}_{z}^{0} {M}_{{z}_{j}} - L {z}_{j} ) {φ}^{n - j} + {\sum }_{i = 1}^{n - 1} {\sum }_{j = 0}^{min ( n - i \vert \vert 4 )} {λ}_{z}^{i} {M}_{{z}_{j}} {φ}^{n - i - j} \qquad ( 130 )$$

To use orthogonality, the M_{z}_{₀} and L_{z}_{₀} terms should be written separately. The above Equation is rewritten as:

$${ε}^{n} \text{:} {L}_{{z}_{0}} {φ}^{n} - {λ}_{z}^{0} {M}_{{z}_{0}} {φ}^{n} = {λ}_{z}^{n} {M}_{{z}_{0}} {φ}^{0} + {\sum }_{j = 1}^{min ( n \vert \vert 4 )} ( {λ}_{z}^{0} {M}_{{z}_{j}} - L {z}_{j} ) {φ}^{n - j} + {\sum }_{i = 1}^{n - 1} {λ}_{z}^{i} {M}_{{z}_{0}} {φ}^{n - i} + {\sum }_{i = 1}^{n - 1} {\sum }_{j = 1}^{min ( n - i \vert \vert 4 )} {λ}_{z}^{i} {M}_{{z}_{j}} {φ}^{n - i - j} \qquad ( 131 )$$

Equation (127a) is same as the eigenvalue problem for the undamaged elastic element, so the solution would be the same. Let the solution be given by S_{ud}(ζᵢ). For example, for an Euler-Bernoulli beam the solution is given by:

S_{ud}(ζ₁)=A cos aζ₁+B sin aζ₁+C sin haζ₁+D cos haζ₁ (132)

After applying the boundary conditions, the eigenvalue problem gives the mode shapes for the beam. Hence, the solution to the zeroth-order Equation is same as that for the undamaged beam given by

λ_{z}⁰=λ_{z}_{ₖ}⁰φ⁰(ζᵢ)=φₖ⁰(ζᵢ),n=1,2,3, . . . ,∞ (133)

Next, the Equations of orders higher than zero are solved. Because the solution of zeroth-order gives an infinite number of modes, all the Equations higher than zeroth-order will have one Equation for each mode. Equation (131) for the k^{th} mode number is given by:

$${ε}^{n} \text{:} {L}_{{z}_{0}} {φ}_{k}^{n} - {λ}_{{z}_{k}}^{0} {M}_{{z}_{0}} {φ}_{k}^{n} = {λ}_{{z}_{k}}^{n} {M}_{{z}_{0}} {φ}_{k}^{0} + {\sum }_{j = 1}^{min ( n \vert \vert 4 )} ( {λ}_{{z}_{k}}^{0} {M}_{{z}_{j}} - {L}_{{z}_{j}} ) {φ}_{k}^{n - j} + {\sum }_{i = 1}^{n - 1} {λ}_{{z}_{k}}^{i} {M}_{{z}_{0}} {φ}_{k}^{n - i} + {\sum }_{i = 1}^{n - 1} {\sum }_{j = 1}^{min ( n - i \vert \vert 4 )} {λ}_{{z}_{k}}^{i} {M}_{{z}_{j}} {φ}_{k}^{n - i - j} \qquad ( 134 )$$

The unknowns in the above Equation are φₖⁿ and λ_{zk}. The total solution for the above Equation consists of a homogeneous part and a particular integral part (φₖⁿ=φₖⁿ|_{homogeneous}+φₖⁿ|_{particular}). Again the above Equation, which is a representative Equation of a set of higher-order Equations, has the same left-hand side as Equation (127a), so the homogeneous part of the solution would be the same, i.e. S_{ud}(ζᵢ). To solve the particular integral part, the particular solution is represented as a summation of the undamaged orthogonal modes or the zeroth-order solution modes, using the expansion theorem, viz.:

$${φ}_{k}^{n} {\vert}_{particular} = {\sum }_{p = 1}^{∞} {η}_{kp}^{n} {φ}_{p}^{0} \qquad ( 135 )$$

Where ηₖₚⁿ is a constant. Thus, the unknowns are now ηₖₚⁿ, p=1, 2, . . . ∞ and λₖₚⁿ, and its solution for the first two orders is known. The solution for the first-order Equation is given by:

$${φ}_{k}^{1} = {φ}_{k}^{0} + {\sum }_{p = 1 , p \neq k}^{∞} {η}_{kp}^{1} {φ}_{p}^{0} \qquad ( 136 )$$

and that for the second-order Equation is given by:

$${φ}_{k}^{2} = {φ}_{k}^{0} + {\sum }_{p = 1 , p \neq k}^{∞} {η}_{kp}^{2} {φ}_{p}^{0} \qquad ( 137 )$$

Using deductive reasoning, the solution for the r^{th}-order Equation with r<n is:

$${φ}_{k}^{r} = {φ}_{k}^{0} + {\sum }_{p = 1 , p \neq k}^{∞} {η}_{kp}^{r} {φ}_{p}^{0} \qquad ( 138 )$$

Orthogonality of the undamaged modes is used to find the values of the unknowns. Equation (135) is premultiplied by (φₘ⁰(x))^{T} and integrated from ζᵢ=0 to ζᵢ=1 to yield:

$${ε}^{n} \text{:} {\int }_{ζ} {( {φ}_{m}^{0} )}^{T} {L}_{{z}_{0}} {\sum }_{p = 1}^{∞} {η}_{kp}^{n} {φ}_{p}^{0} - {λ}_{{z}_{k}}^{0} {\int }_{ζ} {( {φ}_{m}^{0} )}^{T} {M}_{{z}_{0}} {\sum }_{p = 1}^{∞} {η}_{kp}^{n} {φ}_{p}^{0} = {λ}_{{z}_{k}}^{n} {\int }_{ζ} {( {φ}_{m}^{0} )}^{T} {M}_{{z}_{0}} {φ}_{k}^{0} + {\sum }_{j = 1}^{min ( n \vert \vert 4 )} {\int }_{ζ} {( {φ}_{m}^{0} )}^{T} ( {λ}_{{z}_{k}}^{0} {M}_{{z}_{j}} - {L}_{{z}_{j}} ) ( {φ}_{k}^{0} + {\sum }_{p = 1 , p \neq k}^{∞} {η}_{kp}^{n - j} {φ}_{p}^{0} ) + {{\sum }_{i = 1}}^{n - 1} {λ}_{{z}_{k}}^{i} {\int }_{ζ} {( {φ}_{m}^{0} )}^{T} {M}_{{z}_{0}} ( {φ}_{k}^{0} + {\sum }_{p = 1 , p ≢ k}^{∞} {η}_{kp}^{n - i} {φ}_{p}^{0} ) + {{\sum }_{i = 1}}^{n - 1} {{\sum }_{j = 1}}^{min ( n - i \vert \vert 4 )} {λ}_{{z}_{k}}^{i} {\int }_{ζ} {( {φ}_{m}^{0} )}^{T} {M}_{{z}_{j}} ( {φ}_{k}^{0} + {\sum }_{p = 1 , p \neq k}^{∞} {η}_{kp}^{n - i - j} {φ}_{p}^{0} ) \qquad ( 139 )$$

Using orthogonality, the following simplifications can be made:

$${\int }_{ζ} {( {φ}_{m}^{0} )}^{T} {M}_{{z}_{0}} {φ}_{k}^{0} = {δ}_{mn} {C}_{m} = {δ}_{mn} {C}_{n} \\ {\int }_{ζ} {( {φ}_{m}^{0} )}^{T} {L}_{{z}_{0}} {φ}_{k}^{0} = {δ}_{mn} {λ}_{m} {C}_{m} = {δ}_{mn} {λ}_{n} {C}_{n} \qquad ( 140 )$$

where δₘₙ is the Kronecker delta. Notice no orthogonality condition holds for j>1. Also the following notation is used to represent the Equation in a compact manner:

$${\int }_{ζ} {( {φ}_{m}^{0} )}^{T} {L}_{{z}_{j}} {φ}_{k}^{0} = {α}_{{j}_{mn}} \\ {\int }_{ζ} {( {φ}_{m}^{0} )}^{T} {M}_{{z}_{j}} {φ}_{k}^{0} = {β}_{{j}_{mn}} \qquad ( 141 )$$

It can be shown at least for γ(ζᵢ)=Δl_{z}δ(ζᵢ−ζ_{di}) βⱼ_{ₘₙ}32 βⱼ_{ₙₘ} and αⱼ_{ₘₙ}=αⱼ_{ₙₘ}. Using the orthogonality condition of Equation (140) and the compact notation of Equation (141), Equation (139) can be rewritten as:

$${ε}^{n} \text{:} {η}_{km}^{n} ( {λ}_{{z}_{m}}^{0} - {λ}_{{z}_{k}}^{0} ) {C}_{m} = {λ}_{{z}_{k}}^{n} {δ}_{mk} {C}_{k} + {\sum }_{j = 1}^{min ( n \vert \vert 4 )} [ {λ}_{{z}_{k}}^{0} {β}_{{j}_{mk}} - {α}_{{j}_{mk}} + {{\sum }_{p = 1 , p \neq k}}^{∞} {η}_{kp}^{n - j} ( {λ}_{{z}_{k}}^{0} {β}_{{j}_{mp}} - {α}_{{j}_{mp}} ) ] + {\sum }_{i = 1}^{n - 1} {λ}_{{z}_{k}}^{i} ( {δ}_{mk} {C}_{k} + {\sum }_{p = 1 , p \neq k}^{∞} {η}_{kp}^{n - i} {δ}_{mp} {C}_{p} ) + {\sum }_{i = 1}^{n - 1} {\sum }_{j = 1}^{min ( n - i \vert \vert 4 )} {λ}_{{z}_{k}}^{i} ( {β}_{{j}_{mk}} + {{\sum }_{p = 1 , p \neq k}}^{∞} {η}_{kp}^{n - i - j} {β}_{{j}_{mp}} ) \qquad ( 142 )$$

The unknowns of this Equation can be found by using the conditions m=k and m≠k. For m=k, the left-hand side vanishes and the following expression is obtained for the λₖⁿ:

$${λ}_{{z}_{k}}^{n} = \frac{1}{{C}_{k}} \{ \begin{matrix}{\sum }_{j = 1}^{min ( n \vert \vert 4 )} [ {α}_{{j}_{kk}} - {λ}_{{z}_{k}}^{0} {β}_{{j}_{kk}} + {{\sum }_{p = 1 , p \neq k}}^{∞} {η}_{kp}^{n - j} ( {α}_{{j}_{kp}} - {λ}_{{z}_{k}}^{0} {β}_{{j}_{kp}} ) ] - \\ {\sum }_{i = 1}^{n - 1} {λ}_{{z}_{k}}^{i} {C}_{k} - {\sum }_{i = 1}^{n - 1} {\sum }_{j = 1}^{min ( n - i \vert \vert 4 )} {λ}_{{z}_{k}}^{i} ( {β}_{{j}_{kk}} - {{\sum }_{p = 1 , p \neq k}}^{∞} {η}_{kp}^{n - i - j} {β}_{{j}_{kp}} )\end{matrix} \} \qquad ( 143 )$$

and for m≠k the following expression is obtained for ηₖⁿ

$${η}_{km}^{n} = \frac{1}{( {λ}_{{z}_{m}}^{0} - {λ}_{{z}_{k}}^{0} ) {C}_{m}} \{ \begin{matrix}{\sum }_{j = 1}^{min ( n \vert \vert 4 )} [ {λ}_{{z}_{k}}^{0} {β}_{{j}_{mk}} - {α}_{{j}_{mk}} + {\sum }_{p = 1 , p \neq k}^{∞} {η}_{kp}^{n - j} ( {λ}_{{z}_{k}}^{0} {β}_{{j}_{mp}} - {α}_{{j}_{mp}} ) ] + \\ {\sum }_{i = 1}^{n - 1} {λ}_{{z}_{k}}^{i} ( {η}_{km}^{n - i} {C}_{m} ) + {\sum }_{i = 1}^{n - 1} {\sum }_{j = 1}^{min ( n - i \vert \vert 4 )} {λ}_{{z}_{k}}^{i} ( {β}_{{j}_{mk}} + {\sum }_{p = 1 , p \neq k}^{∞} {η}_{kp}^{n - i - j} {β}_{{j}_{mp}} )\end{matrix} \} \qquad ( 144 )$$

To complete the solution for mode shapes, the solution obtained up to now is given by:

$${φ}_{k}^{n} = {S}_{ud} ( {ζ}_{i} ) + {\sum }_{p = 1 , p \neq k}^{∞} {η}_{kp}^{n} {φ}_{p}^{0} + {η}_{kk}^{n} {φ}_{k}^{0} \qquad ( 145 )$$

Notice ηₖₖⁿ is incorrectly deduced to be zero by others. Instead, this constant at this stage is still undetermined. There are as many unknowns in S_{ud}(ζᵢ) as there are boundary conditions as shown in the example expression given for an Euler-Bernoulli beam, Equation (132). The ηₖₖⁿ simply combines with those constants. The final solution after applying the boundary conditions is given by:

$${φ}_{k}^{n} = {φ}_{k}^{0} + {\sum }_{p = 1 , p \neq k}^{∞} {η}_{kp}^{n} {φ}_{p}^{0} \qquad ( 146 )$$

The solution has the mode shapes of the undamaged beam as one of the parts because of the unique choice of the particular solution. The particular solution independently already satisfied the boundary conditions. The final solution for the mode shapes and natural frequencies of the damaged structure is determined by using Equation (125).

To determine the mode shapes and natural frequencies for an arbitrary damage profile, first the modes shapes and natural frequencies are determined using a sharp damage modeled using a delta function γ_{z} (ζᵢ)=δ(ζᵢ−ζ_{di}). Let the eigenfunction (mode shape) and the eigenvalue (which can be used to determine the natural frequency) be determined using a damage profile φ_{δ}_{ₖ} (ζi) and λ_{δ}_{ₖ} respectively. A convolution integral in space domain is used to determine mode shapes and natural frequencies for any arbitrary damage profile. The final expressions are given by:

φₖ(ζᵢ)=∫_{Ω}φ_{δ}_{ₖ}(ζᵢ−ζ_{d}_{ᵢ})γ(ζ_{d}_{ᵢ})dζ_{d}_{ᵢ}

λₖ=∫_{Ω}λ_{δ}_{ₖ}γ(ζ_{d}_{ᵢ})dζ_{d}_{ᵢ} (147)

where ζ_{d} is the spatial location of the damage. For multiple damage locations, the damage profile function for multiple areas of damage given by Equation (118) is used:

$$φ ( {ζ}_{i} ) = {\sum }_{j = 1}^{p} {\int }_{{Ω}_{j}} {φ}_{{δ}_{k}} ( {ζ}_{i} - {ζ}_{{d}_{i}} ) γ ( {ζ}_{{d}_{i}} ) d {ζ}_{{d}_{i}} \\ {λ}_{k} = {\sum }_{j = 1}^{p} {\int }_{{Ω}_{j}} {λ}_{{δ}_{k}} γ ( {ζ}_{{d}_{i}} ) d {ζ}_{{d}_{i}} \qquad ( 148 )$$

The subscript j denotes the damage number iterator, and number p denotes the total number of independent damage locations. Although the natural frequency does not depend on the spatial variable ζᵢ, it still can be determined in the same way.

To verify the correctness of the expression, the first-order correction is compared against the ones derived for Euler-Bernoulli beams and for Timoshenko beams. They were found to be the same:

$${λ}_{{z}_{n}}^{1} = \frac{{α}_{nn} - {λ}_{{z}_{n}}^{0} {β}_{nn}}{{μ}_{nn}} {η}_{nj}^{1} = \frac{{λ}_{{z}_{k}}^{0} {β}_{nj} - {α}_{nj}}{( {λ}_{{z}_{j}}^{0} - {λ}_{{z}_{n}}^{0} ) {μ}_{jj}} \qquad ( 149 )$$

The second-order correction quantities are obtained as solution to (127c)

$$\begin{matrix}{λ}_{{z}_{n}}^{2} = \frac{{α}_{1 nn} - {λ}_{{z}_{n}}^{1} {β}_{1 nn} - {λ}_{{z}_{n}}^{0} {β}_{1 nn}}{{C}_{n}} & ( 150 ) \\ {η}_{nj}^{2} = \frac{\begin{matrix}{λ}_{{z}_{n}}^{1} {β}_{{1}_{nj}} + {λ}_{{z}_{n}}^{1} {η}_{nj}^{1} {C}_{j} {λ}_{{z}_{n}}^{0} {β}_{{1}_{nj}} + \\ {λ}_{{z}_{n}}^{0} {{\sum }_{l = 1 , l \neq n}}^{∞} {η}_{nj}^{1} {β}_{{1}_{nj}} - {α}_{{1}_{nj}} - {{\sum }_{l = 1 , l \neq n}}^{∞} {η}_{nj}^{1} {α}_{{1}_{nj}}\end{matrix}}{{C}_{j} ( {λ}_{zj}^{0} - {λ}_{{z}_{n}}^{0} )} & ( 151 )\end{matrix}$$

The details of the constants involved for the rectangular beam with a rectangular notch have been given. The details for a similar development for the T-beam are given below. The dimensions of the T-beam are given by b₂=4d, b₁=d, h₂=d, h₂=4d, where the subscript 2 denotes the values for the flange, and the subscript 1, those for the web. To have the same cross-sectional area or mass as the rectangular beam, d=0.05 m. The damage is located at the same place as the rectangular beam i.e. at 0.3 L. The mass loss due to the damage is also kept the same as in the rectangular beam. For that, the width of the damage is reduced to 0.02 m and the depth is kept same as 0.04 m. Therefore, the only quantity different in a T-beam is the moment of inertia, which is calculated as:

$$I ( {x}_{1} ) = \frac{{b}_{2} {h}_{2}^{3} ( {x}_{1} )}{12} + {b}_{2} {h}_{2} ( {x}_{1} ) {d}_{2}^{2} ( {x}_{1} ) + \frac{{b}_{1} {h}_{1}^{3}}{12} + {b}_{1} {h}_{1} {d}_{1}^{2} ( {x}_{1} ) \qquad ( 152 )$$

where d₁ and d₂ are distances of the centroid of web and the flange, respectively from the centroid of the section. Notice, only h₂ is a function of x₁, h₁ is independent of x₁. h₂(x₁) is similar to h(x₁) given in Equation (113).

$$\begin{matrix}{h}_{2} ( {x}_{1} ) = {h}_{2} - {\overline{h}}_{d} [ H ( {x}_{1} - {x}_{1 d} ) - H ( {x}_{1} - {x}_{1 d} - Δ l ) ] \\ = {h}_{2} [ 1 - ε {f}_{1} γ ( {x}_{1} ) ]\end{matrix} \\ γ ( {x}_{1} ) = H ( {x}_{1} - {x}_{1 d} ) - H ( {x}_{1} - {x}_{1 d} - Δ l ) \\ {f}_{1} = \frac{{h}_{1} + {h}_{2}}{{h}_{2}} \qquad ( 153 )$$

The factor f₁ is introduced to keep the same meaning for the factor that gives the ratio of the depth of the damage to the total depth of the beam c. Based on the values given, f₁=5. The location of the neutral axis from the top edge of the flange is given by:

$${y}_{c} ( {x}_{1} ) = \frac{{b}_{2} {h}_{2} ( {x}_{1} ) x {h}_{2} ( {x}_{1} ) / 2 + {b}_{1} {h}_{1} x [ {h}_{1} + {h}_{2} ( {x}_{1} ) ] / 2}{{b}_{2} {h}_{2} ( {x}_{1} ) + {b}_{1} {h}_{1}} \qquad ( 154 )$$

The distance of neutral axis from the centroid of the flange and web are calculated next:

$$\begin{matrix}{d}_{2} ( {x}_{1} ) = {y}_{c} ( {x}_{1} ) - {h}_{2} ( {x}_{1} ) / 2 = {d}_{2} \frac{1 - ε {f}_{3} γ ( {x}_{1} )}{1 - ε {f}_{2} γ ( {x}_{1} )} \\ {d}_{2} = \frac{{b}_{1} {h}_{1} ( {h}_{1} + {h}_{2} )}{2 ( {b}_{1} {h}_{1} + {b}_{2} {h}_{2} )} \\ {f}_{2} = \frac{{b}_{2} ( {h}_{1} + {h}_{2} )}{{b}_{1} {h}_{1} + {b}_{2} {h}_{2}} = 2.5 \\ {f}_{3} = 1 & ( 155 ) \\ \begin{matrix}{d}_{1} ( {x}_{1} ) = {h}_{1} + {h}_{2} ( {x}_{1} ) - {y}_{c} ( {x}_{1} ) - \frac{{h}_{1}}{2} \\ = {d}_{1} \frac{[ 1 - ε {f}_{3} γ ( {x}_{1} ) ] [ 1 - ε {f}_{1} γ ( {x}_{1} ) ]}{1 - ε {f}_{2} γ ( {x}_{1} )}\end{matrix} \\ {d}_{1} = \frac{{b}_{2} {h}_{2} ( {h}_{1} + {h}_{2} )}{2 ( {b}_{1} {h}_{1} + {b}_{2} {h}_{2} )} & ( 156 )\end{matrix}$$

Substituting the expressions of h₂(x₁), d₁(x₁) and d₂(x₁) from Equations (153), (155) and (156) into the Equation of the sectional area moment of inertia, the following expression is obtained:

$$I ( {x}_{1} ) = \frac{{b}_{2} {{h}_{2}^{3} [ 1 - ε {f}_{1} γ ( {x}_{1} ) ]}^{3}}{12} + {b}_{2} {h}_{2} [ 1 - ε {f}_{1} γ ( {x}_{1} ) ] {{d}_{2}^{2} [ \frac{[ 1 - ε {f}_{3} γ ( {x}_{1} ) ]}{[ 1 - ε {f}_{2} γ ( {x}_{1} ) ]} ]}^{2} + \frac{{b}_{1} {h}_{1}^{3}}{12} + {b}_{1} {h}_{1} {d}_{1}^{2} {\{ \frac{[ 1 - ε {f}_{3} γ ( {x}_{1} ) ] [ 1 - ε {f}_{1} γ ( {x}_{1} ) ]}{[ 1 - ε {f}_{2} γ ( {x}_{1} ) ]} \}}^{2} \qquad ( 157 )$$

Expanding the above expressions binomially, the following expressions are obtained:

$$I ( {x}_{1} ) = \frac{{b}_{2} {h}_{2}^{3}}{12} + {b}_{2} {h}_{2} {d}_{2}^{2} + \frac{{b}_{1} {h}_{1}^{3}}{12} + {b}_{1} {h}_{1} {d}_{1}^{2} - ε γ ( {x}_{1} ) \{ \begin{matrix}\frac{{b}_{2} {h}_{2}^{3} [ 3 ε {f}_{1} γ ( {x}_{1} ) ]}{12} + {b}_{2} {h}_{2} {d}_{2}^{2} ( 2 {f}_{3} + {f}_{1} - 2 {f}_{2} ) + \\ {b}_{1} {h}_{1} {d}_{1}^{2} ( 2 {f}_{3} + 2 {f}_{1} - 2 {f}_{2} )\end{matrix} \} \qquad ( 158 )$$

Comparing the above Equation with Equation (119), the following values are obtained for the T-beam:

Iₐ=−f_{L}I₀γ(x)I₀=18.167d^{A}I₁=61.25d⁴f_{L}=3.372 (159)

Similar method is used to obtain the values for the area

Aₐ=−fₘA₀γ(x)A₀=4d²A₁=f₂A₀fₘ=2.5 (160)

As is shown, the ability of the theory to correctly predict the results for a damaged beam using Euler-Bernoulli and Timoshenko beam theory is ascertained. A finite element model of the beam was constructed using ABAQUS™ with both simply-supported and clamped-free end conditions. For the rectangular beam, the constants involved were E=62.1 GPa, G=23.3 GPa, K=5/6, L=3 m, h=0.2 m, b=0.1 m, x_{d}=0.3 L, k=9, ΔL_{z}=0.04/3, p=2700 Kg/m³, and ε=0.2 h. The beam was modeled with plane stress elements of size 0.02 m, the material constant Poisson's ratio was v=0.33. The results for the simply-supported end condition are presented in TABLE 2 and those for clamped-free beam in TABLE 3. The two end conditions collectively simulated the symmetric and asymmetric cases.

TABLE 2

| | FE-Model | | Analytical, EB | | Analytical, TB | |
|---|---|---|---|---|---|---|
| Mode | U | D | U | D | U | D |
| 1 | 47.97 | 46.58 | 48.33 | 46.78 | 47.96 | 46.45 |
| 2 | 187.88 | 181.29 | 193.30 | 184.72 | 187.28 | 179.85 |
| 3 | 409.13 | 406.53 | 434.93 | 432.94 | 408.23 | 406.48 |
| 4 | 697.77 | 687.66 | 773.22 | 760.29 | 695.27 | 685.69 |

TABLE 2 presents a frequency comparison (Hz): Simply supported beam σ=3.70×104, e=3.2, ε=0.2, ΔL_{z}=0.04/3 (values which vary more than 5% are given in bold). D-Damaged, U-Undamaged.

TABLE 3

| | FE-Model | | Analytical, EB | | Analytical, TB | |
|---|---|---|---|---|---|---|
| Mode | U | D | U | D | U | D |
| 1 | 17.17 | 16.61 | 17.21 | 16.34 | 17.15 | 16.29 |
| 2 | 105.43 | 104.24 | 107.89 | 107.76 | 105.28 | 105.13 |
| 3 | 286.29 | 277.20 | 302.10 | 291.4 | 285.61 | 277.07 |
| 4 | 538.50 | 532.23 | 591.99 | 583.82 | 536.60 | 532.05 |

TABLE 3 presents a frequency comparison (Hz): Clamped-Free beam σ=3.70×10⁻⁴, e=3.2, ε=0.2, ΔL_{z}=0.04/3 (values which vary more than 5% are given in bold). D-Damaged, U-Undamaged.

The maximum percentage difference between the values of the finite element model results and those using the present unified framework using first-order correction to natural frequencies for Timoshenko beam theory was about 1% for both clamped-free and simply-supported beams. Euler-Bernoulli beam theory results were accurate for only the first two natural frequencies.

TABLE 4

| | FE-Model | | Analytical, EB | | Analytical, TB | |
|---|---|---|---|---|---|---|
| Mode | U | D | U | D | U | D |
| 1 | 62.46 | 61.80 | 63.08 | 62.04 | 62.27 | 61.29 |
| 2 | 237.80 | 231.86 | 252.31 | 246.53 | 240.26 | 235.87 |
| 3 | 498.23 | 487.83 | 567.70 | 566.34 | 512.46 | 508.83 |
| 4 | 814.56 | 808.55 | 1009.3 | 1000.7 | 854.27 | 846.18 |

TABLE 4 presents a frequency comparison (Hz): Simply supported beam σ=6.31×10⁻⁴, e=3.2, ε=0.16, ΔL_{Z}=0.02/3 (values which vary more than 5% are given in bold). D-Damaged, U-Undamaged.

The next results are presented for the T-beam. The material constants are kept same as the rectangular beam. The area too is kept constant by keeping b₁=0.05 m, h₁=0.2 m, h₂=0.05 m, b₂=0.2 m and is equal to 0.02 m², k=27. The moment of inertia changed to 1.1354 m⁴. For the T-beam, three-dimensional brick elements were used, the size of the seeds were 0.05 m, with the flange having four seeds. Hexahedral elements were used for the undamaged beam. For the damaged beam, the quality of hexahedral mesh was not good, therefore tetrahedral elements were used. The global seed size was 0.025. The number of seeds for the flanges and along the notch depth was increased to four. There was also an additional seed provided along the notch thickness. The frequency values are presented in TABLE 4. It is seen that the rectangular beam frequency results are more accurately predicted by an Euler-Bernoulli beam theory (first natural frequency) and Timoshenko beam theory, than that for T-beam. The same trend holds for the present unified framework, i.e. T-beam frequency results are predicted less accurately than rectangular beam.

TABLE 5

| | FE-Model | | Analytical, EB | | Analytical, TB | |
|---|---|---|---|---|---|---|
| Mode | U | D | U | D | U | D |
| 1 | 22.10 | 21.75 | 22.47 | 21.96 | 22.33 | 20.84 |
| 2 | 131.88 | 134.66 | 140.83 | 143.66 | 135.16 | 137.67 |
| 3 | 344.82 | 348.81 | 394.32 | 393.71 | 359.83 | 362.82 |
| 4 | 620.61 | 625.51 | 772.70 | 769.95 | 661.33 | 660.00 |

TABLE 5 presents a frequency comparison (Hz): Clamped-Free beam σ=6.31×10⁻⁴, e=3.2, ε=0.16, ΔL_{Z}=0.04/3 (values which vary more than 5% are given in bold). D-Damaged, U-Undamaged.

In TABLES 6 and 7, frequencies are presented for both undamaged and damaged beams and for both the T-beam and the rectangular beam. In these same tables, the ratio of the frequencies for the undamaged beams to damaged beams is also provided. Since the only difference between the two beams as far as one-dimensional beam theories (Timoshenko beam theory and Euler-Bernoulli beam theory) are concerned is the area moment of inertia, it is therefore aimed to verify how the change in the moment of inertia alone affects the change in frequency by studying the ratio.

TABLE 6

| | FE-Model (r) | | FE-Model (t) | | Ratios | | | |
|---|---|---|---|---|---|---|---|---|
| Mode | ƒᵤᵣ | ƒ_{dr} | ƒᵤₜ | ƒ_{dt} | ƒᵤₜ/ƒᵤᵣ | ƒ_{dt/}ƒ_{dr} | ƒᵤᵣ/ƒ_{dr} | ƒᵤₜ/ƒ_{dt} |
| 1 | 47.97 | 46.58 | 62.46 | 61.79 | 1.30 | 1.33 | 1.011 | 1.030 |
| 2 | 187.88 | 181.29 | 237.78 | 231.86 | 1.27 | 1.28 | 1.026 | 1.036 |
| 3 | 409.13 | 406.53 | 498.14 | 487.83 | 1.22 | 1.20 | 1.021 | 1.006 |
| 4 | 697.77 | 687.66 | 814.34 | 808.55 | 1.17 | 1.18 | 1.007 | 1.015 |

TABLE 6 presents frequencies (Hz) and frequency ratios: Simply supported beam e=3.2, ε=0.2. Rectangular beam (r) σ=3.70×10⁻⁴, ΔL_{Z}=0.04/3, T-beam (t) σ=6.31×10⁻⁴, ΔL_{Z}=0.02/3 (d-Damaged, u-Undamaged)

TABLE 7

| | FE-Model (r) | | FE-Model (t) | | Ratios | | | |
|---|---|---|---|---|---|---|---|---|
| Mode | ƒᵤᵣ | ƒ_{dr} | ƒᵤₜ | ƒ_{dt} | ƒᵤₜ/ƒᵤᵣ | ƒ_{dt/}ƒ_{dr} | ƒᵤᵣ/ƒ_{dr} | ƒᵤₜ/ƒ_{dt} |
| 1 | 17.17 | 16.61 | 22.10 | 21.75 | 1.29 | 1.31 | 1.034 | 1.016 |
| 2 | 105.43 | 104.24 | 131.88 | 134.66 | 1.25 | 1.28 | 1.011 | 0.979 |
| 3 | 286.29 | 277.20 | 344.82 | 348.81 | 1.20 | 1.26 | 1.033 | 0.989 |
| 4 | 538.50 | 532.23 | 620.61 | 625.51 | 1.15 | 1.18 | 1.012 | 0.992 |

TABLE 7 presents frequencies (Hz) and frequency ratios: Clamped-free beam e=3.2, ε=0.2. Rectangular beam (r) σ=3.70×10⁻⁴, ΔL_{Z}=0.04/3, T-beam (t) σ=6.31×10⁻⁴, ΔL_{Z}=0.02/3 (d-Damaged, u-Undamaged).

According to Euler-Bernoulli beam theory the natural frequency is given by

$$f = \frac{1}{2 π} \sqrt{\frac{λ EI}{ρ {AL}^{4}}} ,$$

therefore for two beams (T-beam and rectangular beam), the frequencies should be in the ratio of the area moment of inertias. Therefore, fᵤₜ/f_{uf}=\sqrt{Iₜ/Iᵣ}=1.31. The ratio given in the tables above have this ratio only for the fundamental natural frequency. It is therefore deduced that Euler-Bernoulli beam theory gives useful results only for the first natural frequency.

It is also seen that the ratio of the frequencies for the T-beam and the rectangular beam decreases as the mode number increases. See, columns 5 and 6 of TABLES 6 and 7. This trend is same for both undamaged and damaged beams. Since only the moment of inertia is changed between the two beams, (the rest of the constants are kept the same), it is therefore inferred that the area moment of inertia change affects higher frequencies less than the lower frequencies. This deduction holds for both damaged and undamaged cases. However, the ratio is higher for the damaged case compared to the undamaged case; therefore, it can be surmised that the natural frequency of a damaged beam is affected more by change of moment of inertia as compared to that of an undamaged beam.

In the same columns (columns 5 and 6 of TABLES 6 and 7), it is noted that the values in the column for ratio of damaged beam frequencies is higher than that for undamaged beam frequencies, and that the rate of decrease of the ratio of frequencies for damaged beams is same as that for undamaged beams. The rate is based on the difference between the rows for the two columns mentioned above. It is therefore inferred that the decrease is lower for damaged cases than undamaged case, though the rate of decrease is about the same.

Another important deduction is based on the last column of TABLE 7. It shows that for the T-beam, the damaged beam frequency increases for the damaged case for the clamped-free beam. The natural frequency is the ratio of stiffness and the mass. Conventional research considered only the decrease in stiffness due to the damage. This result shows the importance of considering the decrease in mass due to damage too, because if only stiffness decrease is considered, capturing the increase in frequency of the damaged beam would not be possible. The results for the analytical model given in TABLE 5 corroborate this result. This validates the use of the unified framework disclosed above to estimate the natural frequencies of damaged beams.

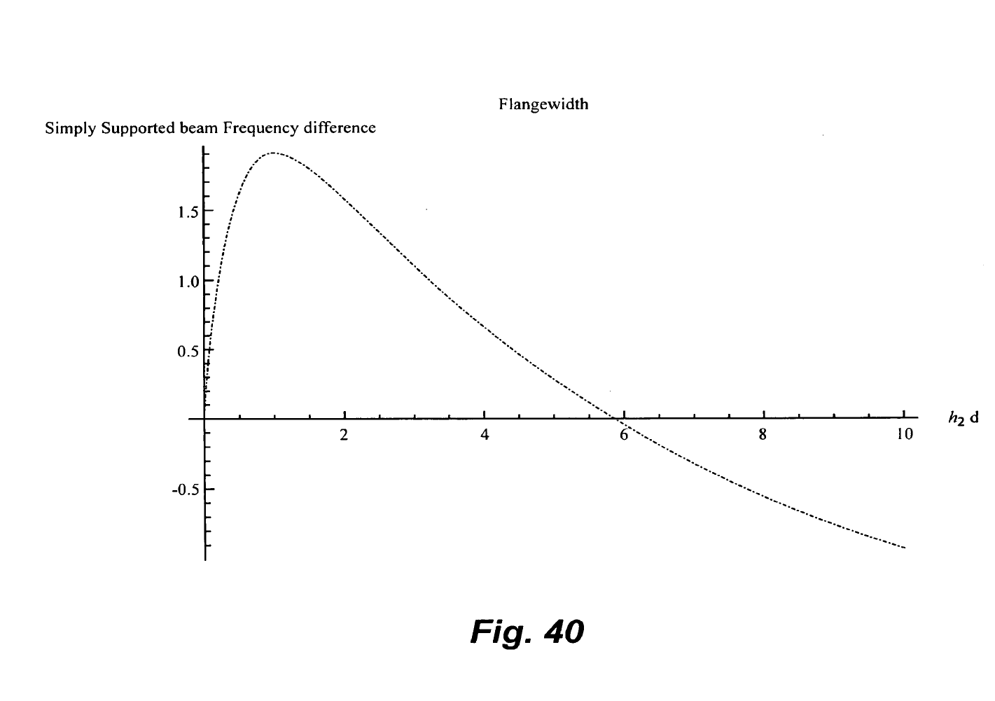

Since the natural frequencies may increase or decrease due to damage, as discussed above, this implies that a suitable choice of structure may result in natural frequencies not changing at all as a result of damage. For example, in FIG. 40, a method to calculate a beam with beneficial dimensions is shown. The flange width of the section of the T-beam is considered, and made a variable (b₂=κd). The plot shows the frequency difference between the damaged and undamaged beam.

For κ=5.84 the difference is zero. On the other hand, at κ=1.1 the change in frequency is maximum between the damaged and undamaged case.

These results were verified using ABAQUS™. Similarly, other parameters may also be varied to find a beam that will have maximal or minimal change due to a discontinuity.

Further, since the mode shape and curvature shape of long slender beams for the simply-supported boundary condition are the same, as predicted by Euler-Bernoulli beam theory, the proper choice of cross-section may result in none of the natural frequencies showing significant changes as a result of the damage (located anywhere throughout the beam).

It is seen that frequency results for rectangular beams are more accurately predicted than for T-beams, regardless of whether one uses an Euler-Bernoulli beam theory (which accurately picks up only the first natural frequency) or the Timoshenko beam theory. The same trend holds for the present unified framework.

Euler-Bernoulli beam theory gives useful results only for the first natural frequency, since only for this case, the ratio of the frequencies for the T-beam and rectangular beam are the same as that predicted by the theory.

A change in the area moment of inertia affects higher frequencies less than it does lower frequencies for both damaged and undamaged beams. The natural frequencies of a damaged beam are affected more by a change in moment of inertia than they are for an undamaged beam. The decrease is less for the damaged case than for the undamaged case, although the relative amount of the decrease is about the same.

The local decrease in mass per unit length as a result of the damage is an important effect, and should not be neglected. It is important because natural frequencies may increase as a result of the damage, which is predictable only if the decrease in mass is considered in the calculation. Results based on the present unified framework corroborate this, and thus provide verification that the present unified framework accurately estimates the natural frequencies of damaged beams.

An important conclusion of the present invention is that a suitable choice of structure may result in natural frequencies that do not change as a result of damage. This result has important ramifications for the simply-supported case, because Euler-Bernoulli beam theory predicts both displacement and curvature mode shapes to be the same. Therefore, proper choice of cross-section may result in none of the natural frequencies showing any changes as a result of damage or even addition of mass.

Thus, in a preferred embodiment of the investigation of the effect of damage shape and beam shape using a unified framework, a process of designing a desired structure without damage with desired modes shapes and natural frequencies when related to the structure modeled as having damage is disclosed, the process comprising, modeling a structure with damage to obtain the modes shapes and natural frequencies of the structure with damage, the modeling process comprising providing the physical characteristics of the structure, providing the modes shapes and natural frequencies of the structure without damage, perturbing the modes shapes and natural frequencies of the structure without damage based on characteristics of the damage, calculating nth-order, perturbed differential equations governing the modes shapes and natural frequencies of the structure with damage, wherein n is 1 or greater, and solving the perturbed differential equations to obtain the modes shapes and natural frequencies of the structure with damage, altering the modes shapes and natural frequencies of the structure with damage with reference to the physical characteristics of the structure, and obtaining the desired structure with desired modes shapes and natural frequencies when related to the structure having damage.

Obtaining the desired structure with desired modes shapes and natural frequencies when related to the structure having damage does not need to utilize the physical properties of the damage.

Altering the modes shapes and natural frequencies of the structure with damage with reference to the physical characteristics of the structure can be the equivalization of the modes shapes and natural frequencies of the desired structure with the modes shapes and natural frequencies of the structure with damage.

Altering the modes shapes and natural frequencies of the structure with damage with reference to the physical characteristics of the structure can be enhancing the modes shapes and natural frequencies of the desired structure with reference to the modes shapes and natural frequencies of the structure with damage.

Altering the modes shapes and natural frequencies of the structure with damage with reference to the physical characteristics of the element can be diminishing the modes shapes and natural frequencies of the desired structure with reference to the modes shapes and natural frequencies of the structure with damage.

The physical characteristics of the structure comprise one or more of spatial, geometric and material characteristics of the structure.

The structure comprises more than one location of damage.

Embodiments of the present invention can be utilized in an a computing environment and computer systems thereof. The computing environment and computer systems represent only one example of a suitable computing environment and computer systems for the practice of the present invention and are not intended to suggest any limitation as to the scope of use or functionality of the invention. Nor should the computer systems be interpreted as having any dependency or requirement relating to any one or combination of components disclosed hereinafter.

Hence, it should be understood that the present invention is operational with numerous other general purpose or special purpose computing system environments or configurations. Examples of well-known communication devices, computing systems, environments, and/or configurations that may be appropriate or suitable for use with the present invention include, but are not limited to, personal computers, server computers, hand-held or laptop devices, multiprocessor systems, microprocessor-based systems, set top boxes, programmable consumer electronics, network personal computers, minicomputers, mainframe computers, distributed computing environments that include any of the above systems or devices, and the like.

The present invention may also be described in the general context of comprising computer-executable instructions, such as program modules, being executed by a computer system. Generally, program modules include routines, programs, programming, objects, components, data, and/or data structures that perform particular tasks or implement particular abstract data types. The present invention may be practiced in distributed computing environments where tasks are performed by remote processing devices that are linked through a communications network. In a distributed computing environment, program modules may be located in both local and remote computer storage media, including, without limitation, in memory storage devices.

An exemplary computing environment of the present invention includes a general purpose computing device in the form of a computer system. Components of computer system may include, but are not limited to, a processing unit, a system memory, and a system bus that couples various system components including the system memory to the processing unit for bi-directional data and/or instruction communication. The system bus may be any of several types of bus structures including a memory bus or memory controller, a peripheral bus, and a local bus using any of a variety of bus architectures. By way of example, and not limitation, such architectures include the Industry Standard Architecture (USA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

The computer system typically includes a variety of computer-readable media. Computer-readable media may comprise any available media that may be accessed by, read from, or written to by computer system, and may include both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data, data structures, program modules, programs, programming, or routines. Computer storage media includes, but is not limited to, RAM, ROM, EEPROM, flash memory or other memory technology, CD-ROM, digital versatile disks (DVD) or other optical disk storage, magnetic cassettes, magnetic tape, magneto-optical storage devices, magnetic disk storage or other magnetic storage devices, or any other medium which may be used to store the desired information and which may be accessed by the computer system. Communication media typically embodies computer-readable instructions, data, data structures, program modules, programs, programming, or routines in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer-readable media.

The system memory includes computer storage media in the form of volatile and/or nonvolatile memory such as read only memory (ROM) and random access memory (RAM). A basic input/output system (BIOS), containing the basic routines that direct the transfer of information between elements within computer, such as during start-up, is typically stored in ROM. RAM typically stores data and/or program instructions that are immediately accessible to and/or presently being operated on by the processing unit. By way of example, and not limitation, the operating system, application programs, other program modules, and program data may be resident in RAM, in whole or in part, from time-to-time.

The computer may also include other removable/non-removable, volatile/nonvolatile computer storage media. By way of example only, they can include a hard disk drive that reads from or writes to non-removable, nonvolatile magnetic media, a magnetic disk drive that reads from or writes to a removable, a nonvolatile magnetic disk, and an optical disk drive that reads from or writes to a removable, nonvolatile optical disk such as a CD ROM or other optical media. Other removable/non-removable, volatile/nonvolatile computer storage media that may be included in the exemplary computing environment include, but are not limited to, magnetic tape cassettes, flash memory cards, digital versatile disks, digital video tape, solid state RAM, solid state ROM, and the like. The hard disk drive is typically connected to the system bus through a non-removable memory interface such as interface, and the magnetic disk drive and optical disk drive are typically connected to the system bus by a removable memory interface.

The drives and their associated computer storage media described above provide storage of computer-readable instructions, data, data structures, program modules, programs, programming, or routines for the computer system. For example, the hard disk drive can store an operating system, application programs, other program modules, and program data. A user may enter commands and information into the computer system through connected input devices such as a keyboard and pointing device, commonly referred to as a mouse, trackball or touch pad. Other connected input devices may include a microphone, joystick, game pad, satellite dish, scanner, or the like. These and other input devices are often connected to the processing unit through a user input interface that is coupled to the system bus, but may be connected by other interface and bus structures, such as a parallel port, game port or a universal serial bus (USB). A monitor or other type of display device is also connected to the system bus via an interface, such as a video interface. In addition to the monitor, the computer system may also include other peripheral output devices such as speakers and printer, which may be connected through an output peripheral interface.

The computer system may operate in a networked environment using bi-directional communication connection links to one or more remote computer systems, such as a remote computer system. The remote computer system may be a personal computer, a laptop computer, a server computer, a router, a network PC, a peer device or other common network node, and typically includes many or all of the elements described above relative to the computer system. The bi-directional communication connection links can include a local area network (LAN) and a wide area network (WAN), but may also include other networks. Such networks are commonplace in offices, enterprise-wide computer networks, intranets and the Internet.

When communicatively connected to a LAN, the computer system connects to the LAN through a network interface or adapter. When communicatively connected to a WAN, the computer system typically includes a modem or other means for establishing a communication link over the WAN, such as the Internet. The modem, which may be internal or external, may be connected to the system bus via the user input interface, or other appropriate mechanism. In a networked environment, program modules may be stored in the remote memory storage device. By way of example, and not limitation, application programs may reside in the memory storage device. It will be appreciated that the described network connections are exemplary and other means of establishing a bi-directional communication link between the computers may be used.

While the invention has been disclosed in its preferred forms, it will be apparent to those skilled in the art that many modifications, additions, and deletions can be made therein without departing from the spirit and scope of the invention and its equivalents, as set forth in the following claims.

1. A process of modeling an element with a discontinuity to obtain one or more vibrational characteristics of the element with the discontinuity, the process comprising:
providing the physical characteristics of the element;
providing one or more vibrational characteristics of the element without the discontinuity;
perturbing one or more vibrational characteristics of the element without the discontinuity based on characteristics of the discontinuity;
calculating nth-order, perturbed differential equations governing one or more vibrational characteristics of the element with the discontinuity, wherein n is 1 or greater; and
solving the perturbed differential equations to obtain one or more vibrational characteristics of the element with the discontinuity.

2. The process of claim 1, wherein the physical characteristics of the element comprise one or more of geometric and material characteristics of the element.

3. The process of claim 1, wherein the vibrational characteristics comprise one or more of mode shapes, natural frequencies, displacements, section-rotations, shears, moments, stresses and strains.

4. The process of claim 1, wherein the vibrational characteristics comprise one or more of displacement mode shapes, sectional-rotation mode shapes, derivatives of displacement mode shape, derivatives of sectional rotational mode shape, and combinations involving their sum or product.

5. The process of claim 1, wherein the element comprises a physical structure.

6. The process of claim 1, wherein the discontinuity comprises damage to the element.

7. The process of claim 1, wherein the element comprises more than one discontinuity.

8. The process of claim 1, wherein solving the perturbed differential equations to obtain the one or more vibrational characteristics of the element with the discontinuity comprises using a convolution integral in space domain over the domain of the discontinuity.

9-24. (canceled)

25. A process of modeling a multi-element structure with finite element analysis, wherein at least one of the multi-elements has a discontinuity, the process to obtain one or more vibrational characteristics of the multi-element structure, the process comprising:
for each of the elements of the multi-elements having a discontinuity:
providing the physical characteristics of the element;
providing a finite element method code;
perturbing one or more vibrational characteristics of the element without the discontinuity based on the physical characteristics of the discontinuity;
calculating nth-order, perturbed differential equations governing one or more vibrational characteristics of the element with the discontinuity, wherein n is 1 or greater; and
forming a finite element based on the perturbed differential equations;
wherein the finite element is used with the finite method element code to obtain one or more vibrational characteristics of the entire multi-element structure;
wherein multi-element is three or more elements.

26. The process of claim 25, wherein the physical characteristics of each element comprises one or more of spatial, geometric and material characteristics of the element.

27. The process of claim 25, wherein the vibrational characteristics comprise one or more of mode shapes, natural frequencies, displacements, section-rotations, shears, moments, stresses and strains.

28. The process of claim 25, wherein the vibrational characteristics comprise one or more of displacement mode shapes, sectional-mode shapes, derivatives of displacement mode shape, derivatives of sectional rotational mode shape, and combinations involving their sum or product.

29. The process of claim 25, wherein each element comprises a physical structure.

30. The process of claim 25, wherein the discontinuity comprises damage to the element.

31. The process of claim 25, wherein forming a finite element comprises modeling the discontinuity as an equivalent (negative) stiffness.

32. The process of claim 25, wherein forming a finite element comprises modeling the discontinuity as an equivalent (negative) force.

33-41. (canceled)

42. The process of claim 25, wherein the multi-element structure is a three-dimensional multi-structural structure.

43-64. (canceled)

65. A process of designing a desired element without a discontinuity with one or more desired vibrational characteristics when related to the element modeled as having a discontinuity, the process comprising:
modeling an element with a discontinuity to obtain one or more vibrational characteristics of the element with the discontinuity, the process comprising:
providing the physical characteristics of the element;
providing one or more vibrational characteristics of the element without the discontinuity;
perturbing one or more vibrational characteristics of the element without the discontinuity based on characteristics of the discontinuity;
calculating nth-order, perturbed differential equations governing one or more vibrational characteristics of the element with the discontinuity, wherein n is 1 or greater; and
solving the perturbed differential equations to obtain one or more vibrational characteristics of the element with the discontinuity;
altering one or more vibrational characteristics of the element with the discontinuity with reference to the physical characteristics of the element; and
obtaining the desired element with one or more desired vibrational characteristics when related to the element having a discontinuity.

66. The process of claim 65, wherein obtaining the desired element with one or more desired vibrational characteristics when related to the element having a discontinuity does not utilize the physical properties of the discontinuity.

67. The process of claim 65, wherein altering one or more vibrational characteristics of the element with the discontinuity with reference to the physical characteristics of the element comprises equalization of one or more vibrational characteristics of the desired element with the same one or more vibrational characteristics of the element with the discontinuity.

68. The process of claim 65, wherein altering one or more vibrational characteristics of the element with the discontinuity with reference to the physical characteristics of the element comprises enhancing one or more vibrational characteristics of the desired element with reference to the same one or more vibrational characteristics of the element with the discontinuity.

69. The process of claim 65, wherein altering one or more vibrational characteristics of the element with the discontinuity with reference to the physical characteristics of the element comprises diminishing one or more vibrational characteristics of the desired element with reference to the same one or more vibrational characteristics of the element with the discontinuity.

70. The process of claim 65, wherein the physical characteristics of the element comprise one or more of spatial, geometric and material characteristics of the element.

71. The process of claim 65, wherein the vibrations characteristics comprise one or more of mode shapes, natural frequencies, displacements, sectional rotations, shears, moments, stresses and strains.

72. The process of claim 65, wherein the vibrations characteristics comprise one or more of displacement mode shapes, sectional rotation mode shapes, derivatives of displacement mode shape, derivatives of sectional rotational mode shape, and combinations involving their sum or product.

73. The process of claim 65, wherein the desired element comprises a physical structure.

74. The process of claim 65, wherein the discontinuity comprises damage to the element.

75. The process of claim 65, wherein the element comprises more than one discontinuity.

76-100. (canceled)

101. A process for detecting a discontinuity in an element, wherein the element has one or more continuous parts, each with no discontinuity, and one or more discontinuous parts, each with a discontinuity, the process comprising:
providing one or more modeled vibrational characteristics of the element due to the one or more continuous parts of the element;
determining one or more vibrational characteristics of the element;
expressing the one or more determined vibrational characteristics of the element as a sum of the one or more modeled vibrational characteristics due to the one or more continuous parts of the element and one or more vibrational characteristics due to the one or more discontinuous parts of the element to obtain the one or more vibrational characteristics due to the one or more discontinuous parts of the element; and
isolating the one or more vibrational characteristics due to the one or more discontinuous parts of the element.

102. The process of claim 101, wherein the determined vibrational characteristics comprise one or more of mode shapes, natural frequencies, displacements, sectional rotations, shears, moments, stresses and strains.

103. The process of claim 101, wherein the determined vibrational characteristics comprise one or more of displacement mode shapes, sectional rotation mode shapes, derivatives of displacement mode shape, derivatives of sectional rotational mode shape, and combinations involving their sum or product.

104. The process of claim 101, wherein the element comprises a physical structure.

105. The process of claim 101, wherein the discontinuity comprises damage to the element.

106. The process of claim 101, wherein the element comprises more than one discontinuity.

107-218. (canceled)
